(19) United States
(12) Patent Application Publication
(10) Pub. No.: US 2026/0289222 A1
(43) Pub. Date: Sep. 24, 2026

(54) WOODEN TRANSACTION CARDS AND METHODS OF MAKING THE CARDS

(71) Applicant: Copecto GmbH, Wiesbaden (DE)

(72) Inventor: David Finn, Fuessen Weissensee (DE)

(21) Appl. No.: 19/573,270

(22) Filed: Mar. 20, 2026

Related U.S. Application Data
(60) Provisional application No. 63/776,126, filed on Mar. 23, 2025.
(60) Provisional application No. 63/780,169, filed on Mar. 29, 2025.
(60) Provisional application No. 63/811,810, filed on May 25, 2025.
(60) Provisional application No. 63/811,792, filed on May 25, 2025.
(60) Provisional application No. 63/828,076, filed on Jun. 22, 2025.
(60) Provisional application No. 63/828,074, filed on Jun. 22, 2025.
(60) Provisional application No. 63/828,072, filed on Jun. 22, 2025.
(60) Provisional application No. 63/880,654, filed on Sep. 12, 2025.
(60) Provisional application No. 63/880,477, filed on Sep. 12, 2025.
(60) Provisional application No. 63/898,576, filed on Oct. 14, 2025.
(60) Provisional application No. 63/898,574, filed on Oct. 14, 2025.
(60) Provisional application No. 63/915,242, filed on Nov. 11, 2025.
(60) Provisional application No. 63/915,204, filed on Nov. 11, 2025.
(60) Provisional application No. 63/915,737, filed on Nov. 12, 2025.
(60) Provisional application No. 63/918,251, filed on Nov. 15, 2025.
(60) Provisional application No. 63/918,241, filed on Nov. 15, 2025.
(60) Provisional application No. 63/922,184, filed on Nov. 21, 2025.

(30) Foreign Application Priority Data
Mar. 12, 2026 (WO) PCT/EP2026/056892

(51) Int. Cl. G06K 19/077; B32B 7/12; B32B 21/06; B32B 21/10; B32B 21/14; B32B 37/18; B32B 38/00; B32B 38/06

(52) U.S. Cl. CPC G06K 19/07722; B32B 7/12; B32B 21/06; B32B 21/10; B32B 21/14; B32B 37/18; B32B 38/06; B32B 2038/0016; B32B 2250/05; B32B 2307/7376; B32B 2425/00

(57) ABSTRACT

A card body (CB) for a wooden transaction card (WTC) having a stack-up of a plurality (n) of wooden (veneer) layers (WL) bonded together using a plurality (n-1) of reinforcement layers (RL) comprising adhesive (AL) coated onto a substrate material (SL) such as fleece or paper disposed between the wooden layers. The wooden layers are pre-pressed to reduce their thickness, and the resulting stack-up of wooden layers and reinforcement layers is laminated to form a card body subassembly (CBS). Exterior surfaces of outer wooden layers may be sanded back so that the card body is ISO thickness compliant, and may be coated with a laser-engravable waterproofing resin (TC). A booster antenna (BA) or a coupling frame (CF) may be integrated into a core subassembly (CS) of the card body. The card may have a front face continuous metal layer (CML) with a ferrite or non-ferrite backer.

### CROSS-REFERENCES TO RELATED APPLICATIONS

This application claims priority (filing date benefit) from the following as:
a continuation-in-part of PCT/EP2026/056892 filed 12 Mar. 2026 which claims priority from the following US provisional applications
U.S. 63/918,241 filed 15 Nov. 2025
U.S. 63/880,654 filed 12 Sep. 2025
U.S. 63/828,074 filed 22 Jun. 2025
U.S. 63/811,810 filed 25 May 2025
US 63/771,141 filed 13 Mar. 2025
a nonprovisional filing of U.S. 63/922,184 filed 21 Nov. 2025
a nonprovisional filing of U.S. 63/918,251 filed 15 Nov. 2025
a nonprovisional filing of U.S. 63/918,241 filed 15 Nov. 2025
a nonprovisional filing of U.S. 63/915,737 filed 12 Nov. 2025
a nonprovisional filing of U.S. 63/915,242 filed 11 Nov. 2025
a nonprovisional filing of U.S. 63/915,204 filed 11 Nov. 2025
a nonprovisional filing of U.S. 63/898,576 filed 14 Oct. 2025
a nonprovisional filing of U.S. 63/898,574 filed 14 Oct. 2025
a nonprovisional filing of U.S. 63/880,654 filed 12 Sep. 2025
a nonprovisional filing of U.S. 63/880,477 filed 12 Sep. 2025
a nonprovisional filing of U.S. 63/828,076 filed 22 Jun. 2025
a nonprovisional filing of U.S. 63/828,074 filed 22 Jun. 2025
a nonprovisional filing of U.S. 63/828,072 filed 22 Jun. 2025
a nonprovisional filing of U.S. 63/811,810 filed 25 May 2025
a nonprovisional filing of U.S. 63/811,792 filed 25 May 2025
a nonprovisional filing of U.S. 63/780,169 filed 29 Mar. 2025
a nonprovisional filing of U.S. 63/776,126 filed 23 Mar. 2025
   all of which are incorporated in their entirety by reference herein.

### FIELD OF THE INVENTION

This invention relates to transaction cards (also known as smartcards, either of which may be referred to herein simply as “cards”) and, more particularly, to cards incorporating layers (or veneers) of wood, or other materials which may be eco-friendly or biodegradable. Cards having a significant wood content may be referred to as “wooden transaction cards”, “timber transaction cards”, or the like. This may include cards having contactless (RFID-enabled) capability or dual interface (contact and contactless) capability.

Some features of the invention(s) disclosed herein may include incorporating either a booster antenna or a coupling frame into the card to facilitate the contactless capability.

Some features of the invention(s) disclosed herein may include incorporating one or more of the following into the construction of the card: a laser engraved QR code, features which have been laser ablated or mechanically engraved, decorative elements, a metal sheet, a magnetic stripe, a hologram foil, a topcoat protecting underlying artwork which can be laser etched with personalization data.

Some of the disclosure(s) herein may relate to transaction cards made from material other than wood.

### BACKGROUND OF THE INVENTION

Most of the wood cards for access control, such as those used as keycards in hotels have a thickness of 1.4 mm, and are unsuitable for use in the payment industry, requiring an ISO thickness of 0.76 mm+0.08 mm. And those “all wood” cards which are within ISO thickness bend easily and warp over time. To achieve card body stiffness and longevity, some producers have densified a stack of wood veneers comprising outer layers of wood veneer having a thickness of 600 μm and inner layers having a thickness of 200 μm, with the inner layers sandwiching an inlay incorporating an antenna circuit with a thickness of 100 μm, as disclosed in US 2024/0001585. However, there are a number of challenges in pre-conditioning to remove moisture and densifying a stack of wood veneers at stepped elevated pressure levels and the post manufacturing processes of impregnating, printing, coating, singulating, applying security elements, engraving features and implanting the chip module while at the same time achieving high production yields and keeping the manufacturing cost down. In use, wooden payment cards have also bowed, warped and delaminated in the field which has been a major concern for the issuing banks and payment schemes. As wooden cards are the eco-friendly alternative to PVC cards, durability and insensitivity to the environment, especially humidity is a prerequisite.

### Some Patents and Publications of Interest

US 2024/0001585 (4 Jan. 2024; Swiss Wood Solutions; Chanana et al.), entitled “Densified hygroscopic materials and products made thereof”, incorporated by reference herein, discloses a method for densifying a hygroscopic material. The method is for hygroscopic material which may be a natural hygroscopic material or wood. The method comprises the steps of providing the hygroscopic material to be densified; pre-conditioning of the hygroscopic material by adjusting the moisture content of the hygroscopic material to a value within a predefined moisture range, if required; simultaneously heating and pressing the gas-tight packed hygroscopic material under predefined temperature and pressure conditions, whereby the moisture content of the hygroscopic material is kept constant; and obtaining a densified material. FIGS. 1, 3, 4 and 5 of US 2024/0001585 are of particular interest, are reproduced as FIGS. 1, 2, 3 and 4 herein, and are discussed herein. Reference is also made to WO 2022/112610.

US 2022/0184931 (16 Jun. 2022; Kona I Co, Ltd.; Shin et al.), entitled “Card including wood sheet, and method of manufacturing the same”, incorporated by reference herein, discloses a method of manufacturing a card includes the steps of: processing a wood sheet; stacking the wood sheet on an inlay sheet including an antenna that will be connected to a COB chip; milling an area corresponding to the chip on the wood sheet, and forming a residual layer of a thickness smaller than that of the wood sheet; exposing end portions of the antenna passing through the residual layer from the inlay sheet located under the residual layer of the wooden sheet; and electrically connecting the chip and the end portions of the antenna. FIG. 1 is of particular interest, is reproduced as FIG. 5A herein, and is discussed hereinbelow.

U.S. Pat. No. 10,832,115 (10 Nov. 2020; Capital One Services, LLC; Suthar), entitled “Wood inlay card and method for making the same”, incorporated by reference herein, discloses a transaction card construction and a method for making a transaction card. The transaction card construction comprises an inlay component comprising wood and a housing component. The inlay may comprise a wood or wood-containing layer and a backer layer. The backer layer may comprise the same or a different wood or wood-containing layer, or a non-woven fiber material. FIG. 11 is of particular interest, is reproduced as FIG. 5B herein, and is discussed hereinbelow.

US 2015/0269477 (24 Sep. 2015; AmaTech; Finn et al.), entitled “Dual interface hybrid metal smartcard with a booster antenna or coupling frame”, incorporated by reference herein, discloses a dual-interface metal hybrid smartcard comprising a plastic card body (CB); a metal slug (MS) disposed in the card body; and a booster antenna (BA) disposed in the card body. The metal slug may have a surface area which is at least 50% of a surface area of the card body, and may comprise titanium or alloys thereof. A antenna chip module (AM) having an antenna (MA) and contact pads (CP) may be disposed in an opening of the card body. The metal slug may comprise two or more separate metal slug components (MS-1, MS-2), which may overlap one another or which may be disposed at different locations in the card body (CB), without overlapping one another. The first metal slug component (MS-1) may be disposed around a peripheral portion of the card body (CB) as an “open loop” discontinuous metal frame around (external to) the booster antenna (BA). The second metal slug component (MS-2) may be disposed internal to the card antenna (CA) component of the booster antenna (BA). Reference is also made to US 2013/0126622. US 2015/0269477 issued as U.S. Pat. No. 10,783,426. FIG. 2H is of particular interest, is reproduced as FIG. 6 herein, and is discussed hereinbelow.

U.S. Pat. No. 10,163,050 (25 Dec. 2018; Capital One Services, LLC; Suthar), entitled “Wood inlay card and method for making the same”, incorporated by reference herein, discloses a transaction card construction and a method for making a transaction card are provided for improving card performance. The transaction card construction comprises an inlay component comprising wood and a housing component. The inlay may comprise a wood or wood-containing layer and a backer layer. The backer layer may comprise the same or a different wood or wood-containing layer, or a non-woven fiber material.

DE 198 03 262 C2 (27 Apr. 2000; Dexle et al.), entitled “Veneer system of high flexibility and method for producing same”, incorporated by reference herein, discloses in the set of claims the following: 1. Use of a single fleece for backing veneer systems, characterized in that the single fleece is hydroentangled. 2. Use of a single fleece according to claim 1, characterized in that the single fleece has a splitting strength of more than 450 kPa with a thickness of more than 0.1 mm. 3. Use according to claim 1 or 2, characterized in that the single fleece is a wet fleece. 4. Use according to claim 3, characterized in that the single fleece is a mixture of cellulose and polyester fibers bound with a binder, preferably an acrylate dispersion. 5. Use according to claim 1 or 2, characterized in that the single fleece is a dry nonwoven. 6. Use according to claim 5, characterized in that the dry nonwoven includes polyester fibers or other plastic fibers. 7. Use according to one of claims 1 to 6, characterized in that the single fleece comprises a coating. (translated from German)

EP 3 985 563 (20 Apr. 2022; Exceet Card Austria GmbH-Skidata GmbH; Irlinger et al.), entitled “Chip card”, incorporated by reference herein, discloses a chip card (1) comprising a chip (9) which is designed as a layered composite, the visible sides (2) of which are designed as layers of wood veneer, with a core designed as a prelaminate (3) being arranged between the visible sides (2) which has a paper substrate (4) connected on both sides to a layer (5) of paper or cardboard, on which the chip (9) and, if present, an antenna (10) are arranged.

EP 4 506 853 (12 Feb. 2025; Giesecke & Devrient; Fernandez et al.), entitled “Method for manufacturing a smart card with a wooden layer”, incorporated by reference herein, discloses a method (150) for manufacturing a smart card (10). The method comprises: in a first step (152), providing a front layer (111), a rear layer (112), and an antenna layer (113) of a smart card body (11), wherein at least the front layer (111) comprises wood; in a second step (154), applying thermal energy to the front layer (111) by a thermal energy source (50, 70, 80) in order to heat the front layer (111) for a first predetermined period of time to a first predetermined temperature; in a third step (156), joining the front layer (111), the rear layer (112), and the antenna layer (113) with the antenna layer (113) being arranged between the front layer (111) and the rear layer (112). The third step (156) is carried out after the second step (154) and prior to the front layer (111) being joined with the antenna layer (113).

### SUMMARY

It is an overall object of the invention to provide improved transaction cards (also known as smartcards, either of which may be referred to herein simply as “cards”) and, more particularly, to provide improved construction techniques for cards incorporating layers (or veneers) of wood, or other materials which may be eco-friendly or biodegradable.

Cards disclosed herein which comprise wood layers may be referred to herein as either “wood cards” or “wooden cards” or, in some cases, simply as “cards”.

The card constructions disclosed herein may include cards having contactless capability or dual interface (contact and contactless) capability.

The card constructions disclosed herein may be rigid and durable, and may use eco-friendly or biodegradable materials.

The card constructions disclosed herein may resolve some challenges in producing an RFID enabled wood card.

The card constructions disclosed herein may provide a card with a premium feel for the payment industry.

In the stack-up construction of a wooden transaction card or timber hybrid smartcard, a wood veneer may be accompanied by an overlay protection layer, an inner-ply layer, an adhesive backer, a polyester backer, a melamine backer, a paper backer, a fleece backer (woven or non-woven), a Tyvek backer, a fiberglass backer, a composite veneer backer, or a raw metal layer (stainless steel, copper, aluminum, etc.). Further, the layers may include a pre-applied thermoset or thermoplastic adhesive layer (eco-friendly or biodegradable), in dry film form or as a resin, penetrating the wood fibers during press lamination. Backers and inner-ply layers act as intermediate tear resistant layers to provide strength and protection against veneer cracking, splitting and curling.

According to the invention, generally, a card body construction for a smartcard comprises a stack-up of a plurality (n) of wood layers (veneers) WL bonded together using a plurality (n-1) of reinforcement layers RL of adhesive coated onto a substrate material such as fleece, paper (or the like) disposed between adjacent ones of the wood layers. The wood layers may be pre-pressed to reduce their thickness prior to stacking them up with the reinforcement layers. The substrate material of fleece may be a calendered (wetlaid) nonwoven fabric, thinned to a defined thickness. The resulting stack-up of wood layers and reinforcement layers may then be laminated to form a card body subassembly CBS. Exposed (exterior) surfaces of the outer wood layers of the card body structure may be sanded back to be ISO thickness compliant, and may be coated with a waterproofing resin which may be laser-engravable. A booster antenna BA or a coupling frame CF may be integrated into the card body structure. A timber metal hybrid transaction card may have a front face continuous metal layer with a ferrite or non-ferrite backer and a rear face wood veneer layer sandwiching a core subassembly incorporating a booster antenna circuit for inductive coupling with a transponder chip module.

According to the invention, generally, a construction of a card body CB for a smartcard may comprise a stack-up of a plurality (such as 4 or 5 or 6) of wooden (veneer) layers (WL) bonded together using a plurality (such as 3 or 4 or 5) of reinforcing or reinforcement layers (RL) comprising a substrate material such as fleece or paper (or the like) coated on both sides thereof with an adhesive and disposed between adjacent ones of the wood (or wooden) layers. The wooden layers (WL) may be prepressed to reduce their thickness prior to stacking them up with the reinforcement layers (RL).

According to an embodiment of the invention, to avoid card warpage post lamination of the stack-up assembly, the wood veneers may receive micro-slits along the grain direction before lamination, allowing the adhesive to seep through the micro-slits during press lamination with the objective to stabilize the card body construction after singulation and to achieve absolute flatness of the card body.

The resulting stack-up of wooden layers (WL) and reinforcement layers (RL) may have an initial (pre-lamination) thickness of approximately 1350 μm. Refer, for example to FIG. 8A.

The resulting stack-up of wooden layers (WL) and reinforcement layers (RL) may then be laminated, using (medium) pressure and heat (15 kg per cm² of pressure at a temperature of 140° C. for a dwell time of 6 minutes). This equates to 147 N/cm² across an area of 360 mm×605 mm, representing 32.7 tons of pressure), to form a laminated card body subassembly CBS. During the lamination process, the adhesive coating on the reinforcement layers may be almost entirely (such as approximately 75%) absorbed into the wood layers which are adjacent thereto. After lamination, the stack-up of wood layers and reinforcement layers may have a thickness of approximately 900 μm, representing an approximate 33% shrinkage in thickness. By applying higher pressure such as 30 kg per cm² during press lamination, the shrinkage in thickness can be improved.

The wood layers may be micro thin, rotary-peeled, and may each have an initial thickness of approximately 150 μm. The plurality of wood layers may (or may not) have the same thickness as each other. The wood layers may be pressed to reduce the initial thickness from 150 μm to 110 μm.

Each of the wood layers may have a grain orientation, and the grain orientation of the various wood layers may be oriented differently than one another.

The reinforcement layers (RL; or adhesive coated substrate layer (ACSL)) may each have an initial (pre-laminated) thickness of approximately 150 μm (AL~25 μm+SL~100 μm (post calendering from an initial thickness of ~220 μm)+AL~25 μm), or 100 grams per square meter (g/m²). The plurality of reinforcement layers may (or may not) have the same thickness as each other. After lamination, the reinforcement layers (compressed between wood layers) may each have a thickness of approximately 38 μm.

The substrate layer (SL) of the reinforcement layer(s) may comprise a nonwoven fleece, nonwoven pulp and fiber or nonwoven fluff pulp further comprising cellulose, synthetic and organic fibers bonded with a latex binder. The substrate layer (SL) may be referred to as a fleece or (air- or wet-laid) paper or fleece.

The adhesive coating AL on the reinforcement layer(s) may comprise an eco-friendly or a biodegradable material, such as solvent free polyvinyl acetate (PVAc) or pine resin.

Instead of calendering, the substrate layer (SL) may be laminated with adhesive film.

### Sanding Back

The topmost and bottommost wood layers (WL) of the card body subassembly (CBS) may, after lamination, have a thickness ranging from 0.80 mm (800 μm) to 1.0 mm (1000 μm) depending on the applied pressure, and may subsequently be sanded back so that the resulting card body (CB) with additional front layers (AFL) and additional rear layers (ARL) will have an ISO compliant uniform thickness of 760 μm=80 μm.

For example, approximately 50 μm of the initial 150 μm thickness of the topmost and bottommost wood layers (WL) of the card body subassembly (CBS) may be sanded away (removed) during the sanding back process.

The sanding back process may also remove any blemishes or dirt from the exposed top and bottom wood layers (WL) of the card body subassembly (CBS). The sanding back process also achieves flatness and a smooth finish. The grit value of the sanding belt, transport rate, and the number of passes determine the smoothness of the surface finish. The magnetic stripe (MS) may be applied to the rear side of the card body subassembly (CBS), after the bottom wood layer of the card body subassembly (CBS) has been sanded back to a very smooth surface.

After sanding back the (front and back) wood layers of the resulting laminated card body structure, the exterior surfaces of the front and/or back wood layers may be treated (such as coated) with an impregnation layer (IL) in the form of a waterproofing resin.

Sanding-back of the exposed surface(s) of the front and/or back wood layers may be performed before impregnation (sealing). Sanding-back of the exposed surface(s) of the front and/or back wood layers may be needed to achieve a uniform thickness and flatness for the resulting laminated card body structure. Sanding-back of the exposed surface(s) of the front and/or back wood layers may be also beneficial to achieve a certain surface roughness (Ra<2 μm) before applying a magnetic stripe to the back surface of the card body.

A recess for receiving a chip module (CM) may be provided by milling a stepped cavity (P₁ and P₂) in the resulting card body. The chip module may be a transponder chip module (TCM) comprising an integrated circuit (IC) chip for processing transactions. The chip module may have contact pads on a front (exposed) surface thereof to facilitate a contact interface (ISO/IEC 7816) with an external card reader (terminal) such as a point of sale (POS) device or an automated teller machine (ATM) having a contact interface. The chip module may have an antenna incorporated therein to facilitate a contactless (ISO/IEC 14443) interface with an external card reader (terminal) such as a point of sale (POS) terminal or an automated teller machine (ATM) having a contactless interface.

According to an embodiment of the invention, the card body structure may comprise a front subassembly (FS) having two wood layers and a reinforcing layer (RL) between the two wood layers; a rear subassembly (RS) having two wood layers and a reinforcement (reinforcing) layer (RL) between the two wood layers; and a core subassembly (CS) having one wood layer (WL) with a reinforcement layer (RL) on each of the two sides (surfaces) thereof. See, for example, FIGS. 7 and 8A.

According to an embodiment of the invention, a module opening MO may be provided, extending into several of the wood and reinforcing layers of the card body structure to allow a chip module to be inserted into the card body structure from a front surface thereof. The chip module may be a transponder chip module TCM having radio frequency (RF) capability for enabling a contactless interface between the card and an external card reader or terminal.

According to an embodiment of the invention, a booster antenna (BA) may be disposed between or integrated onto an inner layer of the card body structure. The booster antenna may comprise an insulated copper wire conductor scribed (embedded) into the adhesive material of one of the reinforcement layers (RL). The purpose of the booster antenna is to enhance contactless communication (coupling) between the transponder chip module and an external card reader or terminal. The booster antenna (BA) may take the form of a “booster antenna circuit (BAC)” with several elements in the circuit: a communication coil (perimeter), a coupler coil and an extension coil. In the case of a booster antenna BA on a carrier, a capacitor bank may be included.

According to an embodiment of the invention, a coupling frame (CF) may be integrated into a core (an inner layer of layers) of the stack-up, prior to laminating. The coupling frame may comprise a layer (such as a sheet or foil) of conductive material such as stainless steel, sheet iron or aluminum having a module opening (MO for receiving a portion of a transponder chip module (TCM) and a slit(S) extending from the module opening to a periphery of the conductive layer. The purpose of the coupling frame is to enhance contactless communication (coupling) between the transponder chip module and an external card reader or terminal. See, for example, FIG. 9A.

According to an embodiment of the invention, a core of the stackup does not have a booster antenna (BA) or a coupling frame (CF). It should be understood that such an embodiment may have a limited activation distance (distance at which the card can communicate effectively with an external card reader or terminal), and that the inclusion of a booster antenna or coupling frame will increase the activation distance, such as by a factor of 1.5×, 2× or more.

According to an embodiment of the invention, a transponder chip module may be sized to accommodate an antenna (module antenna) which is designed to be capable of facilitating contactless communication with an external card reader without requiring either a booster antenna or coupling frame in the card body. A design for such an enlarged or oversized transponder chip module may be the subject of another provisional patent application, and may for example measure 13.0 mm×17.5 mm for a 6 contact module or 14.40 mm×16.4 mm for an 8 contact module (as contrasted with a conventional transponder chip module which typically measures 8.2 mm×10.8 mm for a 6 contact module or 11.8 mm×13.0 mm for an 8 contact module).

According to an embodiment of the invention, additional layers of material may be disposed as additional front layers (AFL) or additional rear layers (ARL) on the front or rear surfaces of the card body subassembly CBS, respectively. This may include substances which may be absorbed into the exposed outer wood layers of the card body structure. For example, the exposed outer wood layers of the card body structure may be impregnated for waterproofing using a self-sealer. Pre- or post-impregnation, features such as artistic designs may be laser etched. Graphic artwork may be digitally printed (UV curable ink) on the cured impregnation layer and protected by a topcoat. For example, the topcoat comprising a water-based self-sealer may be sprayed on to the exposed outer wood layers of the card body structure. The cured topcoat may then be laser marked with personalization data.

The topcoat may prevent overheating of the exposed surfaces of the outer wood layers of the card body structure when laser etching.

According to the invention, generally, a card body subassembly (CBS) generally comprises a front subassembly (FS), a rear subassembly (RS), and a core subassembly (CS) disposed between the front subassembly (FS) and the rear subassembly (RS). Some of the subassemblies may comprise a wooden layer (WL) and a reinforcement layer (RL). In some embodiments, some of the subassemblies may comprise a booster antenna (BA), a coupling frame (CF), or a magnetic shielding layer (MSL). Or, the booster antenna (BA) and coupling frame (CF) may be applied to a subassembly or disposed between adjacent subassemblies. All of these subassemblies (FS, RS, CS), and their constituent components (WL, RL, BA, CF, MSL) may be laminated together all at once to form the card body subassembly (CBS), rather than being separately laminated as three individual subassemblies (FS, RS, CS), then assembled into the card body subassembly (CBS). In either case, after the card body subassembly (CBS) is formed, additional front layers (AFL) and additional rear layers (ARL) may be assembled thereto, as described herein.

### Restoration of the Wood Grain

Using casting release paper with three-dimensional wood grain structures, the wood grain can be restored on the surface of the wooden card, by placing (before lamination) the release paper over the water-based self-sealer, resin coating or dry film layer intended to impregnate the wood veneers. Post lamination, the grandeur of the wood grain will be evident on the surfaces of the outer wood veneers.

According to an embodiment of the invention, LED back lightning may be incorporated into the card construction to illuminate the wood layers from within.

According to an embodiment of the invention, a 5 or 6 ply construction (i.e. 5 or 6 wood layers (WL) and 4 or 5 reinforcement layers (RL)) without an in-card booster antenna circuit (BAC) or coupling frame (CF) may communicate with a contactless terminal via an enlarged transponder chip module; wherein the enlarged transponder chip module having its long side orientated parallel the length of the card body or parallel the width of the card body; wherein the wood layers (WL) are micro thin rotary peeled wood veneers with a thickness of 127-150 μm; wherein the reinforcement layers are adhesive coated paper (ACP: paper saturated with melamine resin) or adhesive coated fleece (ACF: wetlaid nonwoven fabric coated with PVAc) with a thickness of 140-150 μm; and wherein the complete assembly is laminated at an elevated pressure to compress or densify the material layers to an ISO conforming thickness of 800 μm. See, for example, FIGS. 7 and 10.

According to an embodiment of the invention, a wooden transaction card (WTC) or smartcard (SC) comprises an odd number of wooden layers such as 5 and an even number of reinforcement layers such as 4; wherein the wooden layers comprise micro thin rotary peeled wood veneer with a grain direction (crosswise or lengthwise) having a thickness between 125 and 150 μm; wherein the reinforcement layers comprise a substrate layer (SL) of nonwoven fabric (fleece), nonwoven pulp and fiber or nonwoven fluff pulp (of cellulose, synthetic and organic fibers bonded with a latex binder) laid in a specific direction and coated on both sides by way of adhesive transfer, spray coating or curtain coating with a thermoplastic adhesive (PVAc) having a total thickness of 150 μm; wherein the individual wooden layers and reinforcement layers are oriented differently (such as 90 degrees) with respect to each other; wherein the complete stack-up construction of wooden layers (5×150 μm) and reinforcement layers (4×150 μm) with a total thickness of 1350 μm are laminated in one step to produce a multi-layered laminate with a thickness of 900 μm representing a shrinkage in thickness of approximately 33%, with the adhesive from the reinforcement layers penetrating the pores of the wooden veneers for the purpose of adhesion, reinforcement and impregnation; wherein the outer wooden layers of the card body structure (post lamination) may be sanded back to be ISO thickness compliant; wherein the sanded-back laminate may be impregnated with a water based self-sealer for the purpose of waterproofing and as an adhesion promoter for the deposition of digital ink; wherein the water-protected sanded-back laminate may receive graphic features by way of digital inkjet printing or laser etching; and wherein the graphic features are protected by a topcoat (film, resin or varnish) which may be laser engravable. The water-protected sanded-back laminate with graphic features may be reduced to card bodies (singulation process) by CO₂ laser cutting while at the same time sealing the perimeter edges of the individual card bodies to protect against the environment. A booster antenna (BA) or a coupling frame (CF) may be integrated into the card body structure. A sacrificial casting paper may be used to emboss a wood grain direction into the coated outer layers of wooden veneer in a subsequent lamination process. See, for example, FIG. 8A.

According to an embodiment of the invention, a wooden transaction card (WTC) with contactless functionality comprises at least 5 wood layers and at least 4 reinforcement layers, wherein each wood layer (WL) is a micro-thin rotary peeled wood veneer with a thickness of ~150 μm and each reinforcement layer (RL) comprising a substrate layer (SL) coated on both sides with an adhesive layer (2×~25 μm), also referred to as an adhesive coated substrate layer (ACSL) for structural integrity and interlayer bonding, and wherein said substrate layer (SL) further comprises a smooth, compressed and densified (wetlaid) nonwoven fabric (aka fleece) processed through a mechanical finishing technique of calendering, with an initial thickness of 220 μm (e.g. 70 g/m²) and post calendering and coating of adhesive having a thickness of ~150 μm (e.g. 100 g/m²) and wherein the overall thickness of the stack-up (5 WLs and 4 RLs/ACSLs) before press lamination being approximately 1350 μm and a post lamination thickness of 780-800 μm by application of pressure, temperature over a defined dwell time, representing a material shrinkage of 42%. The (wetlaid) nonwoven fabric (fleece) comprises cellulose and synthetic fibers in a latex binder. An antenna circuit is incorporated into a core reinforcement layer. During press lamination, the adhesive on both sides of the substrate layer seeps into the wood fibers of the surrounding wood layers. The topmost and bottommost wood layer of the laminated assembly may be sanded-back to have a smooth and uniform ISO compliant thickness. Refer, for example to FIG. 8A. Micro-thin rotary peeled wood veneer with a thickness of ~150 μm may be translucent (such as birch). Individual layers of wood veneer in the stack-up may or may not be pigmented (stained or unstained). The adhesive coating on each side of the reinforcement layer may or may not be pigmented (dyed). The substrate layers may or may not be pigmented (dyed).

According to an embodiment of the invention, a timber metal transaction card (TMTC) may comprise outer layers of wood veneer (WL) sandwiching upper and lower reinforcement layers (RL) assembled to a core discontinuous metal layer (DML, ML) functioning as a coupling frame (CF), wherein the upper and lower reinforcement layers (RL) comprise a substrate layer (SL) of nonwoven fabric (cellulose and synthetic fibers bonded with a latex binder) coated on both sides with an adhesive layer (AL), wherein the adhesive coatings impregnate the top and bottom wood layers (WL) from within while simultaneously functioning as a bonding agent to the metal coupling frame (CF) with the nonwoven fabric stretched or spanning across the slit(S) and module opening (MO) for structural stability, negating the need to fill the voids with a thermosetting resin such as epoxy or polyurethane.

Regarding the discontinuous metal layer (DML; or coupling frame (CF)) in the core subassembly (CS) of the card body subassembly (CBS) as shown, for example, in FIGS. 9A, 14B, and 14C, the following may be noted:
The card body subassembly (CBS) may be laminated in a single lamination step compressing the wooden (veneer) layers (WL) and the reinforcement layers (RL, front and rear) against the core discontinuous metal layer (DML), with said layers (WL, RL) shrinking in material thickness under the application of pressure and temperature, wherein the pressure applied is under 500 N/cm² or under 850 N/cm² (material thickness dependent) at a temperature between 135° C. and 160° C. for a dwell time of 30 minutes (i.e. laminating multiple subassemblies at the same time).
The adhesive layers (AL) applied to the substrate layer (SL) to form a reinforcement layer (RL) may be thermosetting adhesive in order to avoid clogging of the milling tools during the singulation process of CNC milling, as may otherwise be the case with thermoplastic adhesive.
The discontinuous metal layer may desirably provide 10 grams of additional weight to the card body.
The discontinuous metal layer (DML) will have an appearance which is different in both texture and color than the wooden (veneer) layers.

According to an embodiment of the invention, mechanical engraving through the front and/or rear wooden (veneer) layers sandwiching the discontinuous metal layer may be performed, such as after singulation of card bodies (SCB) from the laminated sheet assembly (LSA), to expose (reveal) the contrasting front and rear surfaces of the discontinuous metal layer (DML) to reveal (make visible to the card holder) aesthetic features or logos. Any suitable means for precisely cutting through the front and/or rear wooden (veneer) layers may be employed to achieve this result.

According to an embodiment of the invention, the timber metal transaction card (TMTC) presented in FIG. 9A may have a front and rear layer of oxidized maple (jet black in color) wooden (veneer) layers (WL) sandwiching a discontinuous metal layer (DML) acting as a coupling frame (CF). The metal layer may be an alloy having significant weight, greater 10 grams. The metal may protrude through an opening in (through) the front face wooden layer or the rear face wooden layer may be machined to reveal the underlying metal (knockout to metal).

According to an embodiment of the invention, a metal timber transaction card may comprise a front face continuous metal layer (CML: 200 μm) and a rear face wood veneer layer (WL: 250 μm) with their position in the stack-up assembly interchangeable, sandwiching a core subassembly (CS) comprising an upper reinforcement layer (RL: 150 μm), a magnetic shielding layer (MSL: 65 μm), an adhesive spacing layer (ASL: 50 μm), a booster antenna circuit (BAC) and a lower reinforcement layer (RL: 150 μm); wherein the booster antenna circuit (BAC) is a double sided plated copper structure on an acrylic carrier (65-75 μm) or a double-sided aluminum etched antenna on a PET carrier (45 μm), or alternatively, the booster antenna circuit (BAC) is a wire embedded antenna circuit (bare wire Ø: 80 μm) countersunk into the adhesive layer (AL) on the underside of the lower reinforcement layer (RL) replacing and making the adhesive spacing layer (ASL) redundant; wherein the upper and lower reinforcement layers (RL) are in the form of a substrate layer (SL) of calendered (wetlaid) nonwoven fabric coated on both sides with an adhesive layer (AL), also referred to as an adhesive coated fleece (ACF) or adhesive coated substrate layer (ACSL), with the substrate layer (SL) having an initial thickness of 220 μm before thinning to a thickness of ~ 100 μm and application of the adhesive coating to both sides of the substrate layer (SL), resulting in an overall thickness of 150 μm (i.e. RL/ACSL: AL 25 μm+SL 100 μm+AL 25 μm). See, for example, FIG. 9B. Depending on the configuration of the core subassembly (CS) with different options for the integration of a booster antenna circuit (BAC), the thickness of the outer layers of metal (top) and wood (bottom) may be adapted to conform to an ISO thickness of 800 μm. The application of a magnetic shielding layer (MSL) to offset the RF attenuation effect of the continuous metal layer (CML) is revisited in FIGS. 12D, 13A, B and C.

According to an embodiment of the invention, a timber metal transaction card (TMTC) may comprise a front face metal layer (ML: aluminum, anodized aluminum, steel, iron, brass, copper, titanium, special alloys, etc.) with a thickness, for example, of 100 μm with an underlying adhesive layer (AL: 25 μm) for adhesive attachment in forming a front subassembly (FS) and a rear face wood (veneer) layer (WL) having a thickness of 150 μm with an inward facing adhesive layer (AL: 25 μm) for adhesive attachment in forming a rear subassembly (RS), wherein the front and rear subassemblies (FS & RS) sandwich a core subassembly (CS) comprising layers of wood veneer (stained or unstained) with adhesive layers for interlayer bonding and substrate layers for reinforcement, with the core subassembly (CS) having a thickness before press lamination of 750 μm (3-ply wood veneer laminate with 2 adhesive coated substrate layers (ACSL-4 interlayers of adhesive and 2 substrate layers) or reinforcement layers (RL)) and a post lamination thickness of 545 μm, wherein a booster antenna circuit (BAC) is incorporated in an adhesive layer (AL) positioned between a top wood (veneer) layer (WL) and a substrate layer (SL); wherein each substrate layer (SL) has an orientation and is positioned crosswise or lengthwise to the grain direction of the wood veneer layer (WL); wherein the booster antenna circuit (BAC) is galvanically connected to terminals (L_{A} and L_{B}) on the bond side of a dual interface chip module (6 or 8 pin package) per TeConnect technology; wherein the front face metal layer (ML) is provided with a milled out pocket (post lamination of the complete assembly) or a laser cut module opening (before lamination of the complete assembly); wherein the front face metal layer (ML) receives a decorative design (DD), for example, by laser etching a woodgrain effect into the metal layer (ML); wherein the front face metal layer (ML) is a discontinuous metal layer (DML) with a gap (G) around the intended area of the module opening (MO); wherein the gap (G) is part of the decorative design (DD) and wherein contactless communication with a payment or identification terminal is effectuated via the booster antenna circuit (BAC) connected to the dual interface chip module (CM). Post laser etching of the decorative design (DD), the metal surface may be protected with a laser engravable coating or with a primer to promote the adhesion of digitally deposited ink. Refer, for example to FIG. 12A. Note the chip module (CM) is physically connected to the booster antenna circuit (BAC) without the need for a module antenna (MA) or a coupler coil (CC), in contrast to the teachings proposed by the foundation patents on RFID slit technology (e.g. U.S. Pat. Nos. 9,475,086, 9,798,968, 9,390,364). A partial magnetic shielding layer (MSL) with a thickness of 50, 65 or 75 μm, occupying an area around the module opening (MO) and the left-hand side of the card body (CB) may be arranged on the underside of the discontinuous metal layer (ML, DML) to enhance RF performance.

RFID Slit Technology relates to Smart Cards comprising a metal body having a discontinuity in the form of a slit extending from a periphery edge of the metal body to an opening for receiving the transponder chip module (i.e., an RFID (radio frequency identification) chip), enabling the metal body to operate in contactless mode. Wherein the module antenna of the transponder chip module overlaps the slit for inductive coupling.

According to an embodiment of the invention, a timber metal transaction card (TMTC) may comprise a front face discontinuous metal layer (DML) with a thickness of 100 μm provided with an upper adhesive layer (AL: 25 μm), a magnetic shielding layer (MSL: 50, 65 or 75 μm) and a lower adhesive layer (AL: 25 μm) in forming a front subassembly (FS) and a rear wood (veneer) layer (WL) having a thickness of 150 μm provided with an adhesive layer (AL: 25 μm) atop the wood layer (WL) in forming a rear subassembly (RS) adhesively attached to and sandwiching a core subassembly (CS); with said core subassembly comprising layers of wood veneer (stained or unstained) with adhesive layers for interlayer bonding and substrate layers for reinforcement having a thickness before press lamination of 681 μm (3-ply wood veneer laminate with 2 adhesive coated substrate layers (ACSL-4 interlayers of adhesive and 2 substrate layers) or reinforcement layers (RL)) and a post lamination thickness of 490 μm, wherein a booster antenna circuit (BAC) is incorporated in an adhesive layer (AL) between the top wood veneer layer (WL) and the top substrate layer (SL); wherein the coupler coil (CC) of the booster antenna circuit (BAC) inductively couples with the module antenna (MA) of the transponder chip module (TCM); wherein the front face metal layer (ML) is provided with a milled out pocket (post lamination of the complete assembly) or a laser cut module opening (before lamination of the complete assembly); wherein the front face metal layer (ML) receives a decorative design (DD), for example, by laser etching a woodgrain effect into the metal layer (ML); wherein the front face metal layer (ML) is a discontinuous metal layer (DML) with a gap (G) around the intended area of the module opening (MO); wherein the gap (G) is part of the decorative design (DD) and wherein contactless communication with a payment or identification terminal is effectuated via the booster antenna circuit (BAC) inductively coupled to the transponder chip module (TCM) and shielded from the front face metal layer (ML) with the magnetic shielding layer (MSL). Post laser etching of the decorative design (DD), the metal surface may be protected with a laser engravable coating or with a primer to promote the adhesion of digitally deposited ink. Refer, for example to FIG. 12B. The booster antenna may be a plated copper antenna on a carrier, a double sided aluminum etched antenna on a PET carrier or a 3D printed antenna circuit constructed on an adhesive layer (AL), a substrate layer (SL) or a wood layer (WL). Note the dual interface chip module or transponder chip module (TCM) is inductively coupled to the booster antenna circuit (BAC) and shielded from the front face discontinuous metal layer (DML) by a magnetic shielding layer (MSL) without coupling to the discontinuous metal layer (DML), in contrast to the teachings proposed by the foundation patents on RFID slit technology with the module antenna (MA) of the transponder chip module (TCM) overlapping the slit(S) in the discontinuous metal layer (e.g. U.S. Pat. Nos. 9,475,086, 9,798,968, 9,390,364).

The embodiments shown in FIGS. 9A and 9B are similar, with the following differences:
FIG. 9A shows a wooden (or timber) transaction card (WTC) with a discontinuous metal layer (DML) or coupling frame (CF) in the core subassembly (CS), sandwiched between and supported by reinforcement layers (RL) atop and below the coupling frame. A front wooden (veneer) layer (WL) is disposed atop the core subassembly, and a rear wooden (veneer) layer (WL) is disposed below the core subassembly. FIGS. 14A and 14B are relevant (related to) this coupling frame in the core subassembly embodiment.
FIG. 9B shows a smart card (SC) with a booster antenna (BA) disposed in the core subassembly (CS). The booster antenna sits atop a reinforcement layer (RL). An adhesive layer (AL) is disposed atop the booster antenna. A magnetic shielding layer (MSL) is disposed atop the adhesive layer. A reinforcement layer (RL) is disposed atop the magnetic shielding layer. A front continuous metal layer (ML, CML is disposed atop the core subassembly, and a rear wooden (veneer) layer (WL) is disposed below the core subassembly.

According to an embodiment of the invention, a coupling frame (a discontinuous metal layer) acting as an antenna circuit in a transaction card and inductively coupled to a transponder chip module for radio frequency communication with a contactless terminal may be replaced by the combination of a continuous metal layer, magnetic shielding layer and a booster antenna circuit in the form of a wire embedded, plated copper or chemically etched antenna circuit.

According to an embodiment of the invention, a transaction card may comprise outer (non-conductive) wood veneer layers (front and rear) and a core continuous metal layer (without a slit), with the presence of the continuous metal layer attenuating the electromagnetic field generated by a contactless terminal (via reverse eddy currents), wherein a magnetic shielding layer offsets said attenuation effect and is adhesively attached to the underside of the continuous metal layer with a booster antenna circuit spaced off the magnetic shielding layer to improve radio frequency performance using an adhesive spacing layer or an adhesive coated substrate layer (with a minimum spacing distance of 50 μm of the surface of the magnetic shielding layer), with contactless communication operating only from the rear side of the transaction card body.

According to an embodiment of the invention, a coupling frame (a discontinuous metal layer) sandwiched between (non-conductive) wood veneer layers, such as micro thin rotary peeled wood veneer with a thickness of 150 μm (front and rear) may be replaced by a core subassembly of a continuous metal (254 μm), an adhesive layer (25 μm), a magnetic shielding layer (65 μm), an adhesive spacing layer 50 μm with an underlying booster antenna circuit or a reinforcement layer in the form of an adhesive coated substrate layer with an integrated wire embedded booster antenna circuit (150 μm), with the core subassembly adhesively attached to the front and rear wood veneer layers with upper and lower adhesive film layers (25 μm). The total assembly having a thickness of 844 μm prior to press lamination, and a post lamination thickness of approximately 760 μm by application of a pressure between 200 N/cm² and 300 N/cm².

According to an embodiment of the invention, the outer wood veneer layers (front and rear) sandwiching the core subassembly may be increased to 300 μm, with the lamination pressure increase to 500 N/cm² to provide greater shrinkage of the wood veneer layers to a post lamination thickness of approximately 200 μm.

According to an embodiment of the invention, the compression of the front wood veneer layers during press lamination shrinking to a thickness of 200 μm is equal to the combined thickness of the module tape or chip carrier tape of the transponder chip module (170 μm) and the mounting tape (compressed 30 μm).

According to an embodiment of the invention, a timber metal transaction card (TMTC) may comprise a front face wood veneer layer (WL) adhesively attached to underlying discontinuous metal layer (DML or ML) and a rear face wood veneer layer, sandwiching a core subassembly comprising upper and lower wood veneer (WL: stained or unstained) with adhesive layers for interlayer bonding and a substrate layer for reinforcement (2-ply wood veneer laminate) with a booster antenna circuit (BAC) incorporated in a top adhesive layer (AL) of the core subassembly (CS) and electrically connected to terminals (L_{A} and L_{B}) on the bond side of a dual interface chip module (6 or 8 pin package); wherein the discontinuous metal layer (DML or ML) is provided with a milled out pocket (post lamination) or a laser cut module opening (pre-lamination of the assembly); and wherein the front face wood veneer layer receives graphic elements by mechanically engraving and or laser etching the features to the surface of the discontinuous metal layer (DML or ML), also referred to as knockout to metal. Refer, for example to FIG. 12C. Optionally, a magnetic shielding layer (MSL) may be disposed between the discontinuous metal layer (DML) and the booster antenna circuit (BAC).

According to an embodiment of the invention, a timber metal transaction card (TMTC) may comprise a front face continuous metal layer (CML, ML) with a thickness of 100 μm provided with an adhesive layer (AL: 25 μm), a magnetic shielding layer (MSL: 50, 65 or 75 μm) and an adhesive coated substrate layer (ACSL: 150 μm) in forming a front subassembly (FS) having an overall thickness of 350 μm before press lamination, and an adhesive coated substrate layer (ACSL: 150 μm) and a rear wood (veneer) layer (WL: 150 μm) in forming a rear subassembly (RS) having an overall thickness of 300 μm before press lamination, attached to and sandwiching a core subassembly (CS); with said core subassembly comprising top and bottom layer of wood veneer (WL: 150 μm, stained or unstained) and intermediate adhesive coated substrate layers (ACSL: 150 μm) for interlayer bonding and reinforcement having a thickness before press lamination of 645 μm (a 2-ply wood veneer laminate with 2 adhesive coated substrate layers (ACSL: 4 interlayers of adhesive and 2 substrate layers) and a post lamination thickness of 420 μm, wherein a booster antenna circuit (BAC) in the form of an aluminum etched antenna on a PET carrier (BAC: 45 μm) is incorporated between the adhesive coated substrate layers (ACSL); wherein the coupler coil (CC) of the booster antenna circuit (BAC) inductively couples with the module antenna (MA) of the transponder chip module (TCM); wherein the front face continuous metal layer (CML, ML) is provided with a milled out pocket (post lamination of the complete assembly) or a laser cut module opening (before lamination of the complete assembly); wherein the front face continuous metal layer (CML, ML) receives graphic artwork through the deposition of digital ink (CYMK) and wherein prior to assembly the magnetic shielding layer (MSL) is provided with an opening to receive the transponder chip module (TCM). Refer, for example to FIG. 12D. The booster antenna may be a double-sided aluminum etched antenna on a PET carrier or a plated copper antenna on an acrylic carrier. Individual card bodies from the inlay array may be punched or milled.

According to an embodiment of the invention, a compressed laminated sheet assembly (LSA) of a front face continuous metal layer or metal foil (CML, ML, MF) with a magnetic shielding layer (MSL) as backer attached thereto and a rear face wood veneer layer (WL) sandwiching a 2-ply core subassembly (CS) of upper and lower wood veneer layers (WL) and adhesive coated substrate layers (ACSL) in a production format (e.g. 3×8 (24-up), 5×5 (25-up), 6×8 (48-up), etc.) incorporating a booster antenna circuit (BAC) at each card body site in the array, and the sheet assembly having a top (metal) and bottom (wood) exposed surface (front and rear face); wherein the continuous metal layer (CML, ML, MF) with a thickness of 100 μm having a laser cut module opening (MO) at each card body position is attached to the magnetic shielding layer (MSL) with a thickness of 75 μm having a punched module opening (MO) at each card body position using a dry film adhesive (thermosetting) with a thickness of 25 μm and also having a corresponding module opening (MO) at each card body position to accept the later implanting of an 8 pin transponder chip module (TCM); and wherein the continuous metal layer, adhesive layer and magnetic shielding layer are laminated together forming a subassembly with the post lamination thickness of the assembly (~200 μm) matching the thickness of the module tape (MT: 170 μm) of the transponder chip module and the chip module mounting tape (30-40 μm), compressed post embedding), with the thickness of the module tape and mounting tape representing the P₁ depth of the recessed module cavity; wherein the core subassembly comprises an upper and lower sheet of rotary peeled wood veneer (WL: 150 μm) with a crosswise grain direction sandwiching an adhesive coated substrate layer (ACSL: AL 25 μm+SL 100 μm (post calendering from an initial thickness of ~220 μm)+AL 25 μm) for bonding and reinforcement, with a booster antenna circuit wire embedded or scribed into the top adhesive layer (AL) of the ACSL at each card body site, and the underlying substrate layer (SL) having a lengthwise direction, with an overall thickness of 450 μm before lamination of the subassembly; wherein the post lamination of the core subassembly (CS) with two layers of wood veneer (2-ply construction) and 1 adhesive coated substrate layer (ACSL) may have a thickness of 335 μm+15 μm (26% compression); wherein the front face continuous metal layer or metal foil (CML, ML, MF) is attached to the core subassembly via an (upper) intermediate adhesive coated substrate layer (ACSL) while the rear face wood veneer layer (WL) with a lengthwise grain direction is attached to the underside of the core subassembly via a (lower) intermediate adhesive coated substrate layer (ACSL); wherein the bottom (wood) exposed surface (rear face) may be coated with a primer (post lamination) of the assembly for impregnation (waterproofing) and surface treatment (adhesion promoter) to receive the later deposition of digital ink; and wherein the implanted transponder chip module (TCM) is mounted to and resides on the (upper) intermediate adhesive coated substrate layer (ACSL) having a milled out cavity (P₂) to accept the later implanting of the transponder chip module (TCM). The P₂ module opening may be 9.8 mm×8.8 mm with a corner radii of 2.2 mm, having a depth of 430 μm. See, for example, FIGS. 13A and 13B.

According to an embodiment of the invention, a timber metal transaction card (TMTC) or smartcard (SC) may comprise a front subassembly (FS) having a front face continuous metal layer or metal foil (CML, ML, MF), an adhesive layer (AL) and a magnetic shielding layer (MSL), with each layer in the stack-up assembly provided with a module opening (MO) for the later placement of a chip module (CM) in a stepped recess (P₁ and P₂) of the card body (CB), and said chip module (CM) comprising a module tape (MT) with contact pads (CP) on its upward facing side and a module antenna (MA), bond pads and circuitry or traces on its downward facing side, and an integrated circuit (IC) chip disposed to the downward (rear) facing side of the module tape (MT), wherein the thickness of the laminated front subassembly (FS) matches the approximate thickness of the module tape (MT) of the chip module (MT) including the chip module mounting tape and represents the first step (P₁) in the recess to accept the chip module (CM); a core subassembly (CS) having an adhesive coated substrate layer (ACSL) for bonding the front subassembly (FS) to the rear subassembly (RS), further comprising a top adhesive layer (AL), a substrate layer (SL) and a bottom adhesive layer wherein a booster antenna circuit (BAC) for inductive coupling with the module antenna (MA) of the chip module (CM) is incorporated into the bottom adhesive layer (AL) of said adhesive coated substrate layer (ACSL) and prepressed to form the core subassembly (CS), and wherein the adhesive coated substrate layer (ACSL) is provided with a module opening (MO) in partially creating the second step (P₂) of the recess in the card body (CB) to accept the later implanting of the chip module (CM), and wherein the substrate layer (SL) provides mechanical support to the chip module (CM), and wherein the substrate layer (SL) is a (wetlaid) nonwoven fabric (aka fleece), a hydroentanglement nonwoven, a glass fiber nonwoven or a hybrid nonwoven of glass fiber and fleece of a defined thickness; and a rear subassembly (RS) having three wood veneer layers (WL), upper, middle and lower, bonded between reinforcement layers (RL) of an adhesive coated substrate (ACSL) forming a 3-ply wood veneer laminate with 4 interlayers of adhesive and 2 substrate layers, wherein the upper wood veneer layer (WL), the first adhesive coated substrate layer (ACSL), the middle wood veneer layer (WL), the second adhesive coated substrate layer (ACSL) and the lower wood veneer layer (WL) are laminated together and compressed to a defined thickness before final lamination of the complete stack-up, and to prevent ghosting of the boater antenna circuit in the core subassembly. See, for example, FIG. 13C. The substrate layer in the core subassembly spaces the booster antenna circuit (BAC) off the magnetic shielding layer MSL) for optimum RF performance.

According to an embodiment of the invention, a coupling frame (CF) forming the core of a wood metal hybrid transaction card as shown in FIG. 9A, may have a discontinuity in the form of a straight or shaped slit(S) starting at a peripheral edge of the coupling frame (CF), extending to a module opening (MO) and terminating at a point representing the center of the card body (CB), and a transponder chip module (TCM) having a module antenna (MA) and configured to be received atop the module opening (MO) of the coupling frame (CF), wherein the RF performance of the inductively coupled transponder chip module is significantly improved via the discontinuity extending to the center area of the coupling frame. See, for example, FIG. 14A.

The slits (S, slit, Slit 1, Slit 2) in the discontinuous metal layer (DML) or coupling frame (CF) shown in various embodiments extend completely through the metal layer, and may have a width of approximately 100 μm. Some embodiments disclosed herein may have a continuous metal layer (CML), such as the front face metal layer (ML) shown in FIG. 9B, which does not have a slit and which does not function as a coupling frame (CF).

According to an embodiment of the invention, a timber metal transaction card (TMTC) may comprise a front and rear layer of stained or dyed wood veneer sandwiching a core discontinuous metal layer (ML, DML) to form a card body subassembly (CBS) similar to the construction as shown in FIG. 9A. To offset the instability of said discontinuous metal layer (ML, DML) with a slit(S) extending from a peripheral edge to the center of the card body (CB) as shown in FIG. 14A in forming a coupling frame (CF) for radio frequency communication, a tear-resistant reinforcement layer (RL) in the form of a calendered (wetlaid) nonwoven fabric coated on both sides with an adhesive (also referred to as an adhesive coated fleece (ACF) or adhesive coated substrate layer (ACSL)) is applied to the top and bottom side of the metal layer (ML, DML) to form a core subassembly (CS), and sandwiched between a front subassembly (FS) and a rear subassembly (RS) of stained or dyed wood veneers. The calendered nonwoven fabric having a defined weight, thickness, strength, softness and air permeability may be a hydroentanglement nonwoven, a glass fiber nonwoven or a hybrid nonwoven of glass fiber and fleece. This calendering process of thinning increases the modulus, strength, tear resistance, puncture resistance and impact strength of the fabric by decreasing its thickness.

The front and rear face wood layer (single-ply) forming the front subassembly (FS) and rear subassembly (RS) may be a stained or dyed wood veneer having an initial thickness of 300 or 550 μm before compression or densification, and a post lamination thickness of 200 μm (pressure dependent). Alternatively, the wood layers may be technical or reconstituted wood veneers.

The upper and lower reinforcement layers (RL) comprise a substrate layer (SL) of fleece, i.e. a (wetlaid) nonwoven fabric comprising a blend of cellulosic and polyester fibers bonded with a latex binder. The basis weight of the nonwoven fabric may be 70 g/m² having an initial thickness of 220 μm before adhesive coating. Post calendering and application of the adhesive coating (~25 μm) to both sides of the substrate layer, the adhesive coated nonwoven fabric or adhesive coated fleece (ACF) may have a thickness of ~150 μm (100 g/m²).

The discontinuous metal layer (ML, DML) as a coupling frame (CF) in forming the core subassembly (CS) as described in FIG. 14A may be a layer of tempered 304 stainless steel, titanium, aluminum or any suitable metal alloy that provides durability and aesthetics having a thickness of 254 μm. Optionally, the laser-cut module opening (MO) may be stuffed with a wooden plug or slug to prevent indents (top and bottom) appearing after lamination of the complete card body subassembly (CBS).

The complete card body subassembly (CBS) of the front face wood layer (FS), upper reinforcement layer (RL), core discontinuous metal layer (CS), lower reinforcement layer (RL) and rear face wood layer (RS) may be laminated together in a single process step without prepressing of the wood layers.

According to an embodiment of the invention, a timber metal transaction card (TMTC) may comprise a core discontinuous metal layer (DML) with a laser cut slit (straight or shaped) and module opening (MO) in forming a coupling frame (CF) with the slit(S) having a pathway running parallel the long side of the card body (CB) in the horizontal axis, wherein said discontinuous metal layer (DML) is laminated between front and rear outer wood layers (WL) with a grain direction running parallel the short side of the card body (CB) in the vertical axis and intermediate reinforcement layers (RL) of adhesive coated fleece (ACF) with fibers running parallel the short side of the card body (CB) in the vertical axis, with the outer wood layers (WL) and intermediate reinforcement layers (RL) providing mechanical support and stability to the core discontinuous metal layer (DML), and wherein the adhesive coating (AC) on both sides of the reinforcement layers (RL) is a c-stage thermosetting adhesive after final lamination of the complete assembly. The outer wood layers (WL) and reinforcement layers (RL) may be compressed or densified during press lamination resulting in material shrinkage. See, for example, FIG. 14C.

Conversely, a discontinuous metal layer (DML) with a laser-cut slit(S) running parallel the short side of the card body (CB) may have outer wood layers (WL) with a grain direction running parallel the long side of the card body (CB).

The rear wood layer (WL) as shown in FIG. 14C may be replaced by another material layer such as leather (410 μm) which may be compressed in thickness during press lamination process.

According to an embodiment of the invention, a wooden transaction card (WTC) may comprise outer (front and rear) wooden (veneer) and a core continuous metal layer (CML; without a slit), with the presence of the continuous metal layer attenuating the electromagnetic field generated by a contactless terminal, wherein a magnetic shielding layer (MSL) offsets said attenuation effect and is adhesively attached to the underside of the continuous metal layer with a booster antenna (BA) or booster antenna circuit (BAC) spaced from the magnetic shielding layer using an adhesive spacing layer (ASL) or an adhesive coated substrate layer (SL) providing a spacing distance between the booster antenna and the magnetic shielding layer of 50 μm to allow contactless communication operating from the rear side of the card body (CB). In other words, with the magnetic shielding layer disposed in front of the booster antenna, contactless interaction with the card may be only one-sided, from the rear of the card. Arranged otherwise, with the magnetic shielding layer disposed behind (to the rear of) the booster antenna, contactless interaction with the card may be only one-sided, from the front of the card. Disposing the shielding layer in front of the antenna enables in contactless communication being operative from the rear of the card.

Disposing the shielding layer behind of the antenna enables in contactless communication being operative from the front of the card.

According to an embodiment of the invention, the compression of the front wood veneer layer during press lamination shrinks to a thickness (pressure dependent) equal to the combined thickness of the module tape (MT) or chip carrier tape of the dual interface chip module (TCM) and the mounting tape.

According to an embodiment of the invention, a smartcard (SC), or wooden transaction card (WTC) having a front face and a rear face, may comprise:
a front subassembly (FS) comprising a front face wooden layer (WL);
a rear subassembly (RS) comprising a rear face wooden layer (WL); and
a core subassembly (CS) disposed between the front and rear subassemblies, comprising:
   an upper reinforcement layer (RL) such as a substrate layer (SL, SB) with an adhesive coating or an adhesive layer (AL) on upper/front and lower/rear surfaces (sides) thereof (see FIG. 11);
   a lower reinforcement layer (RL) such as a substrate layer (SL, SB) with an adhesive coating or an adhesive layer (AL) on upper/front and lower/rear surfaces (sides) thereof (see FIG. 11); and
   a discontinuous metal layer (DML) functioning as a coupling frame (CF) disposed (sandwiched) between the upper and lower reinforcement layers.

A card body subassembly (CBS) may comprise the front subassembly (FS), rear subassembly (RS), and core subassembly (CS). Additional front layers (AFL) and additional rear layers (ARL) may be disposed on the front and rear faces, respectively, of the card body subassembly. Compare, for example, FIG. 12A.

A (transponder) chip module (CM, TCM) may be implanted into the card body subassembly (CBS) of the smartcard. The chip module has an upper portion with a P1 cross-dimension, and a lower portion with a P2 cross-dimension. The P1 cross-dimension is greater than the P2 cross-dimension.

A module opening (MO) may extend into the card body subassembly (CBS) from the front surface of the smartcard, wherein:
the wooden layer of the front subassembly has a module opening with a P1 dimension; and
the reinforcement layers and discontinuous metal layer of the core subassembly have module openings with a P2 cross-dimension.

According to an embodiment of the invention, smartcard (SC), or wooden transaction card (WTC) having a front face and a rear face, may comprise:
a front subassembly (FS) comprising a front face continuous metal layer (ML, CML) which does not have a slit(S) and which does not function as a coupling frame (CF);
a rear subassembly (RS) comprising a rear face wooden layer (WL); and
a core subassembly (CS) disposed between the front and rear subassemblies, comprising:
   an upper reinforcement layer (RL) such as a substrate layer (SL, SB) with an adhesive coating or an adhesive layer (AL) on upper/front and lower/rear surfaces (sides) thereof (see FIG. 11);
   a lower reinforcement layer (RL) such as a substrate layer (SL, SB) with an adhesive coating or an adhesive layer (AL) on upper/front and lower/rear surfaces (sides) thereof (see FIG. 11); and
   a booster antenna (BA, BAC) disposed (sandwiched) between the upper and lower reinforcement layers; and
   a magnetic shielding layer (MSL) disposed between the upper reinforcement layer and the booster antenna to shield the booster antenna from the front face metal layer (ML); and
   an adhesive layer (AL, ASL) disposed between the booster antenna and the magnetic shielding layer.

A card body subassembly (CBS) may comprise the front subassembly (FS), rear subassembly (RS), and core subassembly (CS). Additional front layers (AFL) and additional rear layers (ARL) may be disposed on the front and rear faces, respectively, of the card body subassembly. Compare, for example, FIG. 12A.

A (transponder) chip module (CM, TCM) may be implanted into the card body subassembly (CBS) of the smartcard. The chip module has an upper portion with a P1 cross-dimension, and a lower portion with a P2 cross-dimension. The P1 cross-dimension is greater than the P2 cross-dimension.

A module opening (MO) may extend into the card body subassembly (CBS) from the front surface of the smartcard, wherein:
the metal layer of the front subassembly has a module opening with a P1 dimension; and
the upper reinforcement layer and magnetic shielding layer of the core subassembly have module openings with a P2 cross-dimension.

According to an embodiment of the invention, a smartcard (SC), or wooden transaction card (WTC) having a front face and a rear face, may comprise:
a front subassembly (FS) comprising a front face wooden layer (WL);
a rear subassembly (RS) comprising a rear face wooden layer (WL); and
a core subassembly (CS) disposed between the front and rear subassemblies, comprising:
   an upper reinforcement layer (RL) such as a substrate layer (SL, SB) with an adhesive coating or an adhesive layer (AL) on upper/front and lower/rear surfaces (sides) thereof (see FIG. 11);
   a lower reinforcement layer (RL) such as a substrate layer (SL, SB) with an adhesive coating or an adhesive layer (AL) on upper/front and lower/rear surfaces (sides) thereof (see FIG. 11); and
   a booster antenna (BA, BAC) disposed (sandwiched) between the upper and lower reinforcement layers; and

In this embodiment, there is no magnetic shielding layer (MSL) and no separate adhesive coating or adhesive layer (AL) since no shielding from a front face continuous metal layer is needed.

A card body subassembly (CBS) may comprise the front subassembly (FS), rear subassembly (RS), and core subassembly (CS). Additional front layers (AFL) and additional rear layers (ARL) may be disposed on the front and rear faces, respectively, of the card body subassembly. Compare, for example, FIG. 12A.

A (transponder) chip module (CM, TCM) may be implanted into the card body subassembly (CBS) of the smartcard. The chip module has an upper portion with a P1 cross-dimension, and a lower portion with a P2 cross-dimension. The P1 cross-dimension is greater than the P2 cross-dimension.

A module opening (MO) may extend into the card body subassembly (CBS) from the front surface of the smartcard, wherein:
the wooden layer of the front subassembly has a module opening with a P1 dimension; and
the upper reinforcement layer of the core subassembly has a module opening with a P2 cross-dimension.

According to an embodiment of the invention, a smartcard (SC), or wooden transaction card (WTC) having a front face and a rear face, may comprise:
a front subassembly (FS) comprising a front face wooden layer (WL) and an adhesive layer (AL) disposed behind the wooden layer;
a rear subassembly (RS) comprising a rear face wooden layer (WL); and
a core subassembly (CS) disposed between the front and rear subassemblies, comprising:
   a continuous metal layer (ML, CML);
   an adhesive layer (AL) disposed behind (below) the metal layer:
   a magnetic shielding layer (MSL) disposed behind the adhesive layer;
   a reinforcement layer (RL) such as a substrate layer (SL, SB) with an adhesive coating or an adhesive layer (AL) on upper/front and lower/rear surfaces (sides) thereof (see FIG. 11) disposed behind (under) the magnetic shielding layer.

A card body subassembly (CBS) may comprise the front subassembly (FS), rear subassembly (RS), and core subassembly (CS). Additional front layers (AFL) and additional rear layers (ARL) may be disposed on the front and rear faces, respectively, of the card body subassembly. Compare, for example, FIG. 12A.

A (transponder) chip module (CM, TCM) may be implanted into the card body subassembly (CBS) of the smartcard. The chip module has an upper portion with a P1 cross-dimension, and a lower portion with a P2 cross-dimension. The P1 cross-dimension is greater than the P2 cross-dimension.

A module opening (MO) may extend into the card body subassembly (CBS) from the front surface of the smartcard, wherein:
the wooden layer and adhesive layer of the front subassembly have module openings with a P1 dimension; and
the metal layer, adhesive layer, and magnetic shielding layer of the core subassembly have module openings with a P2 cross-dimension.

Stack-up constructions of wooden layers, adhesive layers, reinforcement layers, support layers, continuous metal layers, discontinuous metal layers and booster antennas in configurations other than those that have been explicitly shown herein are intended to be within the scope of the invention.

In their various embodiments, the invention(s) described herein may relate to industrial and commercial industries, such RFID applications, payment smartcards, electronic credentials, identity cards, loyalty cards, access control cards, key-cards, biometric cards, and the like.

Other objects, features and advantages of the invention(s) disclosed herein may become apparent in light of the following illustrations and descriptions thereof.

### BRIEF DESCRIPTION OF THE DRAWINGS

Reference will be made in detail to embodiments of the disclosure, non-limiting examples of which may be illustrated in the accompanying drawing figures (FIGs). The figures may generally be in the form of diagrams. Some elements in the figures may be stylized, simplified or exaggerated, others may be omitted, for illustrative clarity.

Although the invention is generally described in the context of various exemplary embodiments, it should be understood that it is not intended to limit the invention to these particular embodiments, and individual features of various embodiments may be combined with one another. Any text (legends, notes, reference numerals and the like) appearing on the drawings are incorporated by reference herein.

Some elements and (sub) assemblies may be referred to with letters (“CB”, “CBS”, “CS”, “FS”, “MO”, “MS”, “RL”, “RS”, “SC”, “TCM”, “WL”, etc.) rather than or in addition to numerals. Some similar (including substantially identical) elements in various embodiments may be similarly numbered, with a given numeral such as “310”, followed by different letters such as “A”, “B”, “C”, or “a”, “b”, “c”, etc. (resulting in “310A”, “310B”, “310C” or “310a”, “310b”, “310c”), and may collectively be referred to simply by their common numeral (“310”).

FIG. 1 (compare FIG. 1 of US 2024/0001585) is a perspective view of a laminated structure consisting of four rectangular layers of densified wood veneer whereby adjacent layers have different wood grain directions, according to the prior art.

FIG. 2 (compare FIG. 3 of US 2024/0001585) is a cross-sectional view of a portion of a card, according to the prior art.

FIG. 3 (compare FIG. 4 of US 2024/0001585) is an exploded assembly drawing (perspective view) of a card with electronic functionality, according to the prior art.

FIG. 4 (compare FIG. 5 of US 2024/0001585) is a perspective view of a card with electronic functionality, according to the prior art.

FIG. 5A (compare FIG. 1 of US 2022/0184931) is an exploded perspective view of a wooden card, according to the prior art.

FIG. 5B (compare FIG. 11 of U.S. Pat. No. 10,832,115) is an exploded perspective view of a wood-on-wood inlay, according to the prior art.

FIGS. 6A, 6B (compare FIG. 2H of US 2015/0269477) is (two) front views of a dual-interface metal hybrid smartcard with a discontinuous metal frame (DMF) around the perimeter of the card body and the booster antenna inside the free space of the metal frame, according to the prior art.

As used herein, in describing some of the following figures of embodiments of the invention, the terms “6-ply”, “5-ply”, “4-ply”, “2-ply”, and the like, may refer to the number of wood or wooden (veneer) layers (WL) in the stack-up construction of a wooden transaction card (WTC; or simply wood or wooden card).

FIG. 7 is an exploded perspective view of a construction of a 5-ply construction of a wooden card (WTC), according to an embodiment of the invention.

FIG. 8A is an exploded perspective view of a construction of a 5-ply construction of wooden card (WTC) having a booster antenna BA incorporated in a reinforcement layer RL, according to an embodiment of the invention.

FIG. 8B is an exploded perspective view of a construction of a 4-ply wooden card having a booster antenna BA, according to an embodiment of the invention.

FIG. 9A is an exploded perspective view of a construction of a 2-ply wooden card WTC having a discontinuous metal layer DML serving as coupling frame CF (a metal layer having a slit) supported by upper and lower reinforcement layers RL, according to an embodiment of the invention.

FIGS. 9B, 9C, 9D, 14A and 14B may refer to “metal wood hybrid” or “wood metal hybrid” transaction cards which are a subset of wooden transaction cards WTC. The aforementioned US 2015/0269477 (refer to FIGS. 6A, 6B), incorporated by reference herein, refers to a hybrid metal smartcard with a booster antenna or coupling frame.

FIG. 9B is an exploded perspective view of a construction of a metal wood hybrid transaction card having a core subassembly CS comprising an upper reinforcement layer RL, a magnetic shielding layer MSL, an adhesive spacing layer AL, a booster antenna and a lower reinforcement layer RL, according to an embodiment of the invention.

FIG. 9C is an exploded perspective view of a construction of a wood metal hybrid transaction card having a core subassembly CS comprising an upper reinforcement layer RL, a booster antenna, BA an adhesive spacing layer AL, a magnetic shielding layer MSL, and a lower reinforcement layer RL, according to an embodiment of the invention.

FIG. 9D is an exploded perspective view of a construction of a wood metal hybrid transaction card having a top wood layer forming a front subassembly FS and a core subassembly comprising a reinforcement layer, an opening, an antenna insert AI and a bottom metal layer ML with an which is filled with a composite layer of wood veneer, according to an embodiment of the invention.

FIG. 9E is a top (plan) view of the bottom metal layer forming the core subassembly CS suitable for use with the wood metal hybrid transaction card shown in FIG. 9D having a “Large Opening” to accept the placement of an antenna insert (not shown; see FIG. 9D) before filling with a composite (not shown) of wood veneer chips and adhesive, according to an embodiment of the invention.

FIG. 10 is an exploded perspective view of a construction of a 6-ply wooden card WTC, according to an embodiment of the invention.

FIG. 11 is an exploded perspective view of a reinforcement layer RL comprising a substrate layer SB with adhesive layers AL on both sides thereof illustrating a process of adhesive transfer, according to an embodiment of the invention.

FIGS. 12A, 12B, 12C, 12D, 13B, and 13C may refer to a “timber metal transaction card” TMTC (or timber metal hybrid transaction card; FIG. 14C) which is type of wooden transaction card WTC having a front face discontinuous metal layer (such as a coupling frame with a slit). This may be considered to be a type or subset of metal wood or wood metal hybrid card which is a type or subset of wooden transaction card WTC.

FIGS. 12A, 12B, 12C, and 12D show a chip module CM or transponder chip module TCM which will be implanted in a stepped (P1, P2) openings extending through front (top) layers of the card. The modules may be omitted from other figures set forth herein.

FIG. 12A is an exploded perspective view of a timber metal transaction card (TMTC) or smartcard having a front face discontinuous metal layer and a rear face wood (veneer) layer adhesively attached to and sandwiching a core subassembly comprising layers of wood veneer with adhesive layers for interlayer bonding and substrate layers for reinforcement (with the core subassembly forming a 3-ply wood veneer laminate with 2 adhesive coated substrate layers (ACSL: 4 interlayers of adhesive and 2 substrate layers)), wherein a booster antenna circuit is incorporated in a top adhesive layer and electrically connected to a chip module, according to an embodiment of the invention.

FIG. 12B is an exploded perspective view of a timber metal transaction card (TMTC) or smartcard having a front face discontinuous metal layer, an upper adhesive layer, a magnetic shielding layer and a lower adhesive layer forming a front subassembly and a rear face wood (veneer) layer with an adhesive layer forming a rear subassembly respectively laminated to a top and bottom surface of a core subassembly comprising wooden (veneer) layers WL with adhesive layers AL for interlayer bonding and substrate layers for reinforcement (forming a 3-ply wood veneer laminate with 2 adhesive coated substrate layers (ACSL: 4 interlayers of adhesive and 2 substrate layers)), wherein a booster antenna circuit (BA, BAC) for inductive coupling with the module antenna of a transponder chip module is incorporated into the top adhesive layer coated to the top substrate layer, according to an embodiment of the invention.

FIG. 12C is an exploded perspective view of a timber metal transaction card (TMTC) or smartcard having a front face wood veneer layer adhesively attached to an underlying discontinuous metal layer and a rear face wood veneer layer, sandwiching a core subassembly comprising upper and lower wood veneer layers with adhesive layers for interlayer bonding and a substrate layer for reinforcement (forming a 2-ply wood veneer laminate) with a booster antenna circuit (BAC) incorporated in a top adhesive layer and physically connected to a chip module, wherein the front face wood veneer layer receives graphic elements by mechanically engraving and or laser etching the features to the surface of the discontinuous metal layer, also referred to as knockout to metal, according to an embodiment of the invention.

FIG. 12D is an exploded perspective view of a timber metal transaction card (TMTC) or smartcard having a front face continuous metal layer (upward facing), an adhesive layer, a magnetic shielding layer and an adhesive coated substrate layer forming a front subassembly, and an adhesive coated substrate layer and a rear face wood veneer layer (downward facing) forming a rear subassembly, respectively laminated to a upper and lower surface of a laminated core subassembly comprising top and bottom wood (veneer) layers and intermediate adhesive coated substrate layers for bonding and reinforcement (forming a 2-ply wood veneer laminate with 4 interlayers of adhesive and 2 substrate layers), wherein a booster antenna circuit for inductive coupling with the module antenna of a transponder chip module is incorporated between the intermediate adhesive coated substrate layers and wherein the antenna circuit is a double-sided aluminum etched antenna on a PET carrier, according to an embodiment of the invention.

FIG. 13A is an exploded, perspective view of a laminated sheet assembly (stack-up, construction) in a 3×8 format having a plurality of card body sites SCB for production of a like plurality of smart cards, said laminated sheet having a front (top) exposed surface and a rear (bottom) exposed surface, said laminated sheet assembly comprising a front face continuous metal layer or metal foil, 1 adhesive layer, 3 wood veneer layers and 3 adhesive coated substrate layers for bonding and reinforcement, according to an embodiment of the invention.

FIG. 13B is an exploded perspective view of a timber metal transaction card (TMTC) or smartcard (SC) having a front face continuous metal layer or metal foil (CML, ML, MF) with a laser cut module opening (MO), an adhesive layer (AL), a magnetic shielding layer (MSL) and an adhesive coated substrate layer (ACSL) forming a front subassembly (FS), and an adhesive coated substrate layer (ACSL) and a rear downward facing wood veneer layer (WL) forming a rear subassembly (RS), respectively laminated to a upper and lower surface of a laminated core subassembly (CS) comprising top and bottom wood (veneer) layers (WL) and an intermediate adhesive coated substrate layer (ACSL) for bonding and reinforcement (forming a 2-ply wood veneer laminate with 2 interlayers of adhesive and 1 substrate layer), wherein a booster antenna circuit (BAC) for inductive coupling with the module antenna (MA) of a transponder chip module (TCM) is incorporated into an adhesive layer (AL) of the adhesive coated substrate layer (ACSL) and wherein the booster antenna (BA) is a wire embedded antenna circuit with a perimeter coil, coupler coil and extension coil, according to an embodiment of the invention.

FIG. 13C is an exploded perspective view of a timber metal transaction card (TMTC) or smartcard (SC) having a front subassembly (FS) comprising a front face continuous metal layer or metal foil (CML, ML, MF) with a laser cut module opening (MO), an adhesive layer (AL) with a module opening (MO), a magnetic shielding layer (MSL) with a module opening (MO) forming a front subassembly (FS) and a rear subassembly (RS) comprising three wood veneer layers (WL), upper, middle and lower, bonded between reinforcement layers of an adhesive coated substrate (ACSL) forming a 3-ply wood veneer laminate with 4 interlayers of adhesive and 2 substrate layers, with said front subassembly (FS) and rear subassembly (RS) laminated to upper and lower surfaces, respectively, of a (prepressed) core subassembly (CS) comprising an adhesive coated substrate layer (ACSL), wherein a booster antenna circuit (BAC) for inductive coupling with the module antenna (MA) of a transponder chip module (TCM) is incorporated into the bottom adhesive layer (AL) of the core adhesive coated substrate layer (ACSL) and wherein the booster antenna (BA) is a wire embedded antenna circuit with a perimeter coil, coupler coil and extension coil, according to an embodiment of the invention.

FIG. 14A is a frontal plan view of a coupling frame (CF) forming the core of a wood metal hybrid transaction card as shown in FIG. 9A, having a discontinuity in the form of a straight or shaped slit starting a peripheral edge of the coupling frame, extending to a module opening (Slit 1) and terminating at a point representing the center of the card body, and a transponder chip module having a module antenna and configured to be received atop the module opening of the coupling frame, wherein the RF performance of the inductively coupled transponder chip module is significantly improved via the discontinuity (Slit 2) extending to the center area of the coupling frame, according to an embodiment of the invention.

FIG. 14B is an exploded perspective view of a construction of a wood metal hybrid transaction card, similar to the construction shown in FIG. 9A. The transaction card comprising front and rear wood layers (stained or dyed) sandwiching a core subassembly (CS) incorporating a coupling frame (CF) with a straight or shaped slit(S) and module opening (MO), structurally stabilized by upper and lower reinforcement layers (RL), wherein the reinforcement layers comprise a calendered nonwoven fabric coated on both sides with an adhesive, according to an embodiment of the invention.

FIG. 14C is an exploded perspective view of a construction of a timber metal hybrid transaction card, comprising front and rear outer wood layers having a grain direction in the vertical axis and intermediate (upper and lower) reinforcement layers having fibers arranged in a vertical orientation, and said wood layers and reinforcement layers sandwiching a coupling frame with a straight or shaped slit and module opening with said slit running parallel the long side of the card body in the horizontal axis, and wherein the wood layers and reinforcement layers provide structurally stability to the card body, according to an embodiment of the invention.

### GLOSSARY

The following abbreviations may appear in the drawings and in the description that follows:

| | | | |
|---|---|---|---|
| LSA | laminated sheet assembly | CML | continuous metal layer |
| SC | smartcard | DML | discontinuous metal layer |
| WTC | wooden transaction card | G | gap |
| TMTC | timber metal transaction | ML | metal layer or metal foil |
| | card | | (MF) |
| SFL | sacrificial layer | CBS | card body subassembly |
| TCM | transponder chip module | CS | core subassembly |
| CM | chip module | FS | front subassembly |
| CP | contact pads | RS | rear subassembly |
| CB | card body | AFL | additional front layers |
| MA | module antenna | ARL | additional rear layers |
| MO | module opening | AI | antenna insert |
| WL | wood (or wooden) layer | BA | booster antenna (or booster |
| RL | reinforcement (or | | antenna circuit BAC) |
| | reinforcing) layer | CF | coupling frame |
| SL | substrate layer | MSL | magnetic shielding layer |
| ACSL | adhesive coated substrate | IL | impregnation layer |
| | layer | AW | artwork |
| AL | adhesive layer | PLV | post lamination varnish |
| ASL | adhesive spacing layer | TC | top coat |
| ACF | adhesive coated fleece | LM | laser marking |
| ACP | adhesive coated paper | MS | magnetic stripe |
| DD | decorative design | H | hologram |
| DP | deposited primer | HF | holographic foil |

### DESCRIPTION

Various embodiments (or examples) may be described to illustrate teachings of the invention(s), and should be construed as illustrative rather than limiting. It should be understood that it is not intended to limit the invention(s) to these particular embodiments. It should be understood that some individual features of various embodiments may be combined in different ways than shown, with one another. Reference herein to “one embodiment”, “an embodiment”, or similar formulations, may mean that a particular feature, structure, operation, or characteristic described in connection with the embodiment is included in at least one embodiment of the present invention. Some embodiments may not be explicitly designated as such (“an embodiment”).

The embodiments and aspects thereof may be described and illustrated in conjunction with systems, devices and methods which are meant to be exemplary and illustrative, not limiting in scope. Specific configurations and details may be set forth in order to provide an understanding of the invention(s). However, it should be apparent to one skilled in the art that the invention(s) may be practiced without some of the specific details being presented herein.

Furthermore, some well-known steps or components may be described only generally, or even omitted, for the sake of illustrative clarity. Elements referred to in the singular (e.g., “a widget”) may be interpreted to include the possibility of plural instances of the element (e.g., “at least one widget”), unless explicitly otherwise stated (e.g., “one and only one widget”).

In the following descriptions, some specific details may be set forth in order to provide an understanding of the invention(s) disclosed herein. It should be apparent to those skilled in the art that these invention(s) may be practiced without these specific details. Any dimensions and materials or processes set forth herein should be considered to be approximate and exemplary, unless otherwise indicated. Headings (typically underlined) may be provided as an aid to the reader, and should not be construed as limiting.

Reference may be made to disclosures of prior patents, publications and applications. Some text and drawings from those sources may be presented herein, but may be modified, edited or commented to blend more smoothly with the disclosure of the present application.

Cards incorporating transponder chip modules are known, such as may be shown in the following patents and patent publications, incorporated by reference herein: U.S. Pat. Nos. 9,272,370; 9,390,364; 9,489,613; and US 2013/0126622.

Cards incorporating wood veneer layers are known, such as may be shown in the following patents and patent publications, incorporated by reference herein: U.S. Pat. Nos. 8,579,201; 10,572,784; 10,832,115; US 2010/0033297; US 2019/0311238; US 2022/0184931; WO 96/23276; and WO 2022/112610.

Reference(s) may be made to links for some websites on the world wide web. The standard (“https” . . . , sometimes including “www”) prefixes may be omitted, or replaced by “internet”.

As used herein, generally, a wooden transaction card (WTC) is a type of smart card (SC) which comprises one or more wood (or wooden) layers (WL) which may be wooden veneer layers. In some embodiments, a booster antenna (BA) may be incorporated into the construction, typically in an adhesive layer (AL) of a reinforcing layer (RL) which may comprise a substrate (or support) layer (SL) having an adhesive layer on at least one side thereof.

Embodiments of wooden transaction cards (WTC) disclosed herein generally comprise card bodies (CB) having several wooden (veneer) layers (WL) which are stacked up and laminated together with adhesive layers (AL) disposed between adjacent ones of the wooden layers. Some of the wooden layers may be sliced wooden layers (SWL), some of the wooden layers may be peeled wooden layers (PWL). Adhesive-coated substrate layers (ACSL) may be included in the stack-up, and may comprise a reinforcement layer (RL) which is a substrate layer (SL) having adhesive layers or coatings disposed on both sides thereof. A wire antenna structure (AS) functioning as a booster antenna (BA) may be embedded into one of the adhesive layers on the substrate layer. In the exploded views of embodiments of the invention, front (top) surfaces of the various layers are oriented towards the top of the page (sheet), and rear (bottom) surfaces of the various layers are oriented towards the bottom of the page (sheet).

It should be understood that all dimensions (such as thickness and weight) and process parameters (such as pressure, temperature and dwell time) may be considered to be approximate (may include dimensions and parameters ranging +/−5 or 10% from a stated “nominal” value), unless indicated otherwise. Sometimes, ranges may be specified, such as:
The thickness of the adhesive layers (AL), nominally 25 μm, may range from 20-30 μm, prior to lamination.
The thickness of the card body (CB), nominally 760 μm, may range from 760-800 μm, after lamination.
The thickness of a stack-up of layers, before press lamination, nominally 1350 μm, may range from 1300-1400 μm.
The thickness of a laminated assembly of layers, after press lamination, nominally 800 μm, may be 760-800 μm.
A lamination pressure applied to the stack-up, nominally 250 N/cm², may be between 200 to 300 N/cm².
A lamination pressure applied to the stack-up, nominally 1250 N/cm², may be between 1200 to 1300 N/cm².
Wooden (veneer) layers (WL, PWL) having a nominal preconditioned (drying process at the mill) thickness of 150 μm may be between 125 μm and 175 μm.
Wooden (veneer) layers (WL, SWL) having a nominal preconditioned (drying process at the mill) thickness of 550 μm may be between 525 μm and 575 μm.

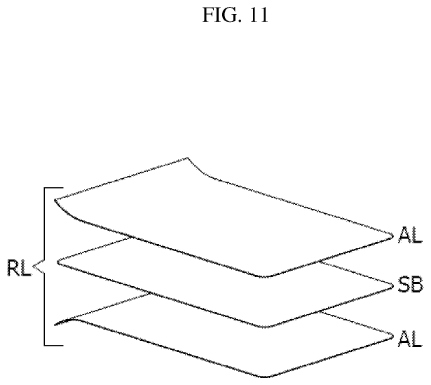

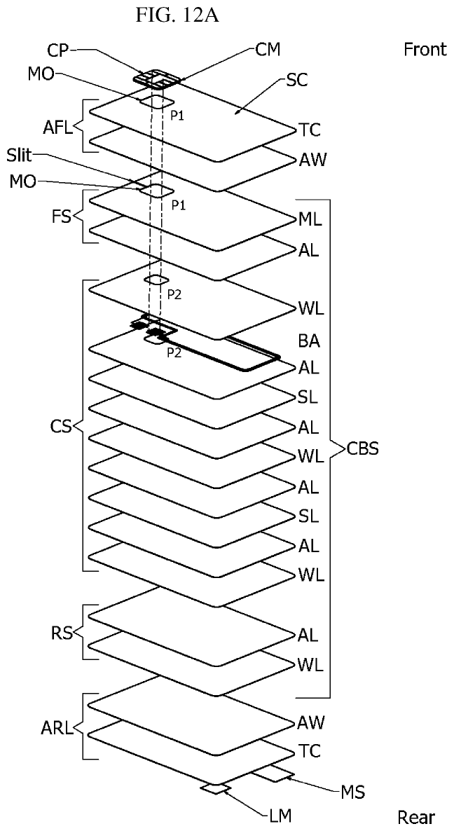

Some of the embodiments of the invention described herein may comprise two or more wooden (veneer) layers (WL) and may also comprise two or more reinforcement layers (RL). A typical reinforcement layer (RL) may comprise a substrate layer (SL) having adhesive or adhesive layers (AL) disposed on both sides or surfaces (i.e., front or top, and rear or bottom) thereof. See, for example, FIG. 11.

The wooden layers (WL) and reinforcement layers (RL) may be arranged in a “stack-up” construction of a smart card body (CB) or, more specifically in subassemblies of the card body, such as a front subassembly (FS), a rear subassembly (RS), and a core subassembly (CS) disposed between the front and rear subassemblies. As used herein, the terms “front” and “rear” may appear in some of the figures, and refer to the top (or front face) and bottom (or rear face), as viewed in the figures, of the resulting smart card (SC) which may be a wooden transaction card (WTC) or variation thereof (such as a hybrid metal wood transaction card), or the like.

Terms such as “front”, “top”, “frontmost”, “topmost” and the like may be used to distinguish similar (such as wooden) layers from one another in descriptions of the constructions presented herein. Similarly, terms such as “rear”, “bottom”, and the like may be used to distinguish similar (such as reinforcement) layers from one another. Also, it should be understood that the layers described herein are generally planar, having length and width dimensions substantially equal to the overall dimensions of the card body (CB), the ISO standard for which is 85.60 mm width (long dimension), 53.98 mm height (short dimension). References may be made to front (or top) surfaces (or sides) of layers (such as WL, RL, SL, AL, ML, DMC, CML) consistent with how these surfaces appear in relevant figures. The ISO standard for card thickness is 0.76 mm (760 μm) thick. The individual layers typically have thicknesses which are a fraction of that, such as approximately 100 μm.

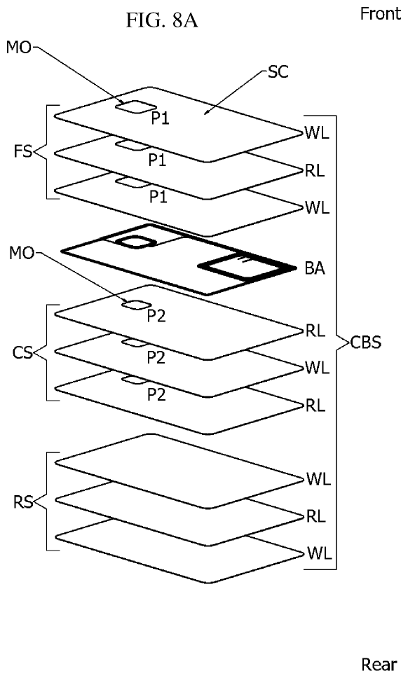

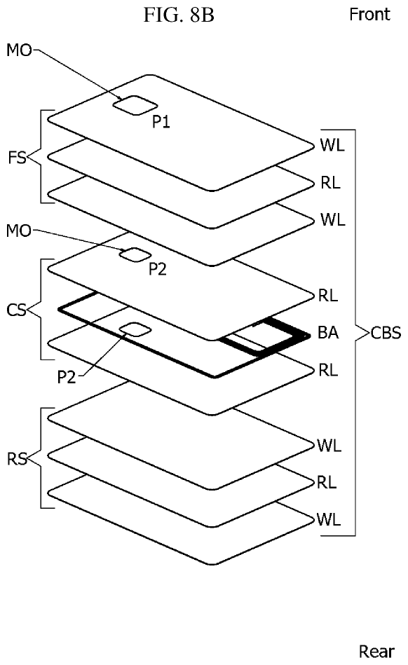

In some of the embodiments described herein, the frontmost layer of the front subassembly (FS) of the card body (CB) may be a wooden layer (WL), see for example FIGS. 8A, 8B, 9A, 9C, 9D, 10, 12C.

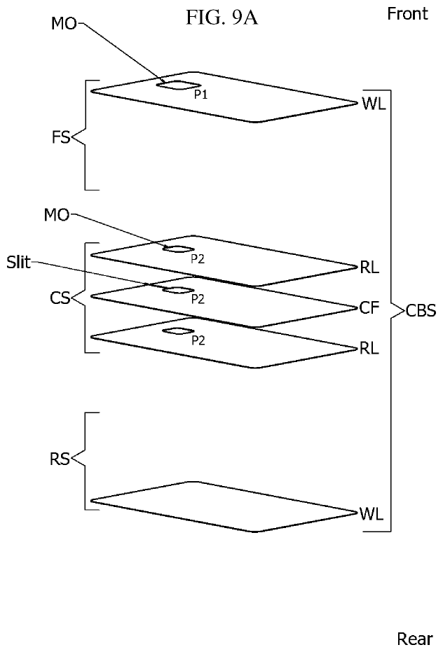

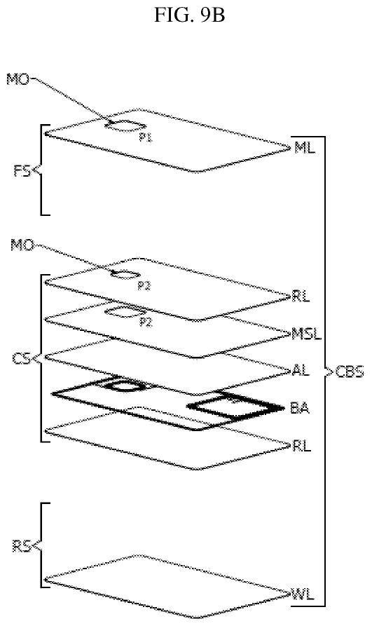

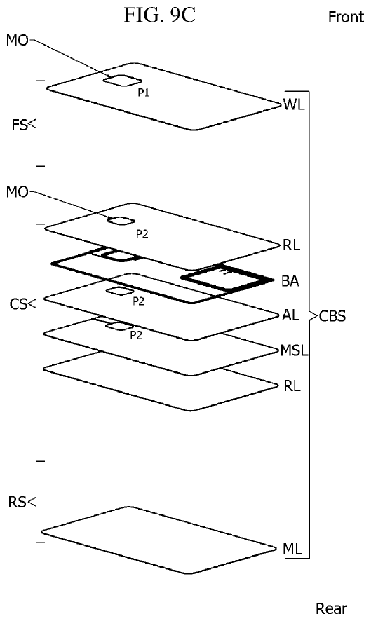

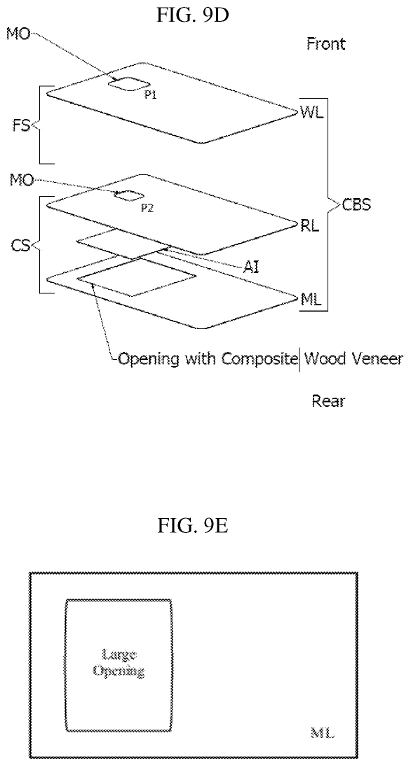

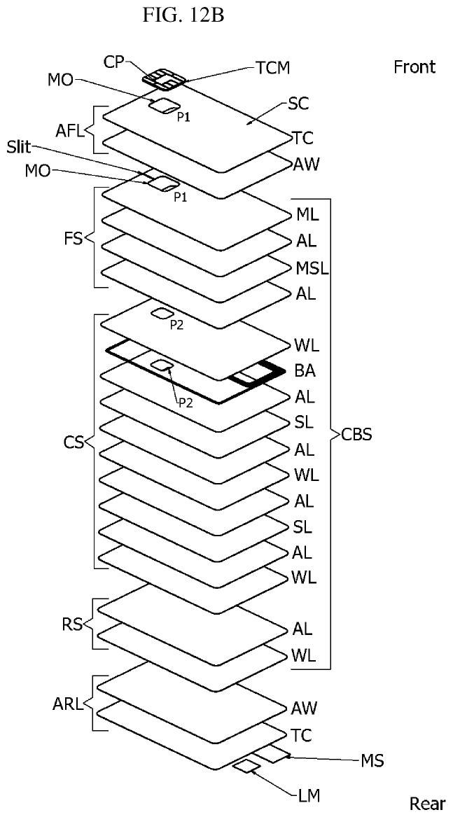

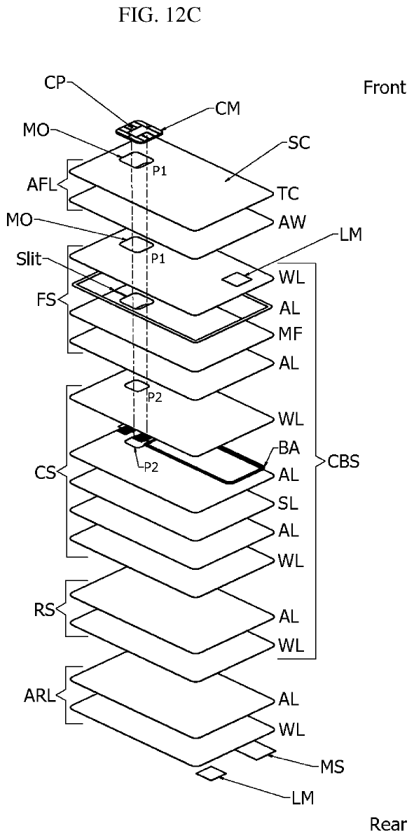

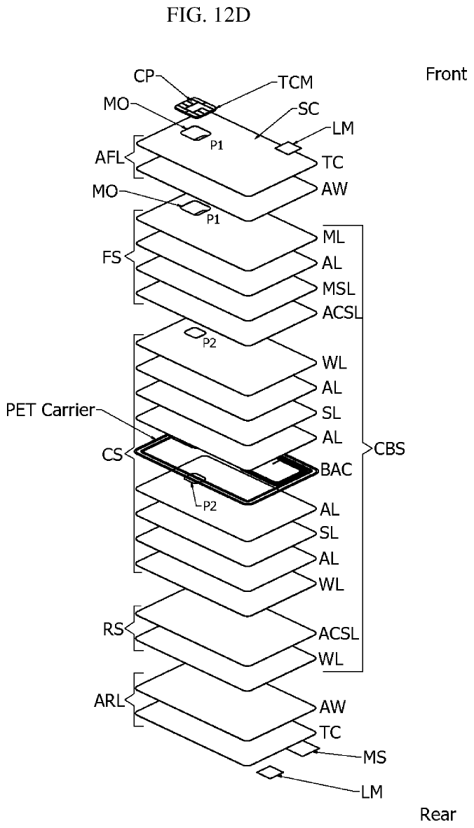

In some of the embodiments described herein, the frontmost layer of the front subassembly (FS) of the card body (CB) may be a metal layer (ML; CML), see for example FIGS. 9B, 12A, 12B, 12D.

The three subassemblies (FS, CS, RS) may be laminated together to form a card body subassembly (CBS). Additional front layers (AFL) may be disposed on a front side of the laminated card body subassembly (CBS). A chip module or transponder chip module (TCM) may be disposed in a module opening (MO) extending into the card body (CB) from a front surface thereof through the additional front layers (AFL) and further into some of the layers of the core subassembly (CS), resulting in contact pads (CP) of the chip module or transponder chip module (TCM) being exposed on the front surface (obverse) of the card. Additional rear layers (ARL) may be disposed on a rear side of the laminated card body subassembly (CBS). A magnetic stripe (MS) may be disposed on the rear surface of the card.

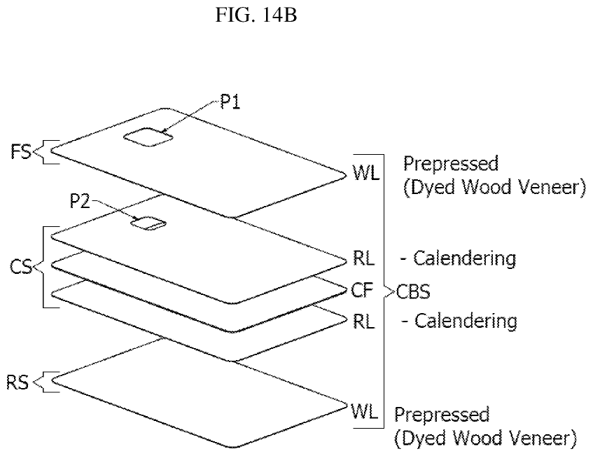

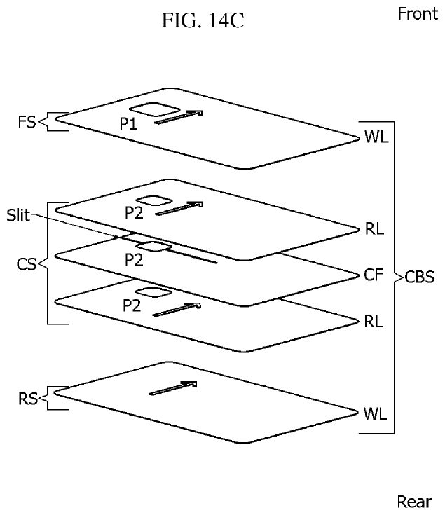

In addition to the above, other elements may be incorporated in the stack-up construction of the card. For example, a booster antenna (BA) or booster antenna circuit (BAC) may be incorporated in the construction. See, for example, FIGS. 8A, 8B, 9B, 9C, 12A, 12B, 12C, 12D, 13A, 13B, 13C. In some embodiments, a coupling frame (CF) or discontinuous metal layer (DML) may be incorporated in the construction. See, for example, FIGS. 12C, 14A. A magnetic shielding layer (MSL) may be incorporated into the construction. See, for example, FIG. 12D.

Pressure and heat are used to laminate the various constructions with their layers and elements together. Typically, the laminating process will result in compressing the stack-up construction from an initial thickness of 1300-1400 μm, to a desired ISO-compliant thickness of 760-800 μm. In some embodiments, front and rear wooden layers may be thinned, such as by sanding, after lamination to achieve the desired ISO-compliant thickness.

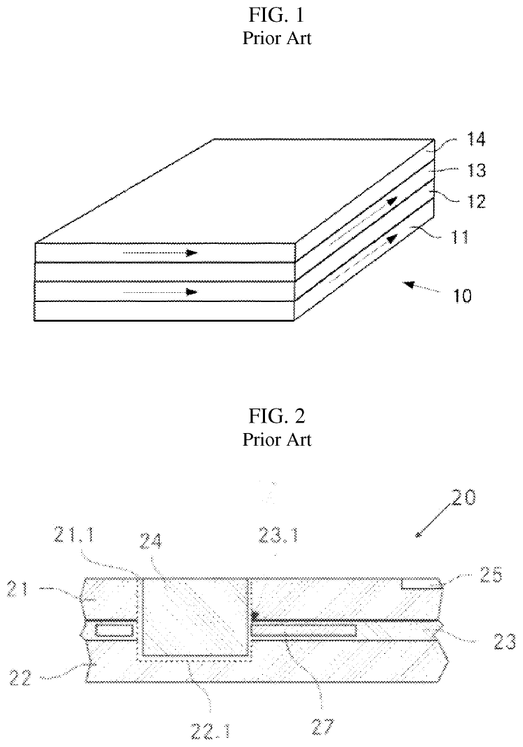

FIG. 1 shows a laminated structure consisting of four rectangular layers of densified wood veneer whereby adjacent layers have different wood grain directions, according to the prior art. A process is described in order to produce a densified wood veneer. In a first step, a wood veneer specimen with a thickness of about 0.6 mm, e.g. of maple wood, was used as hygroscopic materials and pre-conditioned to a moisture content of about 12-13% wood moisture. In a second step, the pre-conditioned wood veneer specimen was packed in a gas-tight manner in temperature resistant and moisture tight metal foil. Subsequently, the foil-packed wood veneer specimen with adjusted moisture content of 12-13% was pre-heated to about 70° C. in a mechanical press in contact mode with only 1 MPa pressure. Then the pressure was raised to 30 MPa at a rate of 15 MPa/minute and kept for 0.5-5 minutes at the temperatures of 70° C. as set before. Thereafter, without affecting the pressure set before, the temperature was raised to a temperature of about 170-185° C. at a rate of 10-20 K/minute and kept for 10 minutes. After this pressing and heating process, the temperature was cooled down actively to room temperature and the pressure was released. This figure shows a laminated structure 10 which was produced by laminating four rectangular layers of densified wood veneer 11, 12, 13, 14 as obtained in the above described process. The structure was formed by bonding adjacent layers 11, 12, 13, 14 together with an adhesive, e.g. a polyurethane or any other adhesive. As indicated by the arrows, the wood grain direction of adjacent layers are perpendicular to each other. This gives a highly stable laminated structure with reduced flexibility.

FIG. 2 shows a card 20. An upper layer 21 (front side of the card) and a lower layer 22 (backside of the card) each consist of a densified wood veneer obtained according to the above described process. A middle layer 23 consisting of a support sheet (densified veneer) with an integrated/glued electromagnetic coil 27 are provided and are cut to the same size as the upper and lower layers 21, 22. In the upper layer 21 and the middle layer 23, a rectangular opening 21.1, 23.1 for an integrated circuit chip 24 with electrical surface contacts 24.1 was cut. In the lower layer 22, a rectangular recess 22.1 (deepness of approximately 0.1 mm) is engraved to provide additional place for the chip 24. The chip 24 and the electromagnetic coil 27 are fully embedded within the card body.

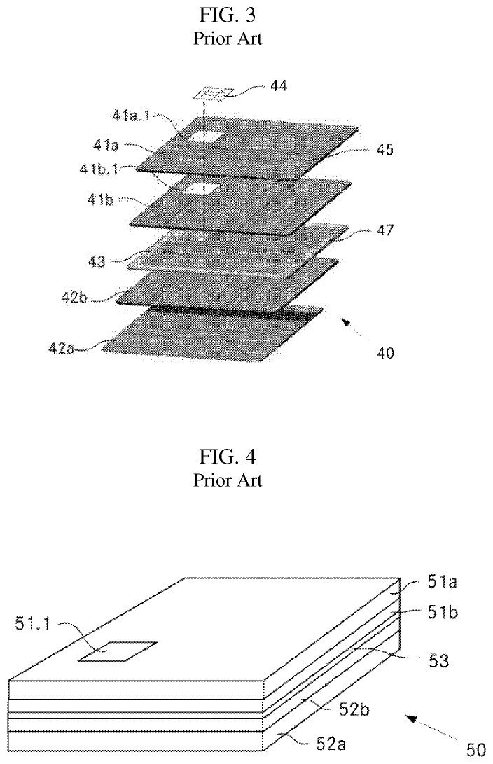

FIG. 3 shows a card 40 with electronic functionality, according to the prior art. Card 40 comprises an upper part consisting of two laminated densified wood veneers 41a, 41b. The wood grain direction of the densified wood veneers 41a, 41b are perpendicular to each other. Both wood veneers 41a, 41b comprise a rectangular opening 41a.1, 41b.1 for receiving an integrated circuit chip 44. The outermost wood veneer 41a furthermore carries a printed logo 47 on the outer side. A lower part of card 40 consists of two further laminated densified wood veneers 42a, 42b. Also in this case, the wood grain direction of the densified wood veneers 42a, 42b are perpendicular to each other. In the middle of the card, there is an inlay 43 consisting of a wood veneer carrying an electromagnetic antenna 47 with contacts for chip 44. All of the layers 41a, 41b, 43, 42a, 43b of the card are adhesively bonded together in the final product. Card 40 consists of five densified wood veneers whereby the wood grain direction of adjacent veneers are perpendicular to each other. Therefore, card 40 is especially robust from a mechanical point of view.

FIG. 4 shows a card 50 with electronic functionality, according to the prior art. The card 50 is a laminated structure made from five layers of a hygroscopic material. Specifically, it comprises two top layers 51a, 52a of wood veneer, two thin mid layers 51b, 52b of wood veneer and an inlay layer 53 comprising a metal antenna 57 with contacts for a chip on a paper. A thickness of each of the two top sheets 51a, 52a is for example 0.6 mm whereas a thickness of the two thin mid sheets 51b, 52b is for example 0.2 mm. The inlay layer 53 has for example a thickness of 0.1 mm. Similar to card 40, card 50 comprises an opening or recess 51.1, respectively, for receiving an integrated circuit chip.

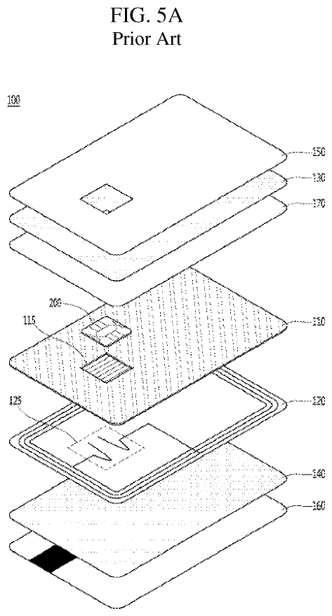

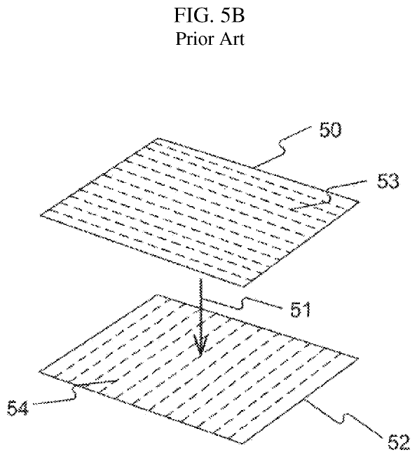

FIG. 5A shows a wooden card 100, according to the prior art. The wooden card 100 includes a wood sheet layer 110, an antenna inlay layer 120 stacked under the wood sheet layer 110 and having an antenna coil inlaid on an inlay core sheet, a core layer 170, a first printing layer 130, and a first overlay layer 150 sequentially stacked on the wood sheet layer 110, and a second printing layer 140 and a second overlay layer 160 sequentially stacked under the antenna inlay layer 120. The second overlay layer 160 may be a magnetic stripe overlay layer (MS O/L) in which a magnetic strip is overlaid. Other components such as a coating layer, a hologram layer, an adhesive layer and the like for implementing a wooden card may be further added, and a display unit, a biological sensor unit and the like may be additionally included for additional functions. The sheets constituting the wooden card 100 of the present invention may be configured as a large sheet of a size including a plurality of cards to make mass production possible, rather than as a sheet for making one card. A wood material constituting the wood sheet layer 110 may be formed by cutting solid wood logged in the nature into a predetermined size and processing a square wood bar of a rectangular parallelepiped shape while expressing the characteristics of wood. In addition, when the wood tissues are softened and sterilized by steaming and boiling the square wood bar, the cutting work may be easy. In addition, preferably, the process may be facilitated by drying the boiled wood to have a moisture content of 20 to 25%. The wood sheet layer 110 may be shaped in a solid wood sheet having a thickness of 0.1 to 0.8 mm by thinly cutting a dried square wood bar using a wide blade, and cutting of the square wood bar may be made in a slicing method. A synthetic resin emulsion woodworking adhesive, which is a non-toxic and eco-friendly material, may be used as a water-based adhesive for stacking wood sheets and attaching upper and lower layers. The upper and lower sheet layers 120, 130, 140, 150, 160 and 170 are laminated by heating and pressing overall after the water-based adhesive is cured, a wooden card body including solid wood can be manufactured first.

FIG. 5B shows a wood-on-wood inlay, according to the prior art. A horizontal grain direction (as indicated by 53) of first wood layer 50 is rotated to 90 degrees with respect to a vertical grain direction (as indicated by 54) of second wood layer 52. That is, first wood layer 50 and second wood layer 52 are stacked with their grain structure perpendicular to each other. Herein, a horizontal grain direction indicates that the grain pattern may parallel the length of the card, while a vertical grain direction indicates that the grain pattern may parallel the width of the card.

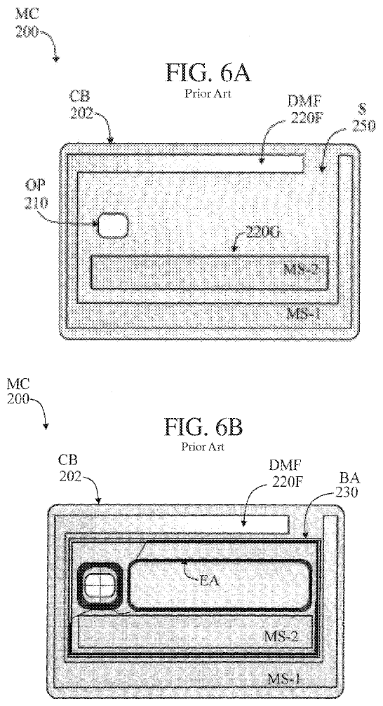

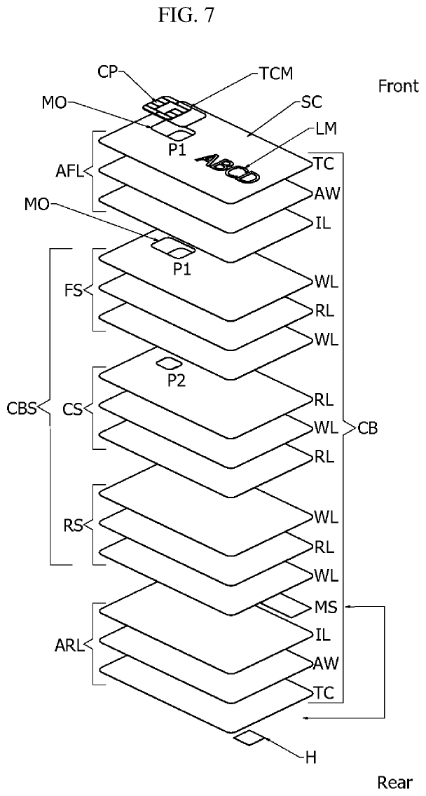

FIGS. 6A, 6B show a dual-interface metal hybrid smartcard with a discontinuous metal frame (DMF) around the perimeter of the card body and the booster antenna inside the free space of the metal frame.

### A Typical Smartcard

A typical smartcard SC has a card body CB with an opening (or recess) MO for receiving a transponder chip module TCM. The card body is generally rectangular, having rounded (radiused) corners, measuring approximately 86 mm in its long dimension (length, or base) and 54 mm in its short dimension (width, or height). The card body should have a thickness of 760 μm.

The card body CB typically comprises several layers of plastic (or synthetic) materials such as Polyvinyl Chloride (PVC), Polycarbonate (PC), PET-G (Polyethylene Terephtalate Glycol-modified), Polyvinyl alcohol (PVA), synthetic paper, paper and the like.

The transponder chip module TCM typically has a plurality (typically 6 or 8) of contact pads CP (or pins) disposed on a front (or top) surface thereof. The contact pads provide for the exchange of electrical signals between an integrated circuit IC in the transponder chip module and an external reader or terminal, such as a point-of-sale (POS) terminal or an automated teller machine (ATM), by physical contact between the contact pads of the transponder chip module and corresponding pins in the external reader or terminal.

When the transponder chip module is implanted into the module opening of the card body, the contact pads will be substantially coplanar (or slightly proud with respect to) the front surface of the card body.

A typical transponder chip module typically an overall thickness of ≤580 μm (wire bonded chip module). An upper (or top, or face-up) portion of the transponder chip module may have a relative large “P₁” cross-dimension such as 8.2 mm×10.8 mm for a 6 contact module and 11.8 mm×13.0 mm for an 8 contact module, and a thickness of 195 μm. A lower (or bottom, or face-down portion of the transponder chip module may have a smaller “P₂” cross-dimension such as 7.0×7.0 mm, and a thickness of 395 μm.

The module opening in the card body may have a relatively large upper portion extending into the card body from the front thereof into the interior thereof for accommodating the relatively large upper portion of the transponder chip module, and a smaller lower portion for accommodating the smaller lower portion of the transponder chip module, and may be referred to as a “stepped” opening.

Some examples of transponder chip modules that may be suitable for incorporating into the card construction disclosed herein may be found in U.S. Pat. Nos. 9,634,391 (25 Apr. 2017; Finn et al.), U.S. Pat. No. 8,833,668 (16 Sep. 2014; Grieshofer et al.) and U.S. Pat. No. 8,100,337 (24 Jan. 2012; Artigue et al.). Transponder chip modules suitable for incorporating into the card construction disclosed herein may be purchased from Infineon and SPS.

The card body CB may also include either a booster antenna BA (not shown) or a coupling frame CF (not shown) in or as one of the layers. As is known, booster antennas and coupling frames facilitate radio frequency (RF) or “contactless” communication between the transponder chip module (via a module antenna in the transponder chip module) and an external reader or terminal, such as a point-of-sale (POS) terminal or an automated teller machine (ATM).

Some examples of booster antennas that may be suitable for incorporating into the card constructions disclosed herein may be found in U.S. Pat. No. 9,033,250 (19 May 2015, Finn et al.), U.S. Pat. No. 9,195,932 (24 Nov. 2015; Finn et al.), and U.S. Pat. No. 9,633,304 (25 Apr. 2017; Finn et al.)

Some examples of coupling frames that may be suitable for incorporating into the card constructions disclosed herein may be found in US Patent Nos. U.S. Pat. No. 9,475,086 (25 Oct. 2016; Finn et al.) and U.S. Pat. No. 10,552,722 (4 Feb. 2020; Finn et al.).

The card body may also include elements such as embossed characters, security features, holograms, a magnetic stripe and the like, on its front and back surfaces.

The above description of a typical transponder chip module is prior art, is well understood, and is presented only for the purpose of establishing context for the present invention, and does not need any further discussion for purposes of this patent application.

### Some Wooden Card Constructions

FIG. 7 shows a construction of a wood (or wooden) smartcard (or transaction card) SC. The card body CB of the smartcard generally comprises a card body subassembly CBS, additional front layers AFL disposed on a front surface of the card body subassembly, and additional rear layers ARL disposed on a rear surface of the card body subassembly.

A generic transponder chip module TCM is shown positioned to be inserted into a module opening MO extending into the card body CB from a front surface thereof.

The card body subassembly CBS comprises a front subassembly FS, a rear subassembly RS, and a core subassembly CS disposed between the front and rear subassemblies. Each of the front, rear and core subassemblies comprise one or more wooden layers WL and one or more reinforcement layers RL.

The wooden layers and reinforcement layers have the same size (length and width) as the card body (i.e., approximately 86 mm×54 mm), and have various thicknesses as described hereinbelow. In the figure, the thicknesses of the wooden layers and reinforcement layers are not drawn to scale.

The front subassembly FS comprises: two wooden (veneer) layers WL with a reinforcing layer RL disposed between the two wooden layers. A module opening MO for receiving the transponder chip module TCM is provided in (through) each of the wooden layers and the reinforcement layer, extending through the respective layers from a front surface to a rear surface thereof.

The rear subassembly RS comprises: two wooden (veneer) layers WL with a reinforcement layer RL disposed between the two wooden layers. No module opening for receiving the transponder chip module needs to be provided in these layers.

The core subassembly CS comprises: one wooden (veneer) layer WL with two reinforcing layers RL, one reinforcing layer disposed on each of the front and rear surface of the wood layer. A module opening MO may need to be provided in the uppermost one (as shown) or ones of these layers. The resulting card body subassembly CBS having 5 wooden layers WL may be referred to as a “5-ply” construction.

The module openings MO extending through various ones of the wooden layers WL and reinforcement layers RL are shown generically, to receive a generic transponder chip module

TCM. The module openings in the various layers are aligned above one another to receive the transponder chip module and the overall module opening resulting therefrom may be “stepped”, with “P₁” and “P₂” cross-dimensions (as discussed above) to accommodate a similarly step-shaped transponder chip module. In the figure, the transponder chip module and module openings are not drawn to scale.

Details of the composition, characteristics, processing, and treatment of the wooden layers WL and reinforcement layers RL, as well as details of how the various layers may be joined together, including some representative dimensions, as well as how the front, rear and core subassemblies (FS, RS, CS) may be assembled into the card body subassembly CBS are set forth below.

Some of the wooden layers may be pre-pressed prior to being introduced into a subassembly. For example, the two wooden layers in each of the front and rear subassemblies may have an initial thickness of 150 μm, and a thickness of 110 μm after being pre-pressed. The wooden layer WL of the core subassembly CS may not be pre-pressed, and may have a thickness of 150 μm.

The reinforcement layers RL may comprise a substrate of paper or fleece, coated on both (front and rear) sides with an adhesive such as PVAc or an eco-friendly adhesive (pine resin), and may have a thickness of 140-150 μm prior to lamination. During the lamination process, the adhesive of the reinforcement layers may seep into the pores of adjacent wooden layers WL. Post lamination, the reinforcement layers may have a thickness of 38 μm.

Generally speaking, the wooden layers WL will have a grain (a generally parallel pattern of fibers), and the grain will have a direction. Some of the wood layers, for example the two wooden layers of the front subassembly may be disposed so that their grain directions are different than one another (e.g., crossed), such as 90° apart from one another. Similarly, the two wooden layers of the rear subassembly may be disposed so that their grain directions are different than one another, such as 90° apart from one another. The core subassembly comprises only one wooden layer, and may be oriented in any desired direction, such as a direction such as horizontal (parallel to the long dimension of the card) to resist flexing along a vertical axis (parallel to the short dimension) of the card. The grain directions of the various wood layers may be oriented to provide a desired amount of “flex” to the resulting card. Generally, this means that after being slightly deformed (bent), the card will return to its original flat state (elastic deformation).

The fibers of the substrate layer (fleece, laid paper, etc.) forming the reinforcement layer RL may also have a “grain” direction, comparable to the grain direction of a wooden layer. The substrate layers of different reinforcement layers may be arranged in different directions (e.g., crossed), comparable to how the grain directions of different wooden layers may be arranged in different directions to increase the stiffness of the resulting card.

### Stacking Up and Laminating

The wooden layer(s) WL and reinforcement layer(s) RL of the front subassembly FS, rear subassembly RS and core subassembly CS forming the card body subassembly CBS may individually be stacked up to form three individual subassemblies (FS, CS, RS), then stacked upon each other, as shown.

In a subsequent step(s), additional front layers AFL may be applied onto the top, exposed wooden layer WL of the front subassembly FS, and additional rear layers ARL may be applied onto the bottom, exposed wooden layer WL of the rear subassembly RS, completing the construction (stack-up) of the card body CB of the smartcard SC. This resulting stack-up may be laminated using pressure and heat.

When laminating, a subassembly such as the front or rear subassembly (FS or RS) having a reinforcement layer RL disposed between two wooden layers WL, adhesive on the reinforcement layer may seep into the adjacent wooden layers. Similarly, adhesive on a reinforcement layer RL between a wooden layer of one subassembly and a wooden layer of another subassembly, such as the reinforcement layer RL between the bottom wooden layer WL of the front subassembly FS and the wooden layer WL in the core subassembly CS may seep into the adjacent wooden layers.

The lamination parameters may for example be 15 kg per cm² of (medium) pressure at a temperature of 140° C. for a dwell time of 6 minutes. This equates to 147 N/cm² across an area of 360 mm×605 mm, representing 32.7 tons of pressure.

### Sanding Back

After the various wooden layers WL and reinforcement layers RL of the card body subassembly CBS has been assembled (stacked up) and laminated. The top, exposed wooden layer WL of the front subassembly FS and onto the bottom, exposed wooden layer WL of the rear subassembly RS may be sanded back, removing between 10 and 50 μm.

### Additional Front and Rear Layers (AFL, ARL)

After laminating the front subassembly FS, core subassembly CS and rear subassembly RS into a card body subassembly CBS, additional front layers AFL may be applied onto the top, exposed (and sanded back) wooden layer WL of the front subassembly FS, and additional rear layers ARL may be applied onto the bottom, exposed wooden layer WL of the rear subassembly RS, as follows:
an impregnation layer IL-(Waterproofing/Reinforcement/Adhesion Promoter) such as a water-based sealer, which may be applied by spraying onto the exposed (and sanded back) surfaces of the front subassembly FS and rear subassembly RS;
artwork AW comprising digitally deposited UV curable ink on the impregnation layer, with the impregnation layer acting as an adhesion promoter (primer) for the ink; and
a topcoat TC comprising a water-based self-sealer or UV varnish deposited on the artwork to protect the digitally deposited UV curable ink.

The impregnation layers IL may be engineered with a wood grain texture (3 dimensional) by the inkjet deposition process of UV curable ink. Features may be mechanically engraved, or laser etched before or after application of the impregnation to the top or bottom of the card body subassembly CBS.

The topcoat TC of a water-based self-sealer or UV varnish protecting the underlying artwork may be laser personalized post curing. The topcoat TC may also be used to attach the magnetic stripe MS to the bottommost wooden layer WL of the rear subassembly RS.

In the case of certain wood species such as birch, the infusion (during lamination) of adhesive from reinforcement layer(s) RL into the pores of wood layer(s) WL adjacent to the reinforcement layer(s) RL may also seep through the adjacent wooden layer to a next wooden layer WL, such as the exposed topmost or bottommost wooden layer WL of the front subassembly FS or rear subassembly RS, thereby sealing the exposed surface(s) thereof. This sealing of the surface of the topmost or bottommost wooden layer WL has the function of waterproofing, reinforcing the structure and improving the receptiveness to the deposition of ink. This transfer of adhesive from the inner to the outer wood layer(s) may eliminate the need for additional impregnation.

After laminating, the construction of the card body CB may further comprise laser marking LM marking of personalization data on the topcoat TC.

As illustrated in the figure, a magnetic stripe MS comprising 2 or 3 tracks of high coercivity (HiCo) material adhesively attached to or recessed into the exposed (sanded back) surface of the bottom wooden layer WL of the rear subassembly RS. Alternatively (not shown), the magnetic stripe may be applied and pressed into the topcoat TC on the rear subassembly RS.

FIG. 7: Architecture of a 5-ply Wooden Transaction Card (WTC/SC) without Booster Antenna Circuit (BAC) or Coupling Frame (CF)

The layers and process steps in the stack-up construction of the wooden transaction card (WTC/SC):
TCM An enlarged (6 or 8 pin faceplate) transponder chip module with a module antenna (MA) for direct communication with a contactless point of sale terminal without the need for an in-card booster antenna circuit (BAC) or a coupling frame (CF), residing in a module opening (MO) and arranged either horizontally (parallel the length of the card) or vertically (parallel the width of the card);
MA Module antenna (MA) of the enlarged transponder chip module (TCM) having for example 12 turns covering a surface area of 400 mm²;
MO Module opening (MO) in the form of a stepped cavity (P₁ and P₂) to accept the insertion or implanting of the enlarged transponder chip module (TCM);
LM Laser marking of personalization data to the topcoat (TC) of the upward facing pre-pressed wood layer (PP-WL) of the front 2-ply subassembly (FS);
TC Topcoat of a water based sealer or a UV varnish to protect the digitally deposited UV curable ink;
AW Artwork-digitally deposited UV curable ink with the impregnation layer (IL) acting as an adhesion promoter (primer);
IL Impregnation layer (IL)-(Waterproofing/Reinforcement/Adhesion Promoter)-application of a water-based sealer or primer by spraying or screen printing to the front face surface of the pre-pressed wood layer (PP-WL) in the front two-ply subassembly (FS);

Features may be mechanically engraved or laser etched before or after impregnation of the front wood layer (upward facing side) of the front 2-ply subassembly (FS).

Front 2-Ply Subassembly (FS) bonded together using an Adhesive Coated Paper (ACP)
WL Top wood layer (WL: upward facing side) of the front 2-ply subassembly (FS) comprising a micro thin wood veneer orientated in a horizontal grain direction (lengthwise) having a thickness of 110 μm, post pre-press from a thickness of 150 μm in a laminator;
RL Reinforcement layer in the form of a melamine film made by pressing paper saturated with melamine resin, and may be referred to as an adhesive coated paper (ACP). The melamine impregnated paper may have a thickness of 140 μm with a processing temperature of 130-135° C., wherein the melamine film impregnates the underside of the top wood layer (PP-WL) and the upside of the underlying (bottom layer) wood layer (PP-WL);
WL Bottom wood layer (WL) of the front 2-ply subassembly (FS) comprising a micro thin wood veneer orientated in a vertical grain direction (crosswise) having a thickness of 110 μm, post pre-press from a thickness of 150 μm in a laminator;

Core 2-ply Subassembly (CS) of Unpressed Wood Veneer Layers
RL Reinforcement layer in the form of an adhesive coated fleece (ACF) having a thickness of 150 μm with a processing temperature of 120-140° C., comprising a substrate layer of nonwoven fabric (fleece) comprising cellulose and synthetic fibers bonded with a latex binder and coated on both sides with an adhesive layer (AL), wherein the adhesive on both sides of the substrate layer impregnates the upside of the core wood layer (WL) and the underside of the pre-pressed wood layer (PP-WL) in the front 2-ply subassembly (FS);
WL A micro thin wood veneer layer (WL) orientated in a horizontal or vertical grain (lengthwise or crosswise) direction having a thickness of 150 μm;
RL Reinforcement layer in the form of an adhesive coated fleece (ACF) having a thickness of 150 μm with a processing temperature of 120-140° C., comprising a substrate layer of nonwoven fabric (fleece) comprising cellulose and synthetic fibers bonded with a latex binder and coated on both sides with an adhesive layer, wherein the adhesive on both sides of the substrate layer impregnates the underside of the core wood layer (WL) and the upside of the pre-pressed wood layer (PP-WL) in the rear 2-ply subassembly (RS);

Rear 2-Ply Subassembly (RS) bonded together using an Adhesive Coated Paper (ACP)
WL Bottom wood layer (WL: inward facing) of the rear 2-ply subassembly (RS) comprising a micro thin wood veneer orientated in a vertical grain direction (crosswise) having a thickness of 110 μm, post pre-press from a thickness of 150 μm in a laminator;
RL Reinforcement layer in the form of a melamine film made by pressing paper saturated with melamine resin, and may be referred to as an adhesive coated paper (ACP). The melamine impregnated paper may have a thickness of 140 μm with a processing temperature of 130-135° C., wherein the melamine film impregnates the underside of the bottom pre-pressed wood layer (PP-WL) and the upside of the downward facing wood layer (PP-WL);
WL Front wood layer (WL: downward facing side) of the rear 2-ply subassembly (RS) comprising a micro thin wood veneer orientated in a horizontal grain direction (lengthwise) having a thickness of 110 μm, post pre-press from a thickness of 150 μm in a laminator; Features may be mechanically engraved or laser etched before or after impregnation of the front layer (downward facing side) of the rear 2-ply subassembly (RS).
MS Magnetic stripe (2 or 3 tracks (HiCo)) adhesively attached to or recessed in the downward facing wood layer (PP-WL) of the rear 2-ply wood veneer subassembly (RS), or the magnetic stripe may be applied and pressed into the topcoat (TC);
IL Impregnation layer (IL)-(Waterproofing/Reinforcement/Adhesion Promoter)-application of a water-based sealer or primer by spraying or screen printing to the front face surface of the wood layer (PP-WL) in the rear two-ply subassembly (RS);
AW Artwork-digitally deposited UV curable ink with the impregnation layer acting as an adhesion promoter (primer);
TC Topcoat of a water based sealer or a UV varnish to protect the digitally deposited UV curable ink;
LM Laser marking of personalization data to the topcoat (TC) in downward facing pre-pressed wood layer (PP-WL) of the rear 2-ply subassembly (RS);

Security elements (not shown)-signature panel and payment brand hologram (H).

In the case of certain wood species such as birch, the infusion of adhesive into the pores of the inner layers of wood veneer in the laminated card stack-up assembly from the internal layers of adhesive coated fleece seeps through to the outer layers of wood veneer sealing the exposed surface. This sealing of the surface has the function of waterproofing, reinforcing the structure and improving the receptiveness to the deposition of ink. This transfer of adhesive from the inner layers to the outer layers of wood veneer may remove the need for additional impregnation.

In an embodiment of the invention, the layers of adhesive coated paper, adhesive coated fleece applied to the inner and outer layers of wood veneer are compressed in the lamination process under pressure and temperature for a certain duration and thus seep into the pores of the wood veneers, unlike the teachings of US 2024/0001585 in which the wood veneers are densified. To compress the adhesive coated layers (reinforcement layers), the lamination pressure may for example be 15 kg per cm² (147 N/cm²) at a temperature of 140° C. for a dwell time of 6 minutes.

This represents a pressure of 32.7 tons for a wood veneer area of 360 mm×605 mm (in a 24-up format). The (very high) pressure to densify a wood veneer as stipulated by US 2024/0001585 is 9-50 MPa (900-5000 N/cm²), which is a minimum of 6 times higher than the cited pressure to compress the reinforcement layers.

### Booster Antenna Integration for Enhanced Activation Distance

To increase the activation distance of the enlarged transponder chip module a booster antenna in the form of a plated copper antenna circuit with tracks having a thickness of 18 μm in a resin base such as acrylic (15 μm) or a double sided aluminum etched antenna on a PET carrier (Al: 10 μm; PET: 25 μm; AL: 10 μm) may be integrated between the top and bottom two-ply subassemblies, and adhesively attached to the core wood layer (WL). Ghosting of the electro-plated copper tracks forming the antenna may be visible post lamination of the assembly. This may be circumvented by also plating the areas void of antenna circuitry.

Alternatively, a wire antenna may be embedded (scribed) into the core wood layer (WL) having a coating of adhesive. Or the wire embedded antenna may be scribed into one of the layers of adhesive coated fleece (ACF).

### Impregnation and Laser Etching

Post lamination and sanding-back of the laminate to an ISO compliant thickness, the exposed wood surfaces are sealed or impregnated with a water-based self-sealer which permits the transmission of infrared and ultraviolet light. After impregnation, the surface may be laser treated without degradation of the protective seal.

### LED Illumination of the Wood Veneer

A light emitting diode in tandem with an in-card booster antenna circuit (BAC) or connected separately to an energy harvesting coil may be passively powered when in the presence of an electromagnetic field generated by a contactless terminal. The LED may be integrated into the core of the card body structure, back-lightening the wood veneers when in close proximity to a contactless terminal. The same applies for the integration of a sound actuator.

FIG. 7: Description and dimensions of the individual layers forming the card construction

| Layers | Description | Grain direction | Thickness |
|---|---|---|---|
| WL-FS | Rotary peeled wood veneer (Top)-Prepressed | Lengthwise | 110 μm |
| | from 150 μm to 110 μm | | |
| RL-FS | Adhesive coated paper (ACP) for bonding and | | 140 μm |
| | reinforcement-Melamine film | | |
| WL-FS | Rotary peeled wood veneer (Bottom)- | Crosswise | 110 μm |
| | Prepressed from 150 μm to 110 μm | | |
| RL-CS | Adhesive coated fleece (ACF) for bonding and | | 150 μm |
| | reinforcement | | |
| WL-CS | Rotary peeled wood veneer (Core WL)-not | Lengthwise or | 150 μm |
| | prepressed | Crosswise | |
| RL-CS | Adhesive coated fleece (ACF) for bonding and | | 150 μm |
| | reinforcement | | |
| WL-RS | Rotary peeled wood veneer (Bottom-inward | Crosswise | 110 μm |
| | facing side)-Prepressed from 150 μm to 110 | | |
| | μm | | |
| RL-RS | Adhesive coated paper (ACP) for bonding and | | 140 μm |
| | reinforcement-Melamine film | | |
| WL-RS | Rotary peeled wood veneer (Bottom-downward | Lengthwise | 110 μm |
| | facing side)-Prepressed from 150 μm to 110 | | |
| | μm | | |
| | Total thickness of the 5-ply construction before | | 1.17 mm |
| | lamination: | | |
| | Post lamination thickness of the assembly with | | 0.85 mm |
| | 27% shrinkage in thickness: | | |

### Impregnation-Artwork-Topcoat

| Layers | Description | | Thickness |
|---|---|---|---|
| TC | Topcoat-sprayed | Water-based self-sealer or | |
| | | UV varnish | |
| AW | Artwork-digitally deposited | UV curable Ink | |
| IL | Impregnation layer/Adhesion | Water-based self-sealer 1 | |
| | promoter-spraying | Primer | |
| | | Thickness before | ~45 μm |
| | | absorption into the wood | |
| | | veneer | |

### Additional Rear Layers (ARL)

| Layers | Description | | Thickness |
|---|---|---|---|
| IL | Impregnation layer/Adhesion | Water-based self-sealer/ | |
| | promoter-spraying | Primer | |
| AW | Artwork-digitally deposited | UV curable Ink | |
| TC | Topcoat-sprayed | Water-based self-sealer or | |
| | | UV varnish | |
| | | Thickness before | ~45 μm |
| | | absorption into the wood | |
| | | veneer | |

For the purpose of clarity with respect to the reinforcement layers of ACP and ACF, the stack-up position of the adhesive coated paper (ACP) in the form of a melamine film with a thickness of 140 μm may be interchanged with the stack-up position of the adhesive coated fleece (ACF) with a thickness of 150 μm. With the reinforcement layers (ACP and ACF) providing mechanical stability and stiffness. Optionally, the reinforcement layers may be either adhesive coated paper (ACP) or adhesive coated fleece (ACF). The processing temperature during press lamination (130-135° C.) needs to be respected, as an elevated temperature may cause a color variation to the adhesive coating. The adhesive coating is a thermosetting or thermoplastic resin.

### Materials and Processes

Some of the wooden layers WL may comprise micro-thin, rotary-peeled, wood veneer, having a thickness of 150 μm before pre-pressing, and 110 μm after pressing. Some wooden layers may not be pre-pressed.

Some of the wooden layers WL may be impregnated with a water-based self-sealer (a single spray coat of a one or two component formulation) or a primer for the purpose of waterproofing, reinforcement and as an adhesion promoter for receiving printed artwork as digitally deposited UV curable ink.

FIG. 11 shows an exemplary reinforcement layer RL. Some of the reinforcement layers RL may comprise an eco-friendly substrate layer (SL) such as a nonwoven fabric (fleece), paper or the like coated on both sides thereof with an adhesive layer AL.

The fleece or paper itself may have a post calendering thickness of 50-110 μm. The substrate layer (SL) may be “laid”. Laid paper is a type of paper that has a ribbed texture imparted by the manufacturing process. The adhesive itself on each side of the substrate layer (SL) may have a thickness of 25-50 μm.

The adhesive layers AL may first be formed by coating on a silicon liner or paper (release layer, not shown), then transferred to the substrate layer (SL).

Alternatively, the substrate and the adhesive coating may be a melamine film made by saturating the paper with melamine resin, and pressing. The melamine impregnated paper may have a thickness of 140 μm.

During the compression process of press lamination, the adhesive coated paper substrate may shrink significantly, with the melamine film on the reinforcement layer impregnating (penetrating into) the wooden layer WL adjacent the reinforcement layer RL. The melamine film on both sides of the substrate of the reinforcing layer RL may be almost entirely absorbed into the surrounding (adjacent) wooden layers WL.

The process of laminating a reinforcement layer RL between wooden layers WL reinforces the strength of the card body subassembly CBS, more particularly the front subassembly FS and the rear subassembly RS which both have a reinforcement layer RL disposed between two wooden layers WL.

The reinforcement layers RL between wooden layers WL are compressed in the lamination process under pressure and temperature for a certain duration of time (dwell time), and thus the adhesive coatings seep into the pores of the adjacent wooden layers WL. This differs from the teachings of US 2024/0001585 in which the wood veneers are densified under elevated pressure.

Before laminating, the total thickness of the 5-ply construction of the card body subassembly CBS may be approximately 1.12 mm (1120 μm). After laminating, the thickness of the card body subassembly CBS may shrink to a thickness of approximately 0.89 mm (890 μm). This represents approximately 20% reduction in thickness caused by compression in the lamination press and the absorption of the adhesives of the reinforcement layers RL into the pores of the wooden layers WL.

The front, rear and core subassemblies (FS, RS, CS) may have a combination of pre-pressed rotary peeled wood veneers and unpressed rotary peeled wood veneers.

The position of the adhesive coated substrate layer (ACSL), in the form of an adhesive coated paper (ACP) may be interchanged with the adhesive coated fleece (ACF) and visa verse. Or the reinforcement layers are either adhesive coated paper (ACP) or adhesive coated fleece (ACF).

The thermoplastic adhesive (AL) applied to both sides of the substrate layer (SL) may be a coating of film or powder for later reactivation in laminating the card body subassembly (CBS). Coating and calendering of the substrate layer, typically in web form, may be performed in the same machine.

The parameters to process a web of nonwoven fabric of a given thickness in a calender (equipped with pressurized rollers and heated drum(s)) i.e. pressure, contact time (speed) and temperature, enables a desired effect to be achieved such as higher tensile strength, surface smoothness and (reduced) calibrated thickness.

### Booster Antenna (BA)

Some embodiments may comprise micro thin rotary peeled wood veneers with a thickness between 125 μm and 170 μm allowing for a significant reduction in lamination pressure (200-300 N/cm²) over the teachings of US 2024/0001585 (4 Jan. 2024; Swiss Wood Solutions; Chanana et al.),; the reinforcement layer are adhesive coated (wetlaid) nonwoven fabric with a thickness post calendaring of 150 μm; and the total thickness of the total assembly (5 WLs+4 RLs) is 1350 μm compressed to 760-800 μm during lamination.

FIG. 8A shows a construction of a smartcard with a booster antenna. The smartcard comprises a 5-ply card body subassembly CBS, similar to the construction shown in FIG. 7. In this figure, the transponder chip module TCM, the magnetic stripe MS, and the additional front and rear layers (AFL and RFL, respectively) are omitted, for illustrative clarity. The front and rear subassemblies (FS and RS, respectively) and the core subassembly CS are shown for context, and may be substantially identical to those elements shown and described with respect to FIG. 7.

A booster antenna BA is shown, disposed between the upper reinforcement layer RL of the core subassembly CS and the lower wood layer WL of the front subassembly FS. The booster antenna BA may be embedded, such as by scribing, into the adhesive layer on the top (front) surface of the reinforcing layer RL. Some examples of booster antennas suitable for incorporating into the wooden cards described herein are set forth above.

As will be shown in FIG. 8B, the booster antenna (BA; or booster antenna circuit BAC) may take the form of a plated copper antenna circuit with tracks having a thickness of 30 μm in a resin base such as acrylic with a total thickness of 66 μm or a double sided aluminum etched antenna on a PET carrier (Al: 10 μm; PET: 25 μm; AL: 10 μm) with a total thickness of 45 μm.

The booster antenna (BA) shown in FIG. 8A is illustrated as round wire, embedded into the adhesive of the underlying reinforcement layer (RL). The booster antenna (BA) shown in FIG. 8B is illustrated as flat (rectangular in cross-section) tracks on an acrylic carrier substrate included for the purpose of supporting the booster antenna.

The booster antenna (BA; or booster antenna circuit (BAC)) may be disposed in the core of the subassembly sandwiched between two reinforcement layers as shown in FIG. 8B.

Alternatively, the booster antenna BA (or booster antenna circuit) may be formed in the adhesive coated substrate layer (ACSL), or directly on the wooden layer WL of the core subassembly CS, by ultrasonically embedding or scribing an insulated copper wire conductor (Ø: 80 μm) therein.

The wire embedded booster antenna BA may be formed on an adhesive coated paper ACP such as melamine film, adhesive coated fleece ACF, adhesive coated wood veneer or an adhesive coated fleece supported by an underlying layer of wood veneer.

FIG. 8A: Architecture of a 5-ply Wooden Transaction Card (WTC) with a Wire Embedded Booster Antenna Circuit (BAC)

The layers and process steps in the stack-up construction of the wooden transaction card (WTC/SC):
TCM 6 or 8 pin faceplate transponder chip module with a module antenna (MA) for inductive coupling with the coupler coil of an in-card booster antenna (BA) residing in a module opening (MO);
MA Module antenna (MA) of the transponder chip module (TCM) having for example 15 turns;
MO Module opening (MO) in the form of a stepped cavity (P₁ and P₂) to accept the insertion or implanting of the transponder chip module (TCM);
LM Laser marking of personalization data to the topcoat (TC) of the upward facing wood layer (WL) of the front 2-ply wood veneer subassembly (FS);
TC Laser engravable topcoat (TC), sprayed-on or screen printed, in the form of a water-based self-sealer or UV varnish to protect the digitally deposited UV curable ink;
AW Artwork-digitally deposited UV curable ink directly onto the front face surface of the wood layer (WL) or to the impregnation layer (IL) acting as an adhesion promoter (primer);
IL Optional, an Impregnation Layer (IL)-(Waterproofing/Reinforcement/Adhesion Promoter)-application of a water-based self-sealer or primer by spraying, roller coating or screen printing to the surface of the wood layer (WL) in the front two-ply subassembly (FS);
Features may be mechanically engraved or laser etched before application of the topcoat (TC) to the front wood layer (upward facing side) of the front 2-ply wood veneer subassembly (FS).

Front 2-Ply Wood Veneer Subassembly (FS) bonded together using an Adhesive Coated Fleece (ACF)
WL Top wood layer (WL: upward facing side) of the front 2-ply subassembly (FS) comprising a micro thin wood veneer orientated in a horizontal grain direction (lengthwise) having a thickness of 150 μm;
RL Reinforcement Layer (RL) or Adhesive Coated Substrate Layer (ACSL) in the form of an adhesive coated fleece (ACF) having a thickness of 150 μm with a processing temperature of 120-140° C., comprising a substrate layer of nonwoven fabric (cellulose and synthetic fibers bonded with a latex binder) coated on both sides with an adhesive layer (AL), wherein the adhesive on both sides of the nonwoven fabric impregnates the underside of the top wood layer (WL) and the upside of the underlying (bottom layer) wood layer (WL);
WL Bottom wood layer (WL) of the front 2-ply subassembly (FS) comprising a micro thin wood veneer orientated in a vertical grain direction (crosswise) having a thickness of 150 μm;

### Core Wood Veneer Subassembly (CS)

BA An insulated wire conductor (Ø: 80 μm) embedded into the adhesive coating of the adhesive coated fleece (ACF) acting as a reinforcement layer (RL), in forming a booster antenna (BA) with a coupler coil (e.g. 9-11 turns), a perimeter coil (e.g. 3-4 turns) and an extension coil (e.g. 4-8 turns);
RL Reinforcement Layer (RL) or Adhesive Coated Substrate Layer (ACSL) in the form of an adhesive coated fleece (ACF) having a thickness of 150 μm with a processing temperature of 120-140° C., comprising a substrate layer of nonwoven fabric (cellulose and synthetic fibers bonded with a latex binder) coated on both sides with an adhesive layer (AL), wherein the adhesive on both sides of the nonwoven fabric impregnates the upside of the core wood layer (WL) and the underside of the wood layer (WL) in the front subassembly (FS);
WL A micro thin wood layer (WL) orientated in a horizontal or vertical grain (lengthwise or crosswise) direction having a thickness between 150 μm;
RL Reinforcement Layer (RL) or Adhesive Coated Substrate Layer (ACSL) in the form of an adhesive coated fleece (ACF) having a thickness of 150 μm with a processing temperature of 120-140° C., comprising a substrate layer of nonwoven fabric (cellulose and synthetic fibers bonded with a latex binder) coated on both sides with an adhesive layer (AL), wherein the adhesive on both sides of the nonwoven fabric impregnates the underside of the core wood layer (WL) and the upside of the wood layer (WL) in the rear subassembly (RS);

Rear 2-Ply Wood Veneer Subassembly (RS) bonded together using an Adhesive Coated Fleece (ACF)
WL Bottom wood layer (WL) of the rear 2-ply subassembly (RS) comprising a micro thin wood veneer orientated in a vertical grain direction (crosswise) having a thickness of 150 μm;
RL Reinforcement Layer (RL) or Adhesive Coated Substrate Layer (ACSL) in the form of an adhesive coated fleece (ACF) having a thickness of 150 μm with a processing temperature of 120-140° C., comprising a substrate layer of nonwoven fabric (cellulose and synthetic fibers bonded with a latex binder) coated on both sides with an adhesive layer (AL), wherein the adhesive on both sides of the nonwoven fabric impregnates the underside of the bottom wood layer (WL) and the upside of the rear downward facing wood layer (WL);
WL Front wood layer (WL: downward facing side) of the rear 2-ply subassembly (RS) comprising a micro thin wood veneer orientated in a horizontal grain direction (lengthwise) having a thickness of 150 μm;
Features may be mechanically engraved or laser etched before application of the topcoat (TC) to the front wood layer (WL: downward facing side) of the rear 2-ply subassembly (RS).
IL Optional, an Impregnation Layer (IL)-(Waterproofing/Reinforcement/Adhesion Promoter)-application of a water-based self-sealer or primer by spraying, roller coating or screen printing to the front face surface of the wood layer (WL) in the rear 2-ply subassembly (RS);
AW Artwork-digitally deposited UV curable ink directly onto the surface of the downward facing wood layer (WL) or to the impregnation layer (IL) acting as an adhesion promoter (primer);
TC Laser engravable topcoat (TC), sprayed on or screen printed, in the form of a water-based self-sealer or UV varnish to protect the digitally deposited UV curable ink;
MS Magnetic stripe (2 or 3 tracks (HiCo)) adhesively attached to or recessed in the MS downward facing wood layer (WL) of the rear 2-plysubassembly (RS), or the magnetic stripe may be applied and pressed into the topcoat (TC);
LM Laser marking (LM) of personalization data to the topcoat (TC) in the form of a water-based self-sealer or UV varnish in downward facing wood layer (WL) of the rear 2-ply subassembly (RS);

Security elements (not shown)-signature panel and payment brand hologram.

FIG. 8A: Description and dimensions of the individual layers forming the smartcard (SC) construction

| Layers | Description | Grain direction | Thickness |
|---|---|---|---|
| WL-FS | Rotary peeled wood veneer (Top) | Lengthwise | 150 μm |
| RL-FS | Adhesive coated fleece (ACF) for bonding and | | 150 μm |
| | reinforcement (aka ACSL) | | |
| WL-FS | Rotary peeled wood veneer (Bottom) | Crosswise | 150 μm |
| BA-CS | Wire embedded booster antenna circuit (BAC) | | N/A |
| | formed in the adhesive coated fleece (ACF) | | |
| RL-CS | Adhesive coated fleece (ACF) for bonding and | | 150 μm |
| | reinforcement (aka ACSL) | | |
| WL-CS | Rotary peeled wood veneer (Core) | Lengthwise or | 150 μm |
| | | Crosswise | |
| RL-CS | Adhesive coated fleece (ACF) for bonding and | | 150 μm |
| | reinforcement (aka ACSL) | | |
| WL-RS | Rotary peeled wood veneer (Bottom-inward | Crosswise | 150 μm |
| | facing side) | | |
| RL-RS | Adhesive coated fleece (ACF) for bonding and | | 150 μm |
| | reinforcement (aka ACSL) | | |
| WL-RS | Rotary peeled wood veneer (Front-downward | Lengthwise | 150 μm |
| | facing side) | | |
| | Total thickness of the 5-ply construction with 4 | | 1.35 mm |
| | inner layers of ACF before lamination: | | |
| | Post lamination thickness of the assembly with | | 0.90 mm |
| | 33% shrinkage in thickness: | | |

### Impregnation-Artwork-Topcoat

| Layers | Description | | Thickness |
|---|---|---|---|
| TC | Laser engravable topcoat | Water-based self-sealer | |
| | (TC)-sprayed on | or UV varnish | |
| AW | Artwork-digitally deposited | UV curable Ink | |
| IL | Optional, impregnation layer- | Water-based self-sealer | |
| | Adhesion promoter-spraying | or primer | |
| | | Thickness before | ~45 μm |
| | | absorption into the | |
| | | wood veneer | |

### Additional Rear Layers (ARL)

| Layers | Description | | Thickness |
|---|---|---|---|
| IL | Optional, Impregnation layer- | Water-based self-sealer | |
| | Adhesion promoter-spraying | or primer | |
| AW | Artwork-digitally deposited | UV curable Ink | |
| TC | Laser engravable topcoat | Water-based self-sealer | |
| | (TC)-sprayed | or UV varnish | |
| | | Thickness before | ~45 μm |
| | | absorption into the | |
| | | wood veneer | |

Bio-based and bio-inspired adhesives from animals and plants may replace conventional petrochemical adhesives used for bonding of the wood layers.

In a one-step lamination process, the complete card body subassembly (CBS) has an overall thickness of 1350 μm pre-lamination (front subassembly (FS): WL/150 μm+ACF/150 μm+WL/150 μm, core subassembly (CS) including the booster antenna circuit (BAC): ACF/150 μm +WL/150 μm+ACF/150 μm, and the rear subassembly (RS): WL/150 μm+ACF/150 μm +WL/150 μm), and post lamination the thickness is approximately 900 μm, representing a shrinkage in thickness of 33%. In a further process step, the laminated assembly is sanded-back on both sides to achieve an ISO compliant thickness of approximately 800 μm.

As discussed above, the stack-up of wood layers (WL) and reinforcement layers (RL) as shown in FIG. 8A may be laminated using (medium) pressure and heat (i.e. 15 kg per cm² of pressure at a temperature of 140° C. for a dwell time of 6 minutes) to achieve a compression in the lamination press from an initial thickness of 1350 μm to approximately 900 μm (post lamination) representing a material shrinkage of 33%. By exerting a higher pressure such as 30 kg per cm², the thickness of the stack-up assembly may be compressed from 1350 μm to a post lamination thickness of 780-800 μm representing a shrinkage in the thickness of 42%.

### FIG. 8A: Exerting Higher Pressure to Compress to an ISO Conforming Thickness of 800 μm

A wooden transaction card (WTC) with contactless functionality may comprise at least 5 wood layers (WL) and at least 4 reinforcement layers RL), wherein each wood layer (WL) is a micro-thin rotary peeled wood veneer with a thickness of ~150 μm and each reinforcement layer (RL) comprising a substrate layer (SL) coated on both sides with an adhesive layer (2×~25 μm), also referred to as an adhesive coated substrate layer (ACSL) for structural integrity and interlayer bonding, and wherein said substrate layer (SL) further comprises a smooth, compressed and densified (wetlaid) nonwoven fabric (aka fleece) processed through a mechanical finishing technique of calendering, with an initial thickness of 220 μm (e.g. 70 g/m²) and post calendering and coating of adhesive having a thickness of ~150 μm (e.g. 100 g/m²) and wherein the overall thickness of the stack-up (5 WLs and 4 RLs/ACSLs) before press lamination being approximately 1350 μm and a post lamination thickness of 780-800 μm by application of pressure, temperature over a defined dwell time, representing a material shrinkage of 42%. The (wetlaid) nonwoven fabric (fleece) comprises cellulose and synthetic fibers in a latex binder. An antenna circuit is incorporated into a core reinforcement layer. During press lamination, the adhesive on both sides of the substrate layer seeps into the wood fibers of the surrounding wood layers. The topmost and bottommost wood layer of the laminated assembly may be sanded-back to have a smooth and uniform ISO compliant thickness.

The wetlaid nonwoven fabric may have a weight of 70 g/m² with a thickness before calendaring of 220 μm.

Alternatively, the wetlaid nonwoven fabric may have a weight of 40 g/m² with a thickness before calendaring of 270 μm (a greater amount of air).

Micro-thin rotary peeled wood veneer with a thickness of ~150 μm may be translucent (such as birch). Individual layers of wood veneer in the stack-up may or may not be pigmented (stained or unstained). The adhesive coating on each side of the reinforcement layer may or may not be pigmented (dyed). The substrate layers may or may not be pigmented (dyed).

### Wood Veneer Composite

Wood veneers may be shredded, chopped and crushed, mixed with a bio-based adhesive, to produce a composite layer for additional reinforcement.

Five criteria are required for wooden transaction cards conforming to ISO thickness: high strength, stiffness, thickness uniformity, flatness and smoothness. Critical bending up to breakage point and shape memory effect are also card body properties to be defined.

### Thermowood

Thermowood is a sustainable and durable wood product that is enhanced with heat and steam. The wood layers (veneers) described herein may be heat treated to enhance their wood characteristics.

Ebonizing Wood with Steel Wool and Vinegar

Ebonizing wood is the effect of darkening or blackening a naturally lighter colored wood to appear more like black ebony wood. For many years woodworkers have used iron acetate, a mixture of steel wool and cleaning grade vinegar, to darken the wood. Iron acetate reacts to tannins in the wood to make a chemical reaction within the wood cells.

FIG. 8B shows a variation of the embodiment of FIG. 8A, wherein the booster antenna BA is disposed in the core between reinforcement layers

FIG. 8B: Architecture of a 4-ply Wooden Transaction Card (WTC/SC) with a Plated Copper Booster Antenna Circuit (BAC)

FIG. 8B illustrates the layers and process steps in the stack-up construction of the wooden transaction card (WTC/SC):

Front 2-Ply Wooden Veneer Subassembly (FS) bonded together using an Adhesive Coated Fleece (ACF)
WL Top wooden layer (WL: upward facing side) of the front 2-ply subassembly (FS) comprising a micro thin wood veneer orientated in a horizontal grain direction (lengthwise) having a thickness of 150 μm;
RL Reinforcement Layer (RL) or Adhesive Coated Substrate Layer (ACSL) in the form of an adhesive coated fleece (ACF) having a thickness of 150 μm with a processing temperature of 120-140° C., comprising a substrate layer of nonwoven fabric (cellulose and synthetic fibers bonded with a latex binder) coated on both sides with an adhesive layer (AL), wherein the adhesive on both sides of the nonwoven fabric impregnates the underside of the top wood layer (WL) and the upside of the underlying (bottom layer) wood layer (WL);
WL Bottom wood layer (WL) of the front 2-ply subassembly (FS) comprising a micro thin wood veneer orientated in a vertical grain direction (crosswise) having a thickness of 150 μm;

### Core Subassembly (CS)

RL Reinforcement Layer (RL) or Adhesive Coated Substrate Layer (ACSL) in the form of an adhesive coated fleece (ACF) having a thickness of 150 μm with a processing temperature of 120-140° C., comprising a substrate layer of nonwoven fabric (cellulose and synthetic fibers bonded with a latex binder) coated on both sides with an adhesive layer (AL), wherein the adhesive on both sides of the nonwoven fabric impregnates the underside of the wood layer (WL) in the front subassembly (FS) and acts as a bonding agent for the booster antenna (BA) to the front subassembly (FS);
BA To increase the activation distance of the transponder chip module TCM a booster antenna (BA) in the form of an electroplated copper antenna circuit on an acrylic carrier with the conductive tracks having a thickness of 18 μm or 30 μm having a total thickness of 66 μm, may be integrated between the front and rear two-ply subassemblies (FS and RS) and adhesively attached thereto using upper and lower reinforcement layers (RL). The antenna circuit may include a coupler coil, a communication coil and optionally a capacitor bank;
RL Reinforcement Layer (RL) or Adhesive Coated Substrate Layer (ACSL) in the form of an adhesive coated fleece (ACF) having a thickness of 150 μm with a processing temperature of 120-140° C., comprising a substrate layer of nonwoven fabric (cellulose and synthetic fibers bonded with a latex binder) coated on both sides with an adhesive layer (AL), wherein the adhesive on both sides of the nonwoven fabric impregnates the upside of the wood layer (WL) in the rear subassembly (RS) and acts as a bonding agent for the booster antenna (BA) to the rear subassembly (RS);

Rear 2-Ply Wood Veneer Subassembly (RS) bonded together using an Adhesive Coated Fleece (ACF)
WL Bottom wood layer (WL) of the rear 2-ply subassembly (RS) comprising a micro thin wood veneer orientated in a vertical grain direction (crosswise) having a thickness of 150 μm;
RL Reinforcement Layer (RL) or Adhesive Coated Substrate Layer (ACSL) in the form of an adhesive coated fleece (ACF) having a thickness of 150 μm with a processing temperature of 120-140° C., comprising a substrate layer of nonwoven fabric (cellulose and synthetic fibers bonded with a latex binder) coated on both sides with an adhesive layer (AL), wherein the adhesive on both sides of the nonwoven fabric impregnates the underside of the bottom wood layer (WL) and the upside of the rear downward facing wood layer (WL);
WL Front wood layer (WL: downward facing side) of the rear 2-ply subassembly (RS) comprising a micro thin wood veneer orientated in a horizontal grain direction (lengthwise) having a thickness of 150 μm;

Security elements (not shown)-signature panel and payment brand hologram.

In a one-step lamination process, the complete card body subassembly (CBS) has an overall thickness of 1266 μm pre-lamination (front subassembly (FS): WL/150 μm+ACF/150 μm+WL/150 μm, core subassembly (CS): ACF/150 μm+BAC/66 μm+ACF/150 μm, and the rear subassembly (RS): WL/150 μm+ACF/150 μm+WL/150 μm), and post lamination the thickness is approximately 842 μm, representing a shrinkage in thickness of 33.5%. In a further process step, the laminated assembly is sanded-back on both sides to achieve an ISO compliant thickness of approximately 800 μm.

FIG. 8B: Description and dimensions of the individual layers forming the card construction

| Layers | Description | Grain direction | Thickness |
|---|---|---|---|
| WL-FS | Rotary peeled wood veneer (Top) | Lengthwise | 150 μm |
| RL-FS | Adhesive coated fleece (ACF) for bonding and | | 150 μm |
| | reinforcement (aka ACSL) | | |
| WL-FS | Rotary peeled wood veneer (Bottom) | Crosswise | 150 μm |
| RL-CS | Adhesive coated fleece (ACF) for bonding and | | 150 μm |
| | reinforcement (aka ACSL) | | |
| BA-CS | Booster antenna circuit | | 150 μm |
| RL-CS | Adhesive coated fleece (ACF) for bonding and | | 150 μm |
| | reinforcement (aka ACSL) | | |
| WL-RS | Rotary peeled wood veneer (Bottom-inward | Crosswise | 150 μm |
| | facing side) | | |
| RL-RS | Adhesive coated fleece (ACF) for bonding and | | 150 μm |
| | reinforcement (aka ACSL) | | |
| WL-RS | Rotary peeled wood veneer (Front-downward | Lengthwise | 150 μm |
| | facing side) | | |
| | Total thickness of the 4-ply construction with 4 | | 1.26 mm |
| | inner layers of ACF before lamination: | | |
| | Post lamination thickness of the assembly with | | 0.84 mm |
| | 33.5% shrinkage in thickness: | | |

### Metal Wood Hybrid Cards

US 2018/0339503 (29 Nov. 2018; Finn et al.; issued as U.S. Pat. No. 10,518,518 on 31 Dec. 2019), entitled “Smartcards with Metal Layer(s) and Methods of Manufacture”, incorporated by reference herein, describes smartcards with metal layers manufactured according to various techniques. One or more metal layers of a smartcard stack-up may be provided with slits overlapping at least a portion of a module antenna in an associated transponder chip module disposed in the smartcard so that the metal layer functions as a coupling frame. One or more metal layers may be pre-laminated with plastic layers to form a metal core or clad subassembly for a smartcard, and outer printed and/or overlay plastic layers may be laminated to the front and/or back of the metal core. Front and back overlays may be provided. Various constructions of and manufacturing techniques (including temperature, time, and pressure regimes for laminating) for smartcards are disclosed. As set forth therein:
A metal layer (ML) may be composed of any metal or metal alloy including but not limited to steel, aluminum, copper/zinc, titanium and tungsten. The metal layer (ML) itself may be a laminate of multiple metals or a laminate of metals with non-metals such as carbon fiber or wood. The metal layer may feature a dielectric coating or decorative coating or may be electroplated. The metal layer may be finished or treated to promote adhesion to adjacent layers in the card stack-up.

FIG. 9A shows a construction of a smartcard. The smartcard comprises a 2-ply card body subassembly CBS, similar to the construction shown in FIG. 7. In this figure, the transponder chip module (TCM), the magnetic stripe (MS), and the additional front and rear layers (AFL and RFL, respectively) are omitted, for illustrative clarity. The front and rear subassemblies (FS and RS, respectively) and the core subassembly (CS) are shown for context, and may be substantially identical to those elements shown and described with respect to FIG. 7.

In this embodiment, a coupling frame CF is shown, disposed between the upper reinforcement layer RL of the core subassembly CS and the lower wood layer WL of the front subassembly FS.

The reinforcement layers (RL) disclosed herein may comprise a substrate layer (SL) having an adhesive coating or an adhesive layer (AL) disposed on both (upper/front, lower/rear) sides (surfaces) thereof. In some embodiments, one or more of the reinforcement layers may be replaced by adhesive layers, without a substrate layer (SL).

FIG. 9A shows a timber metal transaction card or smartcard (TMTC or SC) having a front and rear wood layer (WL), a core discontinuous metal layer (DML) acting as a coupling frame (CF) for contactless communication with a laser-cut slit and a laser cut module opening, with the coupling frame supported by an upper and lower reinforcement layer (RL) covering the slit and module opening. Optionally, the module opening (MO) may be stuffed with a wooden plug or slug to prevent indenting of the wood layers (WL) and reinforcement layers (RL) during press lamination.

FIG. 9A: Architecture of a 2-ply Timber Metal Transaction Card (TMTC/SC) with a Coupling Frame (CF)

The layers and process steps in the stack-up construction of the timber metal transaction card (TMTC/SC) with a front layer of thin wood veneer, a core discontinuous metal layer and a rear layer of thin wood veneer:
TCM A (6 or 8 pin faceplate) transponder chip module (wire bonded or flip chip bonded) with a module antenna (MA) for inductive coupling with an in-card coupling frame (CF), residing in a module opening (MO);
MA Module antenna (MA) of the transponder chip module (TCM) having for example 15 turns, overlapping the slit and module opening (MO) after chip implanting;
MO Module opening (MO) in the form of a stepped cavity (P₁ and P₂) to accept the insertion or implanting of the transponder chip module (TCM);
Note the transponder chip module may be referred to as an inductive coupling chip module or simply a dual interface chip module (having a contact and contactless interface);

Additional Front Layers (AFL, not shown)
LM Laser marking of personalization data to the topcoat (TC) of the upward facing wood layer (WL) forming the front single-ply subassembly (FS);
TC Topcoat of a water based sealer or UV varnish to protect the underlying laser engraved features;
AW Artwork-laser etching of graphic features directly into the wood surface or an impregnated wood surface;
IL Optionally, an impregnation layer (IL)-(Waterproofing/Reinforcement)-application of a water-based sealer or a primer by spraying or screen printing to the front face surface of the wood layer (WL) forming the front single-ply subassembly (FS);

### Front Single-Ply Subassembly (FS):

WL Top wood layer (WL: upward facing side) of the front single-ply subassembly (FS) comprising a thin wood veneer orientated in a horizontal or vertical grain direction (lengthwise or crosswise) having a thickness of 200 μm, post lamination and singulation provided with a P₁ cavity (with a depth of 195 μm) for implanting of a transponder chip module (TCM), with the top wood layer impregnated from the underside with the adhesive from the reinforcement layer (RL) during the compression lamination process;

Core Subassembly (CS) incorporating the Coupling Frame (CF):
RL Reinforcement Layer (RL) or Adhesive Coated Substrate Layer (ACSL) in the form of an adhesive coated fleece (ACF) having a thickness of 150 μm with a processing temperature of 120-140° C., comprising a substrate layer of nonwoven fabric (cellulose and synthetic fibers bonded with a latex binder) coated on both sides with an adhesive layer (AL), wherein the adhesive on the top side of the nonwoven fabric impregnates the underside of the top wood layer (WL) forming the front single-ply subassembly (FS), and wherein the adhesive on the bottom side of the substrate layer is a bonding agent to the metal coupling frame (CF) with the nonwoven fabric stretched or spanning across the slit and module opening negating the need to fill the voids with a thermosetting resin such as epoxy or polyurethane;
CF A single discontinuous metal layer having a laser-cut slit and a laser-cut module opening with metal edges sized to the dimensions of the P₂ opening of the chip module having a thickness of 254 μm (10 mils);
RL Reinforcement Layer (RL) or Adhesive Coated Substrate Layer (ACSL) in the form of an adhesive coated fleece (ACF) having a thickness of 150 μm with a processing temperature of 120-140° C., comprising a substrate layer of nonwoven fabric (cellulose and synthetic fibers bonded with a latex binder) coated on both sides with an adhesive layer (AL), wherein the adhesive on the bottom side of the nonwoven fabric impregnates the underside of the bottom wood layer (WL) forming the rear single-ply subassembly (RS), and wherein the adhesive on the top side of the substrate layer is a bonding agent to the metal coupling frame (CF) with the nonwoven fabric stretched or spanning across the slit and module opening negating the need to fill the voids with a thermosetting resin such as an epoxy or polyurethane;

### Rear Single-Ply Subassembly (RS)

WL Bottom wood layer (WL: inward facing) forming the rear single-ply subassembly (RS) comprising a thin wood veneer orientated in a horizontal or vertical grain direction (lengthwise or crosswise) having a thickness of 200 μm, with the bottom wood layer impregnated from the underside with the adhesive from the reinforcement layer (RL) during the compression lamination process;
MS Magnetic stripe (2 or 3 tracks (HiCo)) adhesively attached to or recessed in the downward facing wood layer (WL) forming the rear 2-ply wood veneer subassembly (RS), or the magnetic stripe may be applied and pressed into the topcoat (TC);

Additional Rear Layers (ARL, not shown)
IL Optionally, an impregnation layer (IL)-(Waterproofing/Reinforcement)-application of a water-based sealer or primer by spraying or screen printing to the front face surface of the wood layer (WL) forming the rear single-ply subassembly (RS);
AW Artwork-laser etching of graphic features such as a QR code directly into the wood surface or an impregnated wood surface;
TC Topcoat of a water based sealer or UV varnish to protect the underlying laser engraved features;
LM Laser marking of personalization data to the topcoat (TC) in the form of a water-based sealer or UV varnish in the downward facing wood layer (WL) forming the rear single-ply subassembly (RS);

Security elements (not shown)-signature panel and payment brand hologram (H).

FIG. 9A is revisited in the treatment of the coupling frame presented in FIG. 14A and the stack-up assembly of FIG. 14B with the use of calendered nonwoven fabric as the substrate layer for reinforcement.

### Wood Veneer Oxidization

Wood species such as maple or birch may be treated with an oxidizing stain to grey or blacken their surface. Oxidized maple will be greyish brown in color. Reference is made to: internet.gadgetsandgrain.com/2019/08/02/how-to-oxidize-age-wood-in-a-matter-of-minutes/

### Wood Veneer Color Change

Many groups of trees have fall colors that are specific to them. Oaks are generally red, brown, or russet. Aspen, cottonwood, and birches are a golden yellow. For maples the color varies by species with red maples turning a brilliant scarlet, sugar maples turning an orange-red, and silver maples turning a yellow-brown.

Maple starts off very light and bright, with a few pink and grey tones. Over time, it will age to a warm golden honey color.

As an embodiment of the invention, the timber metal hybrid transaction card presented in FIG. 9A may have a front and rear layer of oxidized maple (jet black in color) sandwiching a metal layer acting as a coupling frame. The metal layer may be an alloy having significant weight, greater than 10 grams. The metal may protrude through an opening in the front face wood layer. The wood layer may be machined to reveal the underlying metal (knockout).

FIG. 9B shows a metal wood hybrid transaction card or smartcard (SC) having a front continuous metal layer (ML) and a rear wood layer (WL), sandwiching a core subassembly (CS) comprising a first reinforcement layer (RL) for rigidity and bonding, a magnetic shielding layer (MSL) to offset the attenuation effect of the electromagnetic field caused by the presence of the continuous metal layer (ML), an adhesive layer (AL) for spacing and bonding, a booster antenna (BA) having a perimeter coil for RF communication with a contactless terminal and a coupler coil for inductive coupling with the module antenna (MA) of the transponder chip module (TCM) and a second reinforcement layer (RL) for stability and bonding adhesion between the layers. The adhesive layer (AL) is the adhesive spacing layer (ASL) between the magnetic shielding layer (MSL) and the booster antenna (BA). An adhesive coated substrate layer (ACSL) could also be used as the adhesive spacing layer (ASL).

FIG. 9B: Architecture of a Metal Wood Hybrid Transaction Card (SC) with an in-card Booster Antenna (BA)

The layers and process steps in the stack-up construction of the metal wood hybrid transaction card with a front slab of metal and a rear layer of wood veneer:

Component Elements and Additional Front Layers (AFL) not shown
TCM A (6 or 8 pin faceplate) transponder chip module (wire bonded or flip chip bonded) with a module antenna (MA) for inductive coupling with an in-card booster antenna (BA), residing in a module opening (MO);
MA Module antenna (MA) of the transponder chip module (TCM) having for example 15 turns, overlapping the coupler coil of the booster antenna (BA), after chip implanting;
MO Module opening (MO) in the form of a stepped cavity (P₁ and P₂) to accept the insertion or implanting of the transponder chip module (TCM);
PLV Post lamination varnish-raised characters;
TC Laser reactive topcoat, protective gloss or matte coating; Optionally, a transparent coat of rigid ink (hard coat) for scratch protection applied over the graphic print layer, such as by means of digital printing;
AW Graphic print layer (Artwork)-deposition of digital ink (color);
DP Deposited primer;
Combined thickness of the laser reactive, transparent hard coat, deposited ink and primer, approximately: 45 μm.
LM Laser marking of personalization data to the topcoat (TC), anti-scratch or protective coating on the surface of the metal layer (ML) forming the front subassembly (FS);

### Front Subassembly (FS):

ML Front face metal layer (ML) which may be a continuous metal layer (e.g. stainless steel, titanium, tungsten, brass, copper, aluminum, iron, special alloys, or a combination of metals, etc.) with a laser-cut module opening (MO-P₁)-thickness of the metal layer: 203 μm (8 mils);
Alternative Decorative Finish to the Front Face Metal Layer (ML): Electropolishing, gold plating, powder coating, PVD or DLC coating, anodizing in the case of aluminum

### Core Subassembly (CS):

RL A first reinforcement layer having a thickness of 150 μm comprising a substrate layer (SL) of paper coated on both sides with an adhesive (ACP), wherein the adhesive on the top side of the substrate layer (SL) bonds to the underside of the metal layer (ML) forming the front subassembly (FS), and wherein the adhesive on the bottom side of the substrate layer bonds to the magnetic shielding layer (MSL);
Note, the adhesive coated paper (ACP) or adhesive coated fleece (ACF) offers mechanical support and position to the implanted chip module.
MSL Low magnetic loss shielding layer (ferrite or non-ferrite material with a thickness of 30 μm, 50 μm, 65 μm or 75 μm) attached to the front face continuous metal layer (ML) via the first reinforcement layer (RL);
ASL Adhesive spacing layer with a thickness of 50 μm;
BA Booster antenna, in the form of a plated copper circuit (track thickness: 30 μm) with an overall thickness of 65-75 μm, comprising a perimeter coil, a coupler coil and an electrode (optionally, a capacitor bank for tuning) with the (double-sided) booster antenna circuitry assembled on an acrylic carrier;
RL A second reinforcement layer having a thickness of 150 μm comprising a substrate layer (SL) of paper coated on both sides with an adhesive (ACP), wherein the adhesive on the bottom side of the substrate layer (SL) impregnates the underside of the bottom wood layer (WL) forming the rear subassembly (RS), and wherein the adhesive on the top side of the substrate layer (SL) bonds to booster antenna (BA) providing enhanced strength, rigidity and flatness to the circuit;

### Rear Subassembly (RS)

WL Bottom face wood layer (WL) forming the rear subassembly (RS) comprising a thin wood veneer orientated in a horizontal or vertical grain direction (lengthwise or crosswise) having a thickness of 250 μm, with the bottom wood layer impregnated from the underside with the adhesive from the second reinforcement layer (RL) during the compression lamination process;
MS Magnetic stripe (2 or 3 tracks (HiCo)) adhesively attached to or recessed in the downward facing wood layer (WL) forming the rear 2-ply wood veneer subassembly (RS), or the magnetic stripe may be applied and pressed into the topcoat (TC);

Security Elements and Additional Rear Layers (ARL) not shown
IL Optionally, an impregnation layer (IL)-(Waterproofing/Reinforcement)-application of a water-based sealer or primer by spraying or screen printing to the front face surface of the wood layer (WL) forming the rear subassembly (RS);
AW Artwork-laser etching of graphic features such as a QR code directly into the wood surface or an impregnated wood surface;
TC Topcoat of a water based sealer or UV varnish to protect the underlying laser engraved features;
LM Laser marking of personalization data to the topcoat (TC) in the form of a water-based sealer or UV varnish in the downward facing wood layer (WL) forming the rear subassembly (RS);

Security elements (not shown)-signature panel and payment brand hologram (H).

An embodiment of the invention may comprise the following combination of elements described herein:
the front and rear wooden layers (WL) as shown in FIG. 9A; and
the core subassembly (CS) shown in FIG. 9B, with the booster antenna (BA), and without the magnetic shielding layer (not needed, because there is no front face metal layer), sandwiched and laminated between the front and rear wooden layers.

An embodiment of the invention may comprise a core subassembly (CS) comprising:
a continuous metal layer (ML, CML);
a magnetic shielding layer (MSL) disposed atop the continuous metal layer;
an adhesive layer (AL) disposed between the continuous metal layer and the magnetic shielding layer;
either (i) an adhesive spacing layer (ASL) disposed below the magnetic shielding layer and a booster antenna (BA) embedded in the adhesive spacing layer, or (ii) a reinforcement layer (RL) disposed below the magnetic shielding layer in the form of a substrate layer (SL) having upper and lower sides (surfaces) and having an adhesive coating or an adhesive layer (AL) disposed on both sides thereof, with a booster antenna (BA) integrated into the adhesive coating on the upper side of the reinforcement layer.

The different varieties of core subassemblies (CS) may be disposed (sandwiched) between and laminated with front and rear face wooden (veneer) layers (WL) (compare FIG. 9A). This may be achieved using upper and lower adhesive film layers for bonding the front and rear face wooden layers to the core subassembly. The total assembly (stack-up, construction) may have a thickness of 844 μm prior to press lamination, and a post lamination thickness of approximately 760 μm by application of a pressure between 200 N/cm² and 300 N/cm².

In FIGS. 9A and 9B, the front subassembly (FS) is illustrated as comprising a wooden layer or a metal layer, respectively. In both figures, the rear subassembly (RS) is illustrated as comprising a wooden layer.

FIG. 9C shows a wood metal hybrid transaction card or smartcard (SC) having a front wood layer (WL) and a rear continuous metal layer (ML; CML) sandwiching a core subassembly (CS) comprising a first reinforcement layer (RL) for stability and bonding, a booster antenna (BA) having a perimeter coil for RF communication with a contactless terminal and a coupler coil for inductive coupling with the module antenna (MA) of the transponder chip module (TCM), an adhesive layer for spacing and bonding, a magnetic shielding layer (MSL) to offset the attenuation effect of the electromagnetic field caused by the presence of the underlying continuous metal layer (ML), and a second reinforcement layer (RL) for inter-bonding between the layers (SL and ML).

FIG. 9C: Architecture of a Wood Metal Hybrid Transaction Card (SC) with an in-card Booster Antenna (BA)

The layers and process steps in the stack-up construction of the wood metal hybrid transaction card with a front layer of wood veneer and a rear slab of metal:

Component Elements and Additional Front Layers (AFL) not shown
TCM A (6 or 8 pin faceplate) transponder chip module (wire bonded or flip chip bonded) with a module antenna (MA) for inductive coupling with an in-card booster antenna (BA), residing in a module opening (MO);
MA Module antenna (MA) of the transponder chip module (TCM) having for example 15 turns, overlapping the coupler coil of the booster antenna (BA), after chip implanting;
MO Module opening (MO) in the form of a stepped cavity (P₁ and P₂) to accept the insertion or implanting of the transponder chip module (TCM);
LM Laser marking of personalization data to the topcoat (TC), inscribed in the surface of the wood layer (WL) forming the front subassembly (FS);
TC Topcoat of a water based sealer or UV varnish to protect the underlying laser engraved features;
AW Artwork-laser etching of graphic features directly into the wood surface or an impregnated wood surface;
IL Optionally, an impregnation layer (IL)-(Waterproofing/Reinforcement)-application of a water-based sealer or primer by spraying or screen printing to the front face surface of the wood layer (WL) forming the front subassembly (FS);

### Front Subassembly (FS):

WL Top face wood layer (WL) forming the front subassembly (FS) comprising a thin wood veneer orientated in a horizontal or vertical grain direction (lengthwise or crosswise) having a thickness of 250 μm, with the top wood layer impregnated from the underside with the adhesive from the first reinforcement layer (RL) during the compression lamination process;
Note, the wood layer offers mechanical support to the implanted chip module with a P₁ cavity depth of 195 μm.

### Core Subassembly (CS):

RL A first reinforcement layer having a thickness of 150 μm comprising a substrate layer of paper coated on both sides with an adhesive (ACP), wherein the adhesive on the top side of the substrate layer bonds to and impregnates the underside of the wood layer (WL) forming the front subassembly (FS), and wherein the adhesive on the bottom side of the substrate layer bonds to the booster antenna (BA);
BA Booster antenna, in the form of a plated copper circuit (tracks: 30 μm) with an overall thickness of 65-75 μm, comprising a perimeter coil, a coupler coil and an electrode (optionally, a capacitor bank for tuning) with the (double-sided) booster antenna circuitry assembled on an acrylic carrier;
ASL Adhesive spacing layer with a thickness of 50 μm;
MSL Low magnetic loss shielding layer (ferrite or non-ferrite material with a thickness of 30, 50 μm, 65 μm or 75 μm) attached to the rear face continuous metal layer (ML) via the second reinforcement layer (RL);
RL A second reinforcement layer having a thickness of 150 μm comprising a substrate layer of paper coated on both sides with an adhesive (ACP), wherein the adhesive on the bottom side of the substrate layer bonds to the underside of the bottom metal layer (ML) forming the rear subassembly (RS), and wherein the adhesive on the top side of the substrate layer bonds to the magnetic shielding layer (MSL);

### Rear Subassembly (RS)

ML Bottom face metal layer (ML) forming the rear subassembly (RS) which may be a continuous metal layer (e.g. stainless steel, titanium, brass, copper, aluminum, iron, etc.)-thickness of the metal layer: 203 μm (8 mils);
Alternative Decorative Finish to the Rear Face Metal Layer (ML): Electropolishing, gold plating, powder coating, PVD or DLC coating, anodizing in the case of aluminum
MS Magnetic stripe (2 or 3 tracks (HiCo)) on an overlay film may be adhesively attached during the lamination process to the rear metal layer (ML);

### Additional Rear Layers (ARL) not Shown

DP Deposited primer;
AW Graphic print layer (Artwork)-deposition of digital ink (color); Optionally, a transparent coat of rigid ink (hard coat) for scratch protection applied over the graphic print layer, such as by means of digital printing;
TC Laser reactive topcoat, protective gloss or matte coating;
PLV Post lamination varnish-raised characters;
LM Laser marking of personalization data to the topcoat (TC), anti-scratch or protective coating on the surface of the bottom metal layer (ML) forming the rear subassembly (RS);
Combined thickness of the laser reactive, transparent hard coat, deposited ink and primer, approximately: 45 μm

Security elements (not shown)-signature panel and payment brand hologram (H).

FIG. 9D shows a wood metal hybrid transaction card or smartcard (SC) having a top wood layer (WL) forming a front subassembly (FS) and a core subassembly (CS) comprising a reinforcement layer (RL) and a bottom metal layer (ML) having an opening to accept the placement of an antenna insert (AI) and filling the area surrounding the insert with a composite wood veneer.

FIG. 9D: Architecture of a Wood Metal Hybrid Transaction Card (SC) with an Antenna Insert (AI)

The layers and process steps in the stack-up construction of the wood metal hybrid transaction card with a front layer of wood veneer and a rear slab of metal:

Component Elements and Additional Front Layers (AFL, not shown)
TCM A (6 or 8 pin faceplate) transponder chip module (wire bonded or flip chip bonded) residing in a module opening (MO), having a module antenna (MA) for inductive coupling with an antenna insert assembled in a composite filled opening in a bottom metal layer (ML);
MA Module antenna (MA) of the transponder chip module (TCM) having for example 15 turns, overlapping the antenna insert (AI) in the bottom metal layer (ML), after chip embedding;
MO Module opening (MO) in the form of a stepped cavity (P₁ and P₂) to accept the insertion or implanting of the transponder chip module (TCM);
LM Laser marking of personalization data to the topcoat (TC), inscribed in the surface of the wood layer (WL) forming the front subassembly (FS);
TC Topcoat of a water based sealer or UV varnish to protect the underlying laser engraved features;
AW Artwork-laser etching of graphic features directly into the wood surface or an impregnated wood surface;
IL Optionally, an impregnation layer (IL)-(Waterproofing/Reinforcement)-application of a water-based sealer or primer by spraying or screen printing to the front face surface of the wood layer (WL) forming the front subassembly (FS);

### Front Subassembly (FS):

WL Top face wood layer (WL) forming the front subassembly (FS) comprising a thin wood veneer orientated in a horizontal or vertical grain direction (lengthwise or crosswise) having a thickness of 250 μm, with the top wood layer impregnated from the underside with the adhesive from the reinforcement layer (RL) during the compression lamination process;

### Core Subassembly (CS):

RL A reinforcement layer having a thickness of 150 μm comprising a substrate layer of paper coated on both sides with an adhesive (ACP), wherein the adhesive on the top side of the substrate layer bonds to and impregnates the underside of the wood layer (WL) forming the front subassembly (FS), and wherein the adhesive on the bottom side of the substrate layer bonds to the bottom metal layer (ML);
Note, the wood layer offers mechanical support to the implanted chip module with a P₁ cavity depth of 195 μm.
AI Antenna insert comprising an antenna circuit for inductive coupling with the module antenna (MA) of the transponder chip module (TCM) and for RF communication with a contactless terminal, wherein the antenna insert is assembly in an opening in the bottom metal layer (ML);
ML Bottom face metal layer (ML) which may be a continuous metal layer with an opening to accept the placement of the antenna insert (e.g. stainless steel, titanium, brass, copper, aluminum, iron, etc.)-thickness of the metal layer: 203 μm (8 mils);

### Alternative Decorative Finish to the Rear Face Metal Layer (ML):

Electropolishing, gold plating, powder coating, PVD or DLC coating, anodizing in the case of aluminum
Note the antenna insert (AI) assembled in the opening of the bottom metal layer (ML) is shrouded in a composite layer of wood veneer.
MS Magnetic stripe (2 or 3 tracks (HiCo)) on an overlay film may be adhesively attached during the lamination process to the rear metal layer (ML);

Additional Rear Layers (ARL) not shown
DP Deposited primer;
AW Graphic print layer (Artwork)-deposition of digital ink (color); Optionally, a transparent coat of rigid ink (hard coat) for scratch protection applied over the graphic print layer, such as by means of digital printing;
TC Laser reactive topcoat, protective gloss or matte coating;
PLV Post lamination varnish-raised characters;
LM Laser marking of personalization data to the topcoat (TC), anti-scratch or protective coating on the surface of the bottom metal layer (ML); Combined thickness of the laser reactive, transparent hard coat, deposited ink and primer, approximately: 45 μm

Security elements (not shown)-signature panel and payment brand hologram (H).

FIG. 9E shows the bottom metal layer (ML) forming the core subassembly (CS) having a large opening to accept the placement of an antenna insert (AI) before filling with a composite of wood veneer.

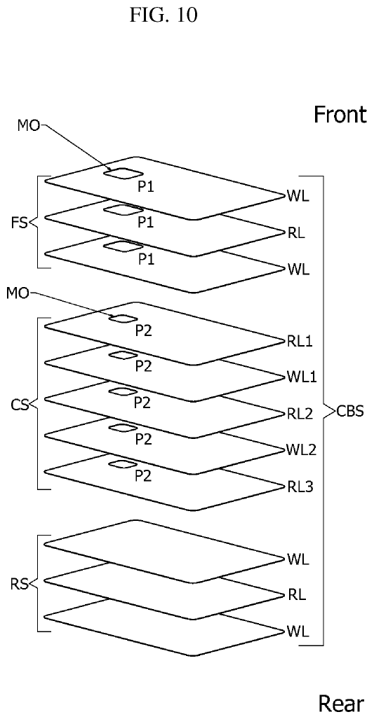

FIG. 10 shows a construction of a smartcard. The smartcard comprises a 6-ply card body subassembly (CBS), similar to the construction shown in FIG. 7. In this figure, the transponder chip module (TCM), the magnetic stripe (MS), and the additional front and rear layers (AFL and RFL, respectively) are omitted, for illustrative clarity. The front and rear subassemblies (FS and RS, respectively) and the core subassembly (CS) are shown for context, and may be substantially identical to those elements shown and described with respect to FIG. 7.

In this embodiment, there are two wood layers (WL1, WL2) and three reinforcing layers (RL1, RL2, RL3) in the core subassembly (CS). Individually, the wood layers and reinforcing layers in this embodiment may be substantially similar to the respective wood layers and reinforcing layers in the FIG. 7 embodiment. The thickness of the wood layers (WLs) may be rotary peeled at a thickness of 127 μm, compared to 150 μm for the corresponding wood layers in FIG. 7.

A booster antenna BA is not shown, but may be incorporated into the construction of this embodiment in the manner described with respect to FIG. 8A.

A coupling frame CF is not shown, but may be incorporated into the construction of this embodiment in the manner described with respect to FIG. 9A.

FIG. 10: Architecture of a 6-ply Wooden Transaction Card (WTC/SC) without a Booster Antenna Circuit (BA) or Coupling Frame (CF)

The layers and process steps in the stack-up construction of the 6-ply wooden transaction card (WTC/SC):
TCM An enlarged (6 or 8 pin faceplate) transponder chip module (TCM) with a module antenna (MA) for direct communication with a contactless point of sale terminal without the need for an in-card booster antenna (BA) or a coupling frame (CF), residing in a module opening (MO);
MA Module antenna (MA) of the enlarged transponder chip module (TCM);
MO Module opening (MO) in the form of a stepped cavity (P₁ and P₂) to accept the insertion or implanting of the enlarged transponder chip module (TCM);
LM Laser marking of personalization data to the topcoat (TC) of the upward facing wood layer (WL) of the front 2-ply subassembly (FS);
TC Topcoat (TC) in the form of a one or two component clear water-based self-sealer or UV varnish to protect the digitally deposited UV curable ink;
AW Artwork (AW)-digitally deposited UV curable ink with the underlying impregnation layer (IL) acting as an adhesion promoter (primer) and sealer;
IL Impregnation/waterproofing layer (IL) in the form of a one or two component clear water-based self-sealer or primer, applied by spraying, roller coating or screen printing the front face surface of the wood layer (WL) in the front two-ply subassembly (FS);

Front 2-Ply Wood Veneer Subassembly (FS) bonded together using an Adhesive Coated Paper (ACP)
WL Top wood layer (WL: upward facing side) of the front 2-ply subassembly (FS) comprising a micro thin wood veneer orientated in a horizontal grain direction (lengthwise) having a thickness of approximately 127 μm;
RL Reinforcement layer (RL) in the form of a melamine film made by pressing paper saturated with melamine resin, and may be referred to as an adhesive coated paper (ACP). The melamine impregnated paper may have a thickness of 140 μm with a processing temperature of 130-135° C., wherein the melamine film impregnates the underside of the top wood layer (WL) and the upside of the underlying (rear layer) wood layer (WL);
WL Bottom wood layer (WL) of the front 2-ply subassembly (FS) comprising a micro thin wood veneer orientated in a vertical grain direction (crosswise) having a thickness of approximately 127 μm;
Features may be mechanically engraved or laser etched to the top wood layer (WL: upward facing side) of the front 2-ply wood veneer subassembly (FS).

Core 2-Ply Wood Veneer Subassembly (CS) bonded together using an Adhesive Coated Fleece (ACF)
RL1 Reinforcement layer (RL1) in the form of an adhesive coated fleece (ACF) having a thickness of 150 μm with a processing temperature of 120-140° C., comprising a substrate layer of nonwoven fabric (cellulose and synthetic fibers bonded with a latex binder) coated on both sides with an adhesive layer (AL), wherein the adhesive on both sides of the nonwoven fabric impregnates the upper wood layer (WL1) of the core 2-ply wood veneer subassembly (CS) and the underside of the wood layer (WL) in the front 2-ply subassembly (FS);
WL1 Upper wood layer (WL1) of the core 2-ply subassembly (CS) comprising a micro thin wood veneer orientated in a horizontal grain direction (lengthwise) having a thickness of approximately 127 μm;
RL2 Reinforcement layer (RL2) in the form of an adhesive coated fleece (ACF) having a thickness of 150 μm with a processing temperature of 120-140° C., comprising a substrate layer of nonwoven fabric (cellulose and synthetic fibers bonded with a latex binder) coated on both sides with an adhesive layer (AL), wherein the adhesive impregnates the underside of the upper wood layer (WL1) and the upside of the lower wood layer (WL2);
WL2 Lower wood layer (WL2) of the core 2-ply subassembly (CS) comprising a micro thin wood veneer orientated in a vertical grain direction (crosswise) having a thickness of approximately 127 μm;
Note that the grain direction of the upper wood layer (WL1) and the lower wood layer (WL2) may be in the same direction, i.e. either crosswise or lengthwise providing additional rigidity to the complete assembly.
RL3 Reinforcement layer (RL3) in the form of an adhesive coated fleece (ACF) having a thickness of 150 μm with a processing temperature of 120-140° C., comprising a substrate layer of nonwoven fabric (cellulose and synthetic fibers bonded with a latex binder) coated on both sides with an adhesive layer (AL), wherein the adhesive on both sides of the nonwoven fabric impregnates the underside of the lower wood layer (WL2) of the core 2-ply subassembly (CS) and the upside of the wood layer (WL) in the rear 2-ply subassembly (RS);

Rear 2-Ply Wood Veneer Subassembly (RS) bonded together using an Adhesive Coated Paper (ACP)
WL Bottom wood layer (WL: inward facing) of the rear 2-ply subassembly (RS) comprising a micro thin wood veneer orientated in a vertical grain direction (crosswise) having a thickness of approximately 127 μm;
RL Reinforcement layer (RL) in the form of a melamine film made by pressing paper saturated with melamine resin, and may be referred to as an adhesive coated paper (ACP). The melamine impregnated paper may have a thickness of 140 μm with a processing temperature of 130-135° C., wherein the melamine film impregnates the underside of the bottom (inward facing) wood layer (WL) and the upside of the downward facing wood veneer (WL);
WL Front wood layer (WL: downward facing side) of the rear 2-ply subassembly (RS) comprising a micro thin wood veneer orientated in a horizontal grain direction (lengthwise) having a thickness of approximately 127 μm;
Features may be mechanically engraved or laser etched to the front layer (downward facing side) of the rear 2-ply subassembly (RS).
IL Impregnation/Waterproofing layer (IL) in the form of a one or two component clear water-based self-sealer or primer, applied by spraying, roller coating or screen printing the front face surface (downward facing side) of the wood layer (WL) in the rear two-ply subassembly (RS);
AW Artwork (AW)-digitally deposited UV curable ink with the underlying impregnation layer acting as an adhesion promoter (primer);
TC Topcoat (TC) in the form of a one or two component clear water-based self-sealer or UV varnish to protect the digitally deposited UV curable ink;
LM Laser marking (LM) of personalization data to the topcoat of the downward facing wood layer (WL) of the rear 2-ply wood veneer subassembly (RS);
MS Magnetic stripe (2 or 3 tracks (HiCo)) adhesively attached to the downward facing wood veneer (WL) of the rear 2-ply wood veneer subassembly (RS), or the magnetic stripe may be applied to the topcoat (TC);

Security elements (not shown)-signature panel and payment brand hologram.

FIG. 10: Description and dimensions of the individual layers forming the card construction SC

| Layers | Description | Grain direction | Thickness |
|---|---|---|---|
| WL-FS | Rotary peeled wood veneer (Top) | Lengthwise | 127 μm |
| RL-FS | Adhesive coated paper (ACP) for bonding and | | 140 μm |
| | reinforcement-Melamine film | | |
| WL-FS | Rotary peeled wood veneer (Bottom) | Crosswise | 127 μm |
| RL1-CS | Adhesive coated fleece (ACF) for bonding and | | 150 μm |
| | reinforcement (aka ACSL) | | |
| WL1-CS | Rotary peeled wood veneer (Core- Upper) | lengthwise or | 127 μm |
| | | crosswise | |
| RL2-CS | Adhesive coated fleece (ACF) for bonding and | | 150 μm |
| | reinforcement (aka ACSL) | | |
| WL2-CS | Rotary peeled wood veneer (Core-Lower) | lengthwise or | 127 μm |
| | | crosswise | |
| RL3-CS | Adhesive coated fleece (ACF) for bonding and | | 150 μm |
| | reinforcement (aka ACSL) | | |
| WL-RS | Rotary peeled wood veneer (Bottom-inward | Crosswise | 127 μm |
| | facing side) | | |
| RL-RS | Adhesive coated paper (ACP) for bonding and | | 140 μm |
| | reinforcement-Melamine film | | |
| WL-RS | Rotary peeled wood veneer (front-downward | Lengthwise | 127 μm |
| | facing side) | | |
| | Total thickness of the 6-ply construction before | | 1.492 mm |
| | lamination: | | |
| | Post lamination thickness of the assembly with | | 0.95 mm |
| | approximately 36 % shrinkage in thickness: | | |

The post laminated card body sub-assembly (CBS) is sanded back to 800 μm for ISO compliance.

For the purpose of clarity, the front and rear 2-ply subassemblies (FS and RS) may be laminated separately as pre-laminates or the entire stack-up construction including the core 2-ply wood veneer subassembly (CS) and reinforcement layers may be laminated in one step, applying pressure and temperature over a defined dwell time.

Sanding-back the laminated 6-ply card body sub-assembly (CBS) of wood veneers with intermediate layers of adhesive to be ISO card thickness compliant is a prerequisite process in the manufacture of wooden smartcards destined for payment applications. Sanding-back is also required to achieve a uniform thickness and flatness. Sanding-back is also a requirement to achieve a certain surface roughness (Ra<2 μm) before applying the magnetic stripe. And sanding-back the wooden surface is also needed before impregnation (sealing).

The adhesive coated paper (ACP) and adhesive coated fleece (ACF) provides adhesion, reinforcement and weight to the card stack-up construction. The layers of ACP and ACF may be interchanged, and ACP may be replaced by ACF and visa verse. Phenolic adhesive film may also be used as a substitute for the adhesive coated fleece or adhesive coated paper or may be used in combination thereof.

### Impregnation-Artwork-Topcoat

| Layers | Description | | Thickness |
|---|---|---|---|
| TC | Topcoat-sprayed/screen | Water-based self- | |
| | printed | sealer/UV varnish | |
| AW | Artwork-digitally deposited | UV curable Ink | |
| IL | Impregnation layer Adhesion | Water-based self- | |
| | promoter-spraying/screen | sealer/primer | |
| | printing | Thickness before | ~45 μm |
| | | absorption into the | |
| | | wood veneer | |

### Additional Rear Layers (ARL)

| Layers | Description | | Thickness |
|---|---|---|---|
| IL | Impregnation layer/Adhesion | Water-based self- | |
| | promoter-spraying/screen | sealer/primer | |
| | printing | | |
| AW | Artwork-digitally deposited | UV curable Ink | |
| TC | Topcoat-sprayed/screen | Water-based self- | |
| | printed | sealer/primer | |
| | | Thickness before | ~45 μm |
| | | absorption into the | |
| | | wood veneer | |

Card body thickness after simultaneous press lamination of all subassemblies (top, core and bottom), sanding back to be ISO compliant, protective coatings and impregnation layers including digitally deposited ink: under 830 μm.

In FIG. 10, the laminated card body subassembly (CBS) has to be sanded back from almost 950 μm to 800 μm. It is therefore an embodiment of the invention, to pre-press the rotary peeled wood veneers in a lamination press from 150 μm to approximately 110 μm and to revert to a 5-ply construction to achieve a post lamination thickness of approximately 850 μm, before sanding-back. Alternatively, the lamination pressure must be significantly increase to compress the 6-ply construction to an ISO conforming thickness of 760-800 μm without sanding back.

### Card Body Stiffness

It is a requirement that wooden cards resist bending, do not warp under environmental conditions and remain flat during the lifetime of the payment smartcard. Therefore, five criteria are required: high strength, stiffness, thickness uniformity, flatness and smoothness.

Reference is made to: Matthias Jakob, Arunjunai Raj Mahendran, Wolfgang Gindl-Altmutter, Peter Bliem, Johannes Konnerth, Ulrich Müller and Stefan Veigel (2022) “The strength and stiffness of oriented wood and cellulose-fibre materials: A review”, Progress in Materials Science, Volume 125, April 2022, 100916.

### Materials and Processes

Some of the following materials and processes may be used in the construction of the various embodiments of wooden cards disclosed herein.

### Wood Veneer

Veneer is produced by slicing or rotary cutting a tree log in thin layers with a blade. The standard thickness of the veneer is 0.6 mm. The veneer retains the natural look and feel of real wood as well as its unique properties, showing authentic color and pattern variations. Wood veneers are available in more than 165 different standard wood species. Reference is made to: internet.decospan.com/en/; internet.dieterle.com/furniere; and internet.formwood.com/.

Veneers are available in a variety of wood species such as ash, aspen, bamboo, birch, birds eye maple, burl, cathedral walnut, cherry, cherry cathedral, curly maple, Douglas fir, eastern red cedar, ebony, fir, hard ash, hard maple, Hawaiian Koa, mahogany, maple, oak, oak cathedral, olivewood, poplar, red cedar, rosewood, sassafras, teak, walnut, wenge, western red cedar, white oak, yellow poplar, zebra, etc. The standard veneer format may be 24 inches square (610 μm×610 μm), with a thickness ranging from 127 μm (5 mils), 140 μm (5.5 mils), 150 μm (6 mils), 178 μm (7 mils), 203 μm (8 mils), 254 μm (10 mils) to 305 μm (12 mils). The veneer may be perforated for drop acoustics. Veneers may be supplied with a fleece as backer.

Wood veneers with a thickness under 203 μm are generally rotary peeled, whereas wood veneers with a thickness above 500 μm are typically sliced.

### Thermowood

Wood properties naturally enhanced with heat and steam. It is a sustainable timber material produced using chemical-free heat treatment.

### Wood Glue (PVAc)

PVAc wood glues, often also called white glues, are produced by polymerizing vinyl acetate or copolymerizing with other monomers and are thermoplastic adhesives. Modern wood glues are now predominantly solvent-free. Polyvinyl acetate is a widely available adhesive used for porous materials like wood, paper, fleece and cloth. Thermoplastic PVA may be altered to function as a thermoset by the addition of a hardener.

### Amino Resins

They are a class of synthetic thermosetting polymers created by reacting formaldehyde with amino compounds, primarily including urea-formaldehyde (UF) and melamine-formaldehyde (MF) resins, which undergo a two-stage reaction to form a three-dimensional crosslinked network structure.

### Phenolic Adhesive Film

Phenolic surface films (PSF) are resin impregnated industrial overlays designed to improve the surface characteristics of wood-based panels. Phenolic adhesive film (thermoset) in various colors may have a thickness of 110 μm with a processing temperature of 130-135° C.

### Melamine Film

Exterior plywood coated with melamine film is made by pressing paper saturated with melamine resin on a surface of exterior plywood. The surface coated with the film improves their resistance to abrasion and protects the sheets from moisture. Melamine impregnated paper may have a thickness of 140 μm with a processing temperature of 130-135° C.

A melamine film impregnated with adhesive having an overall thickness of 110 μm may comprise of 40 g/m² of paper and 80 g/m² of adhesive with a total weight of 120 g/m².

### Backers

Backings strengthen wood veneers to make them sturdier for easy handling. Backings reinforce wood grains to make them more flexible, reducing the potential damage to the wood from bending. Flame resistance and water resistance versions are available. Backings are pre-coated with a dry film adhesive. Available in rolls or sheets. Typical thicknesses for application in smartcards range from 40 μm, 75 μm and 100 μm. Backer material types include: clear, polyester, fleece, woven, cellulose, thin paper, thick paper, melamine, foam, fiber or composites.

### Calendering

It is a process of smoothing and compressing a material (notably paper or fleece) during production by passing a single continuous sheet through a number of pairs of heated rolls. The rolls in combination are called calenders.

### Wetlaid Nonwoven

A wetlaid nonwoven is a type of fabric created by dispersing short fibers in a liquid, typically water, and then depositing the suspension onto a moving screen to form a web. The water is then removed, and the remaining fibers are bonded together, either through mechanical entanglement, chemical binders, or heat, to create a sheet-like material. This process is similar to papermaking but uses a wider range of fibers and bonding methods.

Wetlaid nonwoven fleece is typically manufactured with cellulose and synthetic fibers (e.g. polyester fibers) bonded with a latex binder.

### Adhesive Coated Fleece

An adhesive coated fleece is applied to a wood veneer for reinforcement. It comprises a fleece material coated with wood glue. The fleece mainly consists of long-fibrous cellulose. Synthetic fibers (such as polyethylene (PE) or polyester fibers) as well as a latex binder are admixed for increasing tear resistance and flexibility. The glue coating is applied from a water-based system. In combination with sufficient press temperature and pressure it provides a very heat- and water-resistant bond. The closed surface of the glue avoids penetration of water or solvents. Adhesive coated fleece, a nonwoven material coated on one side with glue, may have a thickness of 125 μm with a maximum processing temperature of 140° C. The fleece carrier may also be coated on both sides having an overall thickness of 150 μm.

### Glass Fiber Nonwovens

Glass fiber nonwovens are sheet or web structures made by bonding together randomly dispersed glass fibers through mechanical, thermal, or chemical processes, but without weaving or knitting. They are used in various applications, due to their versatility and ability to be engineered with specific properties. They offer benefits like dimensional stability, tear strength, and resistance to moisture, mold, and mildew.

### Nonwovens of Glass Fiber and Fleece

In a hybrid fleece and glass fiber construction (with approximately 70% glass fiber, PE fibers and 2% binder), also known as nonwoven fiberglass fleece fabric, the mechanical strength and tear resistance can be significantly improved.

### Hydroentangled Nonwovens

Hydroentanglement, also known as spun-lacing, is a method of creating nonwoven fabrics by using high-pressure water jets to entangle fibers. This process involves passing a web of fibers through multiple rows of fine, high-velocity water jets, which cause the fibers to interlock and form a fabric-like structure. Hydroentangled nonwovens are known for their softness, strength, high absorbency, and good uniformity.

Nonwoven fabrics can be made from various materials, including polyethylene (PE) fibers. PE is a type of polymer that can be used to create soft, comfortable, and durable nonwoven textiles. The process often involves creating a web of fibers, either by extruding PE or using existing PE fibers, and then bonding them together through various methods.

### Printing Primer

A printing primer is a coating applied to a surface before printing to improve ink adhesion, control surface tension, and ensure a uniform, smooth surface for ink droplets. By creating an intermediate layer, a primer makes it easier for inks to bond to the substrate, resulting in higher-quality prints with enhanced color vibrancy, clarity, and sharpness.

### Acrylic

The term “acrylic” represents a family of petroleum-based thermoplastics made from the derivation of natural gas. It is any compound that includes acrylic acid or related compounds called acrylates.

Acrylic resin is a common ingredient in latex paint (aka emulsion paint). Latex paints with a greater proportion of acrylic resin offer better stain protection, greater water resistance, better adhesion, greater resistance to cracking and blistering, and resistance to alkali cleaners compared to those with vinyl.

Acrylic resins are materials which when added to latex increases its gloss properties, mechanical durability (i.e. scratch resistance) and improves the gloss over vinyl-only resins.

Acrylic paint is a fast-drying paint made of pigment suspended in acrylic polymer emulsion and plasticizers, silicone oils, defoamers, stabilizers, or metal soaps. Most acrylic paints are water-based but become water-resistant when dry.

One of the main color compounds of acrylic paint is titanium dioxide which can be harmful to marine life. Eco-friendly, plant-based acrylic paint containing zero plastic that is 100% titanium-free and marine-friendly is currently under development.

### EVA Film

It is a kind of high-viscosity film material made of high molecular resin (ethylene vinyl acetate copolymer) with special additives. It is also called modified EVA film for laminated glass. It has strong adhesion to inorganic glass. It has the characteristics of toughness, transparency, temperature resistance, cold resistance, high adhesion strength, high elongation at break, and good humidity resistance. EVA films are employed in lamination and coating applications. They act as a protective layer, imparting resistance to UV radiation, moisture, and chemicals.

### Penetrating Wood Sealer

A semi-transparent waterproofing stain and sealer enhances a wood veneer's natural pattern while providing increased protection from the elements. They are formulated: (i) to protect the wood veneer from drying out and cracking under direct sunlight (UV Protection), (ii) to ensure that surface water beads on contact and cannot soak into the wood veneer (Water Resistant) and (iii) to withstand changes in environmental conditions having a tough surface finish (Durability Protection).

In general, such penetrating wood sealers are composed of acrylic resin. The resin may be applied to the wood veneer surface by using a pad applicator, brush, nap or sprayer.

### Water-based Self-Sealer

A water-based self-sealer for wood is a type of wood finish that serves both as a sealer and topcoat in one product. It is designed to seal the wood surface, fill pores, and create a protective layer, all while enhancing the wood's natural beauty. The term “self-sealer” means you don't need a separate sealing product before applying the finish.

Key features of water-based self-sealers include (1) water-based formula-uses water as the primary solvent, making it low in volatile organic compounds (VOCs) and environmentally friendly and dries quickly and cleans up easily with soap and water. (2) dual functionality-acts as both a sealer (to protect and prepare the surface) and a topcoat (to provide durability and a finished look). (3) clarity-often dries clear, preserving the natural color and grain of the wood.

### Lignin

It is one of the three main constituents of wood along with cellulose and hemicellulose. It is the second most abundant biopolymer and most abundant natural aromatic compound. One of its most promising applications is related to the fabrication of thermosetting materials such as phenol/formaldehyde resins, polyurethanes, epoxies, and thiol-ene resins.

### Biodegradable Glues

They are designed to break down naturally over time. These materials are often derived from plant-based sources like corn or soybeans, which are renewable and sustainable. When the glue is applied, it forms a strong bond between two surfaces, just like traditional glue. However, unlike traditional glue, biodegradable glue will break down naturally over time, leaving behind no harmful residue or waste.

Biodegradable adhesives decompose naturally over time into harmless components such as carbon dioxide, water, mineral salts, and microbial biomass.

### Protein Adhesives

Eco-friendly protein adhesives have been around since ancient times, and are commonly used in bookbinding, woodworking, case making, and box-making applications. Protein adhesives are made up of just a few all-natural ingredients, which include gelatin, glycerin, water, Epsom salt and corn sugar.

Since these raw materials are naturally recyclable, protein adhesives are also completely biodegradable. They will begin breaking down only weeks after being recycled back into the natural environment.

### Animal Adhesive Products

Animal glue, also referred to as “hide glue,” was the first kind of binding product known to man. It was the primary type of adhesive or glue available before modern synthetic polymers were discovered.

Animal adhesives are derived from gelatin that is extracted from collagen, a naturally occurring substance found in bovine and porcine hides. As a sizing agent, animal-based adhesive and binding products are water soluble. Until the introduction of synthetic adhesives, animal glue was the preferred gluing agent due to its great versatility and usefulness in various fields of application.

Unlike other types of adhesives, animal glue is applied while hot. Its unique properties as a non-toxic adhesive and glue make animal glue ideal for bookbinding, laminating and woodworking. Animal-based adhesives also dissolve quickly and are safe and biodegradable. Reference is made to: internet.usadhesive.com/animalglue.aspx

### Animal-Based Adhesives

Casein and gelatin are two natural components used to produce animal adhesives. These adhesives are frequently utilized in woodworking. Although they are biodegradable, they are not considered as sustainable as plant-based adhesives, because animals require large swaths of land and have significantly higher water and energy requirements than plants, not to mention the ethics involved with the treatment and living conditions of animals raised in high-throughput settings.

### Shape Memory Effect

In use, cards will be subject to bending as a result of deformation forces. Shape memory effect, otherwise known as elastic deformation, can be defined as the ability of a material to retain its original shape and size after deformation, such as upon the application of an external stimulus. Elastic deformation is the deformation that disappears upon the removal of external forces, causing the alteration and the stress associated with it. Elastic deformation is hence reversible and non-permanent. Elastic deformation is best explained by the chemical concept “elasticity”. Elasticity is the ability of a substance to resume the normal state after deformation.

### Tung Oil

Tung oil or China wood oil is a drying oil obtained by pressing the seed from the nut of the tung tree (Vernicia fordii). Tung oil hardens upon exposure to air (through polymerization), and the resulting coating is transparent and has a deep, almost wet look. Used mostly for finishing and protecting wood, after numerous coats, the finish can even look plastic-like. Related drying oils include linseed, safflower, poppy, and soybean oils.

### Dyed Wood Veneers

Wood veneer dyeing technology involves immersion-based methods, often using pressurized tanks to force a dye solution deep into the wood. These processes, which can also be enhanced by technologies like ultrasound, aim for uniform color penetration throughout the veneer's thickness, unlike surface-only stains. Key steps include dye absorption under pressure or vacuum, followed by washing and drying.

Wood veneers in a variety of colors may be used to create aesthetic effects in the construction of wooden transaction cards. Typically, wood veneers with a thickness greater than 300 μm can be dyed.

### Reconstituted Wood Veneers

Technical, or reconstituted, veneers are man-made wood products created by dyeing and laminating thin sheets of fast-growing wood to replicate the appearance of natural wood species. This process results in a consistent, defect-free product with a wide variety of colors and grain patterns that are available in large, uniform sheets. This makes it an eco-friendly, often more affordable alternative to rare or expensive natural veneers.

### Scent of Wood

The smell of birch wood veneer is a complex blend of fresh, woody, and earthy notes, often with hints of sweetness and smokiness, reminiscent of a forest, while maple wood veneer is nearly inconspicuous as it is a low-odor wood, described as slightly sweet or creamy.

The smell of laser-cut wooden cards is a distinct, often strong, burnt, smoky aroma caused by the laser vaporizing the wood fibers and adhesive layers, releasing natural compounds and char residue.

Wooden transaction cards may be infused with an aromatic blend of perfume oils, saturating the wood veneers with various fragrances.

FIG. 12A shows a timber metal transaction card (TMTC) or smartcard (SC) having a front face discontinuous metal layer (DML) and a rear face wood (veneer) layer (WL) adhesively attached to and sandwiching a core subassembly (CS) comprising layers of wood veneer with adhesive layers for interlayer bonding and substrate layers for reinforcement (forming a 3-ply wood veneer laminate with 2 adhesive coated substrate layers (ACSL: 4 interlayers of adhesive and 2 substrate layers)), wherein a booster antenna circuit (BAC) is incorporated in a top adhesive layer and electrically connected to a chip module (CM).

FIG. 12A: Architecture of a Timber Metal Transaction Card (TMTC) with a Wire Embedded Booster Antenna Circuit (BAC) incorporated in a 3-ply Wood Veneer Construction forming a Core Subassembly (CS)

The layers and process steps in the stack-up construction of the timber metal transaction card (TMTC/SC):
CM 6 or 8 pin faceplate dual interface chip module (CM) residing in a module opening (MO) with terminals (L_{A} and L_{B}) on its bond side for a physical interconnection (e.g. per TeConnect) to an in-card booster antenna circuit (BAC);
MO Module opening (MO) in the form of a stepped cavity (P₁ and P₂) to accept the insertion or implanting of the dual interface chip module (CM);

### AFL

LM Laser marking of personalization data to a topcoat (TC) applied to the upward facing metal layer (ML) forming the front subassembly (FS), not shown;
TC Laser engravable topcoat (TC), sprayed-on or screen printed, to protect the underlying laser etched features, not shown;
AW Artwork-laser etched graphics, for example imitating a woodgrain effect to create a decorative design (DD) in the front face metal layer (ML);

### FS

Front Subassembly (FS) of a Metal Layer bonded to the Core Subassembly (CS) using an Adhesive Layer (AL):
ML Front face discontinuous (aluminum) metal layer (DML) having a gap (G) disguised in the laser etched decorative design (DD) with a milled out pocket (post lamination) or a laser cut module opening (before lamination of the assembly), and coated on its front surface with a lacquer including color pigments and pre-treatment, and a primer applied to its reverse side for enhanced adhesion, having a thickness of 100 μm;
AL Adhesive layer (AL) in the form of a thermoplastic or thermoset adhesive film having a thickness of 25 μm;

### CS

### Core Wood Veneer Subassembly (CS)

WL Intermediate wood layer (Upper PWL or IWL) of the core subassembly (CS) comprising a micro thin wood veneer (rotary peeled) orientated in a vertical grain direction (crosswise) having a thickness of 150 μm;
BA An insulated wire conductor (bare copper wire Ø: 80 or 112 μm) ultrasonically embedded into the top adhesive layer coated to the top substrate layer (SL), in forming a booster antenna circuit (BAC) with a perimeter coil (aka communication coil) and connection pads in the form of wire embedded squiggles or meanders to facilitate the interconnection to the dual interface chip module (CM);
AL Adhesive layer (top side) as a coating applied to the substrate layer (SL) having a thickness of 25 μm, with the wire embedded antenna scribed therein;
SL Substrate layer having a thickness of ~100 μm (post calendering from an initial thickness of ~220 μm), comprising a substrate layer of nonwoven fabric (aka a fleece layer (FL)) or nonwoven pulp and fiber comprising cellulose and synthetic fibers bonded with a latex binder;
AL Adhesive layer (bottom side) having a thickness of 25 μm as a coating applied to the substrate layer (SL);
WL Intermediate wood layer (Middle PWL or IWL) comprising a micro thin wood layer (WL) orientated in a horizontal grain (lengthwise) direction having a thickness of 150 μm;
AL Adhesive layer as a coating applied to the top side of the substrate layer (SL) having a thickness of 25 μm;
SL Substrate layer having a thickness of ~100 μm (post calendering from an initial thickness of ~220 μm), comprising a substrate layer of nonwoven fabric (aka a fleece layer (FL)) or nonwoven pulp and fiber comprising cellulose and synthetic fibers bonded with a latex binder;
AL Adhesive layer having a thickness of 25 μm as a coating applied to the underside of the substrate layer (SL);
Note that AL+SL+AL forms the adhesive coated substrate layer (ACSL).
WL Intermediate wood layer (Lower PWL or IWL) comprising a micro thin wood layer (WL) orientated in a vertical grain (crosswise) direction having a thickness of 150 μm;
The post lamination thickness of the 3-ply core subassembly (CS) is approximately 545 μm+15 μm (27% compression).

### RS

Rear Single-Ply Wood Veneer Subassembly (RS) bonded together using an Adhesive Layer (AL):
AL Adhesive layer (AL) in the form of thermoplastic or thermoset adhesive film having a thickness of 25 μm;
WL Rear face wood (veneer) layer (PWL) of the rear single-ply subassembly (RS) comprising a micro thin wood veneer (rotary peeled) orientated in a horizontal grain direction (lengthwise) having a thickness of 150 μm;

### ARL

AW Artwork-laser etched graphics in the rotary peeled wood veneer layer (PWL or WL) of the rear subassembly, not shown;
TC Laser engravable topcoat (TC), sprayed on or screen printed, in the form of a water-based self-sealer or UV varnish to protect the underlying laser etched features, not shown;
MS Magnetic stripe (2 or 3 tracks (HiCo)) adhesively attached to or recessed in the rear facing rotary peeled wood veneer layer (PWL) of the rear single-ply subassembly (RS), or the magnetic stripe may be applied and pressed into the topcoat (TC);
LM Laser marking (LM) of personalization data to the topcoat (TC) in the rear rotary peeled wood veneer layer (PWL or WL) of the rear single-ply subassembly (RS);

Security elements (not shown)-signature panel and payment brand hologram.

FIG. 12A: Description and dimensions of the individual layers forming the smartcard (SC) construction

| Layers | Description | Grain direction | Thickness |
|---|---|---|---|
| ML-FS | Front face metal layer, such as aluminum, laser | Imitation | 100 μm |
| | etched with a decorative design having a gap | woodgrain | |
| | disguised within the graphic elements and a | effect | |
| | milled-out pocket or a laser cut module opening | | |
| | to accept the placement of a dual interface chip | | |
| | module | | |
| AL-FS | Adhesive layer for bonding | | 25 μm |
| WL-CS | Upper intermediate (rotary) peeled wood | Crosswise | 150 μm |
| | (veneer) layer (PWL: Upper Core)-wood | | |
| | species: Birch | | |
| BA-CS | Wire embedded booster antenna circuit (BAC) | | |
| | formed in the top adhesive layer coated to the | | |
| | top substrate layer (SL) and completely | | |
| | submerged (bare copper wire Ø 80 μm or Ø 112 | | |
| | μm | | |
| AL-CS | Top upper adhesive layer of the adhesive coated | | 25 μm |
| | substrate layer (ACSL) for bonding, and to | | |
| | accept the ultrasonic scribing of the wire | | |
| | antenna circuit | | |
| SL-CS | Upper substrate layer in the form of nonwoven | | 100 μm |
| | fabric (aka a fleece layer (FL) or nonwoven pulp | | |
| | and fiber for reinforcement | | |
| AL-CS | Bottom upper adhesive layer of the adhesive | | 25 μm |
| | coated substrate layer (ACSL) for bonding | | |
| WL-CS | Middle intermediate (rotary) peeled wood | Lengthwise | 150 μm |
| | (veneer) layer (PWL: Middle Core)-wood | | |
| | species: Birch | | |
| AL-CS | Top lower adhesive layer of the adhesive coated | | 25 μm |
| | substrate layer (ACSL) for bonding | | |
| SL-CS | Lower substrate layer in the form of nonwoven | | 100 μm |
| | fabric (aka a fleece layer (FL) or nonwoven pulp | | |
| | and fiber for reinforcement | | |
| AL-CS | Bottom lower Adhesive layer of the adhesive | | 25 μm |
| | coated substrate layer (ACSL) for bonding | | |
| WL-CS | Lower intermediate (rotary) peeled wood | Crosswise | 150 μm |
| | (veneer) layer (PWL: Lower Core)-wood | | |
| | species: Birch | | |
| | Note that the core subassembly (750 μm) may | | |
| | be laminated before final lamination of the | | |
| | complete stack-up, having a nominal thickness, | | |
| | post lamination of 545 μm | | |
| AL-RS | Adhesive layer for bonding | | 25 μm |
| WL-RS | Rear face rotary peeled wood (veneer) layer | Lengthwise | 150 μm |
| | (PWL)-wood species: Birch | | |
| | Total thickness of the laminated 3-ply core | | 0.845 mm |
| | subassembly (545 μm), 2 adhesive layers for | | |
| | interlayer boding, a front face metal layer and a | | |
| | rear face wood layer before final press | | |
| | lamination of the stack-up: | | |

### Impregnation/Topcoat-Laser Etched Artwork

| Layers | Description | | Thickness |
|---|---|---|---|
| TC | Laser engravable topcoat | Water-based self- | 10 μm |
| | (TC)-sprayed on/screen | sealer/UV varnish | |
| | printed | | |
| AW | Laser-etched Artwork | | |

### Additional Rear Layers (ARL)

| Layers | Description | | Thickness |
|---|---|---|---|
| AW | Laser-etched Artwork | | |
| TC | Laser engravable topcoat | Water-based self- | 10 μm |
| | (TC)-sprayed on/screen | sealer/UV varnish | |
| | printed, for impregnation | | |
| | post laser treatment | | |

FIG. 12B shows a timber metal layer transaction card (TMTC) or smartcard (SC) having a front face discontinuous metal layer (DML), an upper adhesive layer (AL), a magnetic shielding layer (MSL) and a lower adhesive layer (AL) forming a front subassembly (FS) and a rear face wood (veneer) layer (WL) with an adhesive layer (AL) forming a rear subassembly (RS) respectively laminated to a top and bottom surface of a core subassembly (CS) comprising layers of wood veneer with adhesive layers for interlayer bonding and substrate layers for reinforcement (forming a 3-ply wood veneer laminate with 2 adhesive coated substrate layers (ACSL: 4 interlayers of adhesive and 2 substrate layers)), wherein a booster antenna circuit (BAC) for inductive coupling with the module antenna (MA) of a transponder chip module (TCM) is incorporated into the top adhesive layer (AL) coated to the top substrate layer (SL).

FIG. 12B: Architecture of a Timber Metal Transaction Card (TMTC) with a Wire Embedded Booster Antenna Circuit (BAC) for Inductive Coupling incorporated in a 2-ply Wood Veneer Construction forming a Core Subassembly

The layers and process steps in the stack-up construction of the timber metal transaction card (TMTC/SC): TCM 6 or 8 pin faceplate dual interface chip module (CM) with a module antenna (MA) for inductive coupling with an in-card booster antenna circuit, (aka a transponder chip module (TCM or inductive coupling chip module (ICM)), residing in a module opening (MO);
MA Module antenna with a given number of turns, e.g. 16 windings, for inductive coupling with the coupler coil (CC) of the booster antenna circuit (BAC);
MO Module opening (MO) in the form of a stepped cavity (P₁ and P₂) to accept the insertion or implanting of the transponder chip module (TCM);

### AFL

LM Laser marking of personalization data to a topcoat (TC) applied to the upward facing metal layer forming the front subassembly (FS), not shown;
TC Laser engravable topcoat (TC), sprayed-on or screen printed, to protect the underlying laser etched features, not shown;
AW Artwork-laser etched graphics imitating a woodgrain effect to create a decorative design (DD) in the front face metal layer (ML);

### FS

Front Subassembly (FS) of a Metal Layer bonded to the Core Subassembly (CS) using an Adhesive Layer (AL):
ML Front face discontinuous (aluminum) metal layer (DML) having a gap (G) disguised in the laser etched decorative design (DD) with a milled out pocket (post lamination) or a laser cut module opening (pre-lamination of the assembly), and coated on its front surface with a lacquer including color pigments and pre-treatment, and a primer applied to its reverse side for enhanced adhesion, having a thickness of 100 μm;
AL Upper adhesive layer (AL) in the form of a thermoplastic or thermoset adhesive film having a thickness of 25 μm;
MSL Magnetic shielding layer (MSL: 50, 65 or 75 μm) to offset the attenuation effect of the front face metal layer (ML);
AL Lower adhesive layer (AL) in the form of a thermoplastic or thermoset adhesive film having a thickness of 25 μm;

### CS

### Core Wood Veneer Subassembly (CS)

WL Intermediate wood layer (Upper PWL or IWL) of the core subassembly (CS) comprising a micro thin wood veneer (rotary peeled) orientated in a vertical grain direction (crosswise) having a thickness of 127 μm;
BA An insulated wire conductor (bare copper wire Ø: 80 or 112 μm) ultrasonically embedded into the top adhesive layer (AL) coated to the top substrate layer (SL), in forming a booster antenna circuit (BAC) with a perimeter coil (aka communication coil) and a coupler coil for inductive coupling with the module antenna of the transponder chip module (TCM);
AL Adhesive layer (top side) as a coating applied to the substrate layer (SL) having a thickness of 25 μm, with the wire embedded antenna scribed therein;
SL Substrate layer having a thickness of ~100 μm (post calendering from an initial thickness of ~220 μm), comprising a substrate layer of nonwoven fabric (aka a fleece layer (FL)) or nonwoven pulp and fiber comprising cellulose and synthetic fibers bonded with a latex binder;
AL Adhesive layer (bottom side) as a coating applied to the substrate layer (SL);
WL Intermediate wood layer (Middle PWL or IWL) comprising a micro thin wood layer (WL) orientated in a horizontal grain (lengthwise) direction having a thickness of 127 μm;
AL Adhesive layer as a coating applied to the top side of the substrate layer (SL) having a thickness of 25 μm;
SL Substrate layer having a thickness of ~100 μm (post calendering from an initial thickness of ~220 μm), comprising a substrate layer of nonwoven fabric (aka a fleece layer (FL)) or nonwoven pulp and fiber comprising cellulose and synthetic fibers bonded with a latex binder; AL Adhesive layer as a coating applied to the underside of the substrate layer (SL);
Note that AL+SL+AL forms the adhesive coated substrate layer (ACSL).
WL Intermediate wood layer (Lower PWL or IWL) comprising a micro thin wood layer (WL) orientated in a vertical grain (crosswise) direction having a thickness of 127 μm;
The prelamination thickness of the 3-ply core subassembly (CS) is approximately 490 μm.

### RS

Rear Single-Ply Wood Veneer Subassembly (RS) bonded together using an Adhesive Layer (AL):
AL Adhesive layer (AL) in the form of thermoplastic or thermoset adhesive film having a thickness of 25 μm;
WL Rear face wood (veneer) layer (PWL) of the rear single-ply subassembly (RS) comprising a micro thin wood veneer (rotary peeled) orientated in a horizontal grain direction (lengthwise) having a thickness of 150 μm;

### ARL

AW Artwork-laser etched graphics in the rotary peeled wood veneer layer (PWL or WL) of the rear subassembly, not shown;
TC Laser engravable topcoat (TC), sprayed on or screen printed, in the form of a water-based self-sealer or UV varnish to protect the underlying laser etched features, not shown;
MS Magnetic stripe (2 or 3 tracks (HiCo)) adhesively attached to or recessed in the rear facing rotary peeled wood veneer layer (PWL) of the rear single-ply subassembly (RS), or the magnetic stripe may be applied and pressed into the topcoat (TC);
LM Laser marking (LM) of personalization data to the topcoat (TC) in the rear rotary peeled wood veneer layer (PWL or WL) of the rear single-ply subassembly (RS);

Security elements (not shown)-signature panel and payment brand hologram.

FIG. 12B: Description and dimensions of the individual layers forming the smartcard (SC) construction.

| Layers | Description | Grain direction | Thickness |
|---|---|---|---|
| ML-FS | Front face metal layer, discontinuous metal | Imitation | 100 μm |
| | layer, such as aluminum, laser etched with a | woodgrain | |
| | decorative design having a gap disguised within | effect | |
| | the graphic elements and a milled-out pocket or | | |
| | a laser cut module opening to accept the | | |
| | placement of a dual interface chip module | | |
| AL-FS | Upper adhesive layer for bonding | | 25 μm |
| MSL-FS | Magnetic shielding layer, optionally 50 or 65 | | 75 μm |
| | μm | | |
| AL-FS | Lower adhesive layer for bonding | | 25 μm |
| WL-CS | Upper intermediate (rotary) peeled wood | Crosswise | 127 μm |
| | (veneer) layer (PWL: Upper Core)-wood | | |
| | species: Birch | | |
| BA-CS | Wire embedded booster antenna circuit (BAC) | | |
| | for inductive coupling, formed in the top | | |
| | adhesive layer coated to the top substrate layer | | |
| | (SL) and completely submerged (bare copper | | |
| | wire Ø 80 μm or Ø 112 μm | | |
| AL-CS | Top upper adhesive layer of the adhesive coated | | 25 μm |
| | substrate layer (ACSL) for bonding, and to | | |
| | accept the ultrasonic scribing of the wire | | |
| | antenna circuit | | |
| SL-CS | Upper substrate layer in the form of a nonwoven | | 100 μm |
| | fabric (aka a fleece layer (FL) or nonwoven pulp | | |
| | and fiber for reinforcement | | |
| AL-CS | Bottom upper adhesive layer of the adhesive | | 25 μm |
| | coated substrate layer (ACSL) for bonding | | |
| WL-CS | Middle intermediate (rotary) peeled wood | Lengthwise | 127 μm |
| | (veneer) layer (PWL: Middle Core)-wood | | |
| | species: Birch | | |
| AL-CS | Top lower adhesive layer of the adhesive coated | | 25 μm |
| | substrate layer (ACSL) for bonding | | |
| SL-CS | Lower substrate layer in the form of a nonwoven | | 100 μm |
| | fabric (aka a fleece layer (FL) or nonwoven pulp | | |
| | and fiber for reinforcement | | |
| AL-CS | Bottom lower Adhesive layer of the adhesive | | 25 μm |
| | coated substrate layer (ACSL) for bonding | | |
| WL-CS | Lower intermediate (rotary) peeled wood | Crosswise | 127 μm |
| | (veneer) layer (PWL: Lower Core)-wood | | |
| | species: Birch | | |
| | Note that the core subassembly may be | | |
| | prelaminated before final lamination of the | | |
| | complete stack-up, having a nominal thickness | | |
| | of 490 μm | | |
| AL-RS | Adhesive layer for bonding | | 25 μm |
| WL-RS | Rear face rotary peeled wood (veneer) layer | Lengthwise | 150 μm |
| | (PWL)-wood species: Birch | | |
| | Total thickness of the prelaminated 3-ply core | | |
| | 0.890 mm | | |
| | subassembly, 3 adhesive layers for interlayer | | |
| | bonding, a magnetic shielding layer, a front face | | |
| | metal layer (DML) and a rear face wood layer | | |
| | after final press lamination of the stack-up: | | |

### Impregnation/Topcoat-Laser Etched Artwork

| Layers | Description | | Thickness |
|---|---|---|---|
| TC | Laser engravable topcoat | Water-based | 10 μm |
| | (TC)-sprayed on/screen | self-sealer/ | |
| | printed | | |
| AW | Laser-etched Artwork | UV varnish | |

### Additional Rear Layers (ARL)

| Layers | Description | | Thickness |
|---|---|---|---|
| AW | Laser-etched Artwork | | |
| TC | Laser engravable topcoat | Water-based | 10 μm |
| | (TC)-sprayed on/screen | self-sealer/ | |
| | printed, for impregnation | UV varnish | |
| | post laser treatment | | |

FIG. 12C shows a timber metal transaction card or smartcard having a front face wood veneer layer adhesively attached to an underlying discontinuous metal layer and a rear face wood veneer layer, sandwiching a core subassembly comprising upper and lower wood veneer layers with adhesive layers for interlayer bonding and a substrate layer for reinforcement (forming a 2-ply wood veneer laminate) with a booster antenna circuit (BAC) incorporated in a top adhesive layer and physically connected to a chip module, wherein the front face wood veneer layer receives graphic elements by mechanically engraving and or laser etching the features to the surface of the discontinuous metal layer, also referred to as knockout to metal.

FIG. 12C: Architecture of a Timber Metal Transaction Card (TMTC) having a Front Face Wood Layer with a Knock-out to an Inner Metal Layer (as design feature), and a Wire Embedded Booster

Antenna Circuit (BAC) incorporated in a 2-ply Wood Veneer Construction forming a Core Subassembly (CS)

The layers and process steps in the stack-up construction of the timber metal transaction card (TMTC/SC):
CM 6 or 8 pin faceplate dual interface chip module (CM) residing in a module opening (MO) with terminals (L_{A} and L_{B}) on its bond side for a physical interconnection (e.g. per TeConnect) to an in-card booster antenna circuit (BAC);
MO Module opening (MO) in the form of a stepped cavity (P₁ and P₂) to accept the insertion or implanting of the dual interface chip module (CM);

### AFL

LM Laser marking of personalization data to a topcoat (TC) applied to the surface of the front face wood (veneer) layer (WL) forming the front subassembly (FS);
TC Laser engravable topcoat (TC), sprayed-on or screen printed, to protect the underlying laser etched or mechanically engraved features;
AW Artwork-laser etched graphics or mechanically engraved features with a knock-out to the inner metal layer (ML);

### FS

Front Subassembly (FS) of a Wood Layer (WL) bonded to an underlying Inner Metal Layer (ML) and an Adhesive Layer (AL) for attachment to the Core Subassembly (CS):
WL Front face wood layer (PWL or WL) of the front subassembly (FS) comprising a micro thin wood veneer (rotary peeled) orientated in a horizontal or vertical grain direction (lengthwise or crosswise) having a thickness of 150 μm;
AL Adhesive layer (AL) in the form of a thermoplastic or thermoset adhesive (dry) film having a thickness of 25 μm;
MF Inner metal layer, such as an aluminum foil, having a gap extending from a peripheral edge of the card body to a laser cut module opening, intended to accept the implanting of a dual interface chip module, having a thickness of 100 μm;
AL Adhesive layer (AL) in the form of a thermoplastic or thermoset adhesive (dry) film having a thickness of 25 μm;

### CS

### Core Wood Veneer Subassembly (CS)

WL Intermediate wood layer (Upper PWL or IWL) of the core subassembly (CS) comprising a micro thin wood veneer (rotary peeled) orientated in a horizontal grain direction (lengthwise) having a thickness of 150 μm;
BA An insulated wire conductor (bare copper wire Ø: 80 or 112 μm) ultrasonically embedded into the top adhesive layer coated to the top substrate layer (SL), in forming a booster antenna circuit (BAC) with a perimeter coil (aka communication coil) and connection pads in the form of wire embedded squiggles or meanders to facilitate the interconnection to the dual interface chip module (CM);
AL Adhesive layer (top side) as a coating applied to the substrate layer (SL) having a thickness of 25 μm, with the wire embedded antenna scribed therein;
SL Substrate layer having a thickness of ~100 μm (post calendering from an initial thickness of ~220 μm), comprising a substrate layer of nonwoven fabric (aka a fleece layer (FL)) or nonwoven pulp and fiber comprising cellulose and synthetic fibers bonded with a latex binder;
AL Adhesive layer (bottom side) as a coating applied to the substrate layer (SL);
WL Intermediate wood layer (Lower PWL or IWL) comprising a micro thin wood layer (WL) orientated in a vertical grain (crosswise) direction having a thickness of 150 μm;
The post lamination thickness of the 2-ply core subassembly (CS) is approximately 335 μm+15 μm (26% compression).

### RS

Rear Single-Ply Wood Veneer Subassembly (RS) bonded together using an Adhesive Layer (AL):
AL Adhesive layer (AL) in the form of thermoplastic or thermoset adhesive (dry) film having a thickness of 25 μm;
WL Rear face wood (veneer) layer (PWL) of the rear single-ply subassembly (RS) comprising a micro thin wood veneer (rotary peeled) orientated in a horizontal grain direction (lengthwise) having a thickness of 150 μm;

### ARL

AW Artwork-laser etched graphics in the rotary peeled wood veneer layer (PWL or WL) of the rear subassembly;
TC Laser engravable topcoat (TC), sprayed on or screen printed, in the form of a water-based self-sealer or UV varnish to protect the underlying laser etched features;
MS Magnetic stripe (2 or 3 tracks (HiCo)) adhesively attached to or recessed in the rear facing rotary peeled wood veneer layer (PWL) of the rear single-ply subassembly (RS), or the magnetic stripe may be applied and pressed into the topcoat (TC);
LM Laser marking (LM) of personalization data to the topcoat (TC) in the rear rotary peeled wood veneer layer (PWL or WL) of the rear single-ply subassembly (RS);

Security elements (not shown)-signature panel and payment brand hologram.

FIG. 12C: Description and dimensions of the individual layers forming the smartcard (SC) construction.

| Layers | Description | Grain direction | Thickness |
|---|---|---|---|
| WL-FS | Front face wood layer comprising of (rotary) | Lengthwise or | 150 μm |
| | peeled wood veneer (PWL: front face)-wood | crosswise | |
| | species: Birch | | |
| AL-FS | Adhesive layer for interlayer bonding | | 25 μm |
| MF-FS | Inner metal layer, such as an aluminum foil | | 100 μm |
| | (ML/DML/MF), having a gap and a laser cut | | |
| | module opening | | |
| AL-FS | Adhesive layer for interlayer bonding | | 25 μm |
| WL-CS | Upper intermediate (rotary) peeled wood | Lengthwise | 150 μm |
| | (veneer) layer (PWL or IWL)-wood species: | | |
| | Birch | | |
| BA-CS | Wire embedded booster antenna circuit (BAC) | | |
| | formed in the top adhesive layer coated to the | | |
| | top substrate layer (SL) and completely | | |
| | submerged (bare copper wire Ø 80 μm or Ø 112 | | |
| | um-Physical connection TeConnect | | |
| AL-CS | Top adhesive layer of the adhesive coated | | 25 μm |
| | substrate layer (ACSL) for bonding, and to | | |
| | accept the ultrasonic scribing of the wire | | |
| | antenna circuit | | |
| SL-CS | Substrate layer in the form of a nonwoven fabric | | 100 μm |
| | (aka a fleece layer (FL) or nonwoven pulp and | | |
| | fiber for reinforcement | | |
| AL-CS | Bottom adhesive layer of the adhesive coated | | 25 μm |
| | substrate layer (ACSL) for bonding | | |
| WL-CS | Lower intermediate (rotary) peeled wood | Crosswise | 150 μm |
| | (veneer) layer (PWL or IWL)-wood species: | | |
| | Birch | | |
| | Note that the core subassembly (450 μm) may | | |
| | be laminated before final lamination of the | | |
| | complete stack-up, having a nominal thickness, | | |
| | post lamination of 335 μm | | |
| AL-RS | Adhesive layer for bonding | | 25 μm |
| WL-RS | Rear face rotary peeled wood (veneer) layer | Lengthwise | 150 μm |
| | (PWL)-wood species: Birch | | |
| | Total thickness of the laminated 2-ply core | | 0.810 mm |
| | subassembly (335 μm), 3 adhesive layers for | | |
| | interlayer boding, a front face wood layer, an | | |
| | inner metal layer or metal foil and a rear face | | |
| | wood layer before final press lamination of the | | |
| | stack-up: | | |

### Impregnation/Topcoat-Laser Etched Artwork

| Layers | Description | | Thickness |
|---|---|---|---|
| TC | Laser engravable topcoat (TC)- | Water-based | 10 μm |
| | sprayed on/screen printed, for | self-sealer/ | |
| | impregnation post laser | UV varnish | |
| | treatment or mechanical | | |
| | engraving | | |
| AW | Laser-etched Artwork | | |

### Additional Rear Layers (ARL)

| Layers | Description | | Thickness |
|---|---|---|---|
| AW | Laser-etched Artwork | | |
| TC | Laser engravable topcoat | Water-based | 10 μm |
| | (TC)-sprayed on/screen | self-sealer/ | |
| | printed, for impregnation | UV varnish | |
| | post laser treatment | | |

FIG. 12D shows a timber metal transaction card (TMTC) or smartcard (SC) having an upper facing continuous metal layer (CML, ML), an adhesive layer (AL), a magnetic shielding layer (MSL) and an adhesive coated substrate layer (ACSL) forming a front subassembly (FS), and an adhesive coated substrate layer (ACSL) and a rear downward facing wood veneer layer (WL) forming a rear subassembly (RS), respectively laminated to a upper and lower surface of a laminated core subassembly (CS) comprising top and bottom wood (veneer) layers (WL) and intermediate adhesive coated substrate layers (ACSL) for bonding and reinforcement (forming a 2-ply wood veneer laminate with 4 interlayers of adhesive and 2 substrate layers), wherein a booster antenna circuit (BAC) for inductive coupling with the module antenna (MA) of a transponder chip module (TCM) is incorporated between the intermediate adhesive coated substrate layers (ACSL) and wherein the antenna circuit is a double-sided aluminum etched antenna on a PET carrier.

FIG. 12D: Architecture of a Timber Metal Transaction Card (TMTC) with a Double-Sided Aluminum Etched Antenna as a Booster Antenna Circuit (BAC) for Inductive Coupling incorporated in a 2-ply Wood Veneer Construction forming a Core Subassembly (CS)

The layers and process steps in the stack-up construction of the timber metal transaction card (TMTC/SC):

TCM 8 pin dual interface chip module with 6 pin positioning to accommodate a larger module antenna (MA) for inductive coupling with an in-card booster antenna circuit, (aka a transponder chip module (TCM) or inductive coupling chip module (ICM)), residing in a module opening (MO);
MA Module antenna with a given number of turns, e.g. 15 windings, for inductive coupling with the coupler coil (CC) of the (aluminum etched) booster antenna circuit (BAC);
MO Module opening (MO) in the form of a stepped cavity (P₁ and P₂) to accept the insertion or implanting of the transponder chip module (TCM);

### AFL

LM Laser marking of personalization data to a varnish applied during digital inkjet printing of the graphic artwork to the upward facing continuous metal layer (CML, ML) forming the front subassembly (FS), not shown;
AW Artwork-digitally deposited UV ink to the front face continuous metal layer (CML, ML) and protected by a topcoat of varnish;

### FS

Front Subassembly (FS) of a Continuous Metal Layer (CML) bonded to the Core Subassembly (CS) using an Adhesive Coated Substrate Layer (ACSL):
ML Front face continuous (aluminum) metal layer (CML) with a milled-out pocket (post lamination) or a laser cut module opening (before lamination of the assembly), and coated on its front surface with a lacquer including color pigments and pre-treatment, and a primer applied to its reverse side for enhanced adhesion, having a thickness of 100 μm;
AL Adhesive layer (AL) in the form of a thermoplastic or thermoset adhesive film having a thickness of 25 μm;
MSL Magnetic shielding layer (MSL: 50, 65 or 75 μm) to offset the attenuation effect of the front face continuous metal layer (CML, ML) with an opening to accommodate the transponder chip module;
ACSL Adhesive coated substrate layer (ACSL) in the form of a nonwoven substrate coated on both sides with thermoplastic adhesive (PVAc) having an initial thickness of 150 μm;

### CS

### Core Wood Veneer Subassembly (CS)

WL Top wood layer (PWL or WL) of the core subassembly (CS) comprising a micro thin wood veneer (rotary peeled) orientated in a vertical grain direction (crosswise) having a thickness of 150 μm;
AL Adhesive layer as a coating applied to the top side of the substrate layer (SL) having a thickness of 25 μm;
SL Substrate layer having a thickness of ~100 μm (post calendering from an initial thickness of ~220 μm), comprising a substrate layer of nonwoven fabric (aka a fleece layer (FL)) or nonwoven pulp and fiber comprising cellulose and synthetic fibers bonded with a latex binder;
AL Adhesive layer as a coating applied to the underside of the substrate layer (SL);
BAC Booster antenna circuit in the form of a double-sided aluminum etched antenna on a PET carrier having a thickness of 45 μm;
AL Adhesive layer as a coating applied to the top side of the substrate layer (SL) having a thickness of 25 μm;
SL Substrate layer having a thickness of ~100 μm post calendering from an initial thickness of ~220 μm), comprising a carrier or substrate of nonwoven fleece (aka a fleece layer (FL)) or nonwoven pulp and fiber comprising cellulose and synthetic fibers bonded with a latex binder;
AL Adhesive layer as a coating applied to the underside of the substrate layer (SL);
Note that AL+SL+AL forms the adhesive coated substrate layer (ACSL) and may also be referred to as a reinforcement layer (RL).
WL Bottom wood layer (PWL or WL) comprising a micro thin wood layer (WL) orientated in a vertical grain (crosswise) direction having a thickness of 150 μm;
The thickness before press lamination of the 2-ply core subassembly (CS) is approximately 645 μm.

### RS

Rear Single-Ply Wood Veneer Subassembly (RS) bonded together using an Adhesive Coated Substrate Layer (ACSL):
ACSL Adhesive coated substrate layer (ACSL) in the form of a nonwoven substrate coated on both sides with thermoplastic adhesive having an initial thickness of 150 μm;
WL Rear face wood (veneer) layer (PWL, WL) of the rear single-ply subassembly (RS) comprising a micro thin wood veneer (rotary peeled) orientated in a horizontal grain direction (lengthwise) having a thickness of 150 μm;

### ARL

AW Artwork-digitally deposited ink onto the rotary peeled wood veneer layer (PWL or WL) of the rear subassembly (RS), a white channel (undercoat) may be applied to the wood veneer surface to enhance the color of the digitally deposited CYMK ink (over-print) followed by a topcoat of matt varnish, not shown;
TC Laser engravable topcoat (TC) of matt or gloss varnish, applied during digital printing to protect the graphic artwork, not shown;
MS Magnetic stripe (2 or 3 tracks (HiCo)) adhesively attached to the rear facing rotary peeled wood veneer layer (PWL) of the rear single-ply subassembly (RS);
LM Laser marking (LM) of personalization data to the topcoat (TC) in the rear rotary peeled wood veneer layer (PWL or WL) of the rear single-ply subassembly (RS);

Security elements (not shown)-signature panel and payment brand hologram.

FIG. 12D: Description and dimensions of the individual layers forming the smartcard (SC) construction.

| Layers | Description | Grain direction | Thickness |
|---|---|---|---|
| ML-FS | Front face continuous metal layer, such as | | 100 μm |
| | aluminum foil (metal foil) with a surface finish | | |
| | (e.g. a natural tone, gold, champagne, copper, | | |
| | bronze, stainless steel or anthracite), having a | | |
| | milled-out pocket or a laser cut module opening | | |
| | to accept the placement of a dual interface chip | | |
| | module | | |
| AL-FS | Adhesive layer for bonding | | 25 μm |
| MSL-FS | Magnetic shielding layer with an opening to | | 75 μm |
| | accommodate the dual interface chip module | | |
| ACSL-FS | Adhesive coated substrate layer for bonding and | | 150 μm |
| | reinforcement | | |
| WL-CS | Top (rotary) peeled wood (veneer) layer | Crosswise | 150 μm |
| | (PWL)-wood species: Birch | | |
| AL-CS | Adhesive layer of the adhesive coated substrate | | 25 μm |
| | layer (ACSL) for bonding | | |
| SL-CS | Substrate layer in the form of a nonwoven fabric | | 100 μm |
| | (aka a fleece layer (FL) or nonwoven pulp and | | |
| | fiber for reinforcement | | |
| AL-CS | Adhesive layer of the adhesive coated substrate | | 25 μm |
| | layer (ACSL) for bonding | | |
| BAC-CS | Booster antenna circuit in the form of a double- | | 45 μm |
| | sided aluminum etched antenna on a PET carrier | | |
| AL-CS | Adhesive layer of the adhesive coated substrate | | 25 μm |
| | layer (ACSL) for bonding | | |
| SL-CS | Substrate layer in the form of a nonwoven fabric | | 100 μm |
| | (aka a fleece layer (FL) or nonwoven pulp and | | |
| | fiber for reinforcement | | |
| AL-CS | Adhesive layer of the adhesive coated substrate | | 25 μm |
| | layer (ACSL) for bonding | | |
| WL-CS | Bottom (rotary) peeled wood (veneer) layer | Crosswise | 150 μm |
| | (PWL: Lower Core)-wood species: Birch | | |
| | Note that the core subassembly may be | | |
| | prelaminated before final lamination of the | | |
| | complete stack-up, having a nominal thickness | | |
| | of 420 μm, with a 35% shrinkage from the initial | | |
| | thickness of 645 μm. | | |
| ACSL-RS | Adhesive coated substrate layer for bonding and | | 150 μm |
| | reinforcement | | |
| WL-RS | Rear face rotary peeled wood (veneer) layer | Lengthwise | 150 μm |
| | (PWL)-wood species: Birch | | |
| | Total thickness of the prelaminated 2-ply core | Post | 836 μm |
| | subassembly, an adhesive layer, 2 adhesive | Lamination | |
| | coated substrate layers for interlayer bonding | of the Final | |
| | and reinforcement, a magnetic shielding layer, a | Assembly | |
| | front face metal layer or foil and a rear face | | |
| | wood layer before final press lamination of the | | |
| | stack-up: 1.07 mm | | |

### Topcoat-Digital Inkjet Printed Artwork

| Layers | Description | | Thickness |
|---|---|---|---|
| TC | Laser engravable topcoat (TC)- | Varnish | 10 μm |
| | digitally deposited | | |
| AW | DoD Digital Printing | | |

### Additional Rear Layers (ARL)

| Layers | Description | | Thickness |
|---|---|---|---|
| AW | DoD Digital Printing-underprint | | |
| | (white channel) and overprint | | |
| | (CYMK) | | |
| TC | Laser engravable topcoat (TC)- | Varnish | 10 μm |
| | digitally deposited | | |

### Some Additional References

U.S. Pat. No. 6,233,818 (22 May 2001; AmaTech; Finn et al.), entitled “Method And Device For Bonding A Wire Conductor”, incorporated by reference herein, discloses a process and device for the contacting of a wire conductor (113) in the course of the manufacture of a transponder unit arranged on a substrate (111) and comprising a wire coil (112) and a chip unit (115), wherein in a first phase the wire conductor (113) is guided away via the terminal area (118, 119) or a region accepting the terminal area and is fixed on the substrate (111) relative to the terminal area (118, 119) or the region assigned to the terminal area, and in a second phase the connection of the wire conductor (113) to the terminal area (118,119) is effected by means of a connecting instrument (125).

US 2013/0126622 (23 May 2013; AmaTech; Finn), entitled “Offsetting Shielding and Enhancing Coupling in Metallized Smart Cards”, incorporated by reference herein, discloses a dual-interface smart card having a booster antenna with coupler coil in its card body, and a metallized face plate having a window opening for the antenna module. Performance may be improved by one or more of making the window opening substantially larger than the antenna module, providing perforations through the face plate, disposing ferrite material between the face plate and the booster antenna. Additionally, by one or more of modifying contact pads on the antenna module, disposing a compensating loop under the booster antenna, offsetting the antenna module with respect to the coupler coil, arranging the booster antenna as a quasi-dipole, providing the module antenna with capacitive stubs, and disposing a ferrite element in the antenna module between the module antenna and the contact pads.

U.S. Pat. No. 9,033,250 (19 May 2019; AmaTech; Finn et al.), entitled “Dual Interface Smart Cards, And Methods of Manufacturing”, incorporated by reference herein, discloses a booster antenna (BA) for a smart card comprises a card antenna (CA) component extending around a periphery of a card body (CB), a coupler coil (CC) component at a location for an antenna module (AM), and an extension antenna (EA) contributing to the inductance of the booster antenna (BA). A method of wire embedding is also disclosed, by controlling a force and ultrasonic power applied by an embedding tool at different positions on the card body (CB).

U.S. Pat. No. 10,289,944 (14 May 2019; CompoSecure; Herslow et al.), entitled “Metal Smart Card With Dual Interface Capability”, incorporated by reference herein, discloses a dual interface smart card having a metal layer includes an SC module, with contacts and RF capability, mounted on a plug, formed of non RF impeding material, between the top and bottom surfaces of the metal layer. The plug provides support for the IC module and a degree of electrical insulation and isolation from the metal layer. The resultant card can have contact and contactless operating capability and an entirely smooth external metal surface except for the contacts of the IC module. Reference is also made to EP 3138049 B1.

U.S. Pat. No. 11,501,128 (15 Nov. 2022; CompoSecure; Lowe et al.), entitled “Transaction card with embedded electronic components and process for manufacture” incorporated by reference herein, discloses a transaction card. The transaction card includes a non-plastic layer, one or more embedded electronics, a fill layer, and one or more additional layers. The non-plastic layer has first and second faces and a thickness therebetween, and at least a first opening in the first face. The one or more embedded electronic components are disposed in or adjacent the first opening. The fill layer is in contact with the embedded electronic components, disposed in portions of the first opening not occupied by the embedded electronics. The one or more additional layers are disposed over the fill layer.

US 2023/0086189 (23 Mar. 2023; Metaland; Finn et al.), entitled “Encapsulating a metal inlay with thermosetting resin and method for making a metal transaction card”, incorporated by reference herein, discloses metal layers (650, 730, 750, 830, 850) of a smartcard (SC, 600, 700, 800) have module openings (614, 712, 714, 812, 814) for receiving a transponder chip module (TCM). Thermosetting resin (TR, 668B, 768A, 768B, 868A, 868B) coats (encapsulates) the bottom surfaces and fills the module openings of the metal layers. A first metal layer (650, 750, 850) may have a slit (S; 620, 720B, 820) which may also be filled by the thermosetting resin. A second metal layer (ML, 730) disposed above the first metal layer (750) may have a slit (S, 720A) which may also be filled by the thermosetting resin. A booster antenna circuit (BAC, 844) may be disposed between the first and second metal layers, with magnetic shielding material (842) disposed between the booster antenna circuit and the second metal layer (730). Reference is also made to WO 2023/034642.

U.S. Pat. No. 11,948,036 (2 Apr. 2024; Metaland; Finn et al.), entitled “RFID Enabled Metal Transaction Cards”, incorporated by reference herein, discloses a transaction card (smartcard) having a front “continuous” or non-continuous metal layer (ML, CML, DML) with a module opening (MO) for a dual-interface transponder chip module (TCM). Coating polyurethane resin may be used to replace (in lieu of) adhesive film layers and plastic slugs, and to fill module openings, cut-outs and voids in a metal transaction card. The amplifying element (BAC) and magnetic shielding layer may be encapsulated in a polyurethane resin. The resin may further fill and seal the module opening in the front face continuous metal layer and any voids or recesses in subsequent layers. The resin may fill and seal any discontinuity or opening in the rear discontinuous metal layer. The dual interface chip module may be implanted in a milled-out cavity in the polyurethane resin. Removed metal sections may also be encased in polyurethane resin.

Dimensions Associated with a 6-Pin Chip Module Package (Wire Bonded)
Module Outline (6 pin): 11.0 mm×8.3 mm, R=(1.2)-1.4 mm
Module Opening (6 pin) (P₁): 11.2 mm×8.5 mm, R=1.3 mm
Chip Encapsulation Area (6 pin): 6.1×7.0 mm max.
Module Opening (6 pin) (P₂): 6.4×8.5 mm, R=1.25 mm
Module Tape Thickness (6 pin): 170 μm
Total Thickness of Chip Package (6 pin): 620 μm max
   Dimensions Associated with a 8-Pin Chip Module Package (Wire Bonded)
Module Outline (8 pin): 13.0×11.8 mm, R=2.2 mm
Module Opening (8 pin) (P₁): 13.2 mm×12.0 mm, R=2.3 mm
Chip Encapsulation Area (8 pin): 7.1×6.6 mm max.
Module Opening (8 pin) (P₂): 9.8×8.8 mm, R=2.2 mm
Module Tape Thickness (8 pin): 170 μm
Total Thickness of Chip Package (8 pin): 600 μm max
The chip module mounting tape for both chip packages may have a thickness of 30-40 μm.

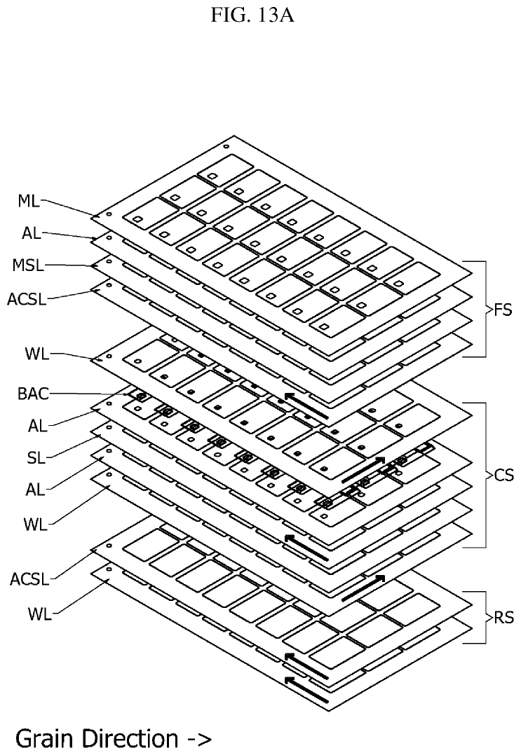

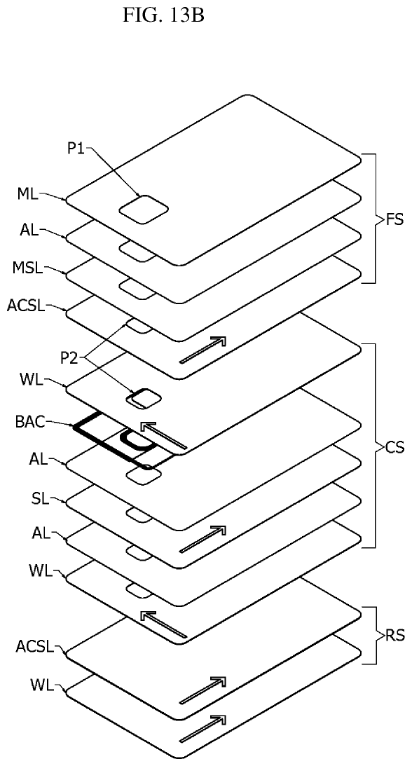

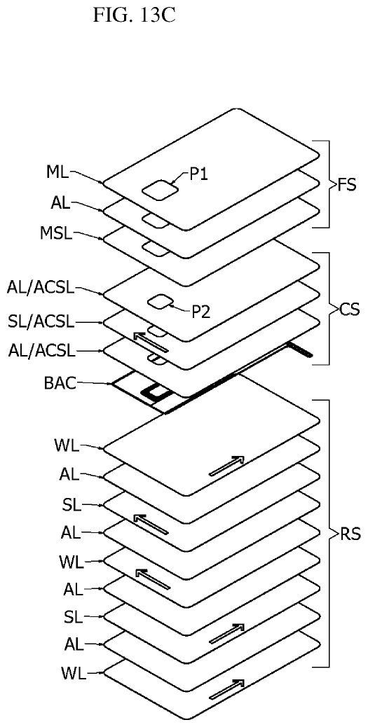

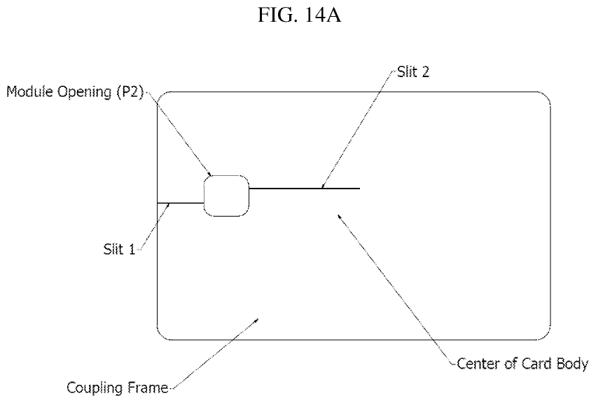

FIG. 13A shows a laminated sheet assembly (LSA; stack-up, construction) in a 3×8 format having a plurality of card body sites (SCB) for production of a like plurality of smart cards, said laminated sheet having a front (top) exposed surface and a rear (bottom) exposed surface, said laminated sheet assembly comprising a front face continuous metal layer or metal foil, 1 adhesive layer, 3 wood veneer layers and 3 adhesive coated substrate layers for bonding and reinforcement.

The alternative approach of manufacturing RFID enabled timber metal transaction cards without a slit or gap having contactless functionality from the rear face (one side tap-to-pay) of the card body requires a booster antenna circuit physically connected or inductively coupled to the dual interface chip module with a magnetic shielding layer (ferrite or non-ferrite based material) to offset the detuning and magnetic flux absorption caused by the continuous metal layer in the card body.

FIG. 13A: Description and dimensions of the individual layers of the laminated sheet assembly (LSA) comprising a front face metal layer (CML, ML, MF), an adhesive layer (AL), a magnetic shielding layer (MSL), 3 wood veneer layers (WL) and 3 adhesive coated substrate layers (ACSL).

| Layers | Description | Grain direction | Thickness |
|---|---|---|---|
| ML-FS | Front face metal sheet of aluminum, as a | | 100 μm |
| | continuous metal layer or metal foil, having a | | |
| | laser cut module opening at each card body site | | |
| | in the 3 x 8 array | | |
| AL-FS | Sheet of thermosetting adhesive film (dry) | | 25 μm |
| MSL-FS | Sheet of magnetic shielding (ferrite or non- | | 75 μm |
| | ferrite material) with a module opening (void) at | | |
| | each card body site | | |
| ACSL-FS | Sheet for bonding and reinforcement in the form | Lengthwise | 150 μm |
| | of an adhesive coated substrate layer | | |
| WL-CS | Upper sheet of rotary peeled wood (veneer), | Crosswise | 150 μm |
| | optionally a sheet of sliced wood veneer of a | | |
| | certain thickness | | |
| BAC-CS | At each card body site in the 3 x 8 array, a wire | | |
| | embedded booster antenna circuit (BAC) | | |
| | formed in the top adhesive layer coated to the | | |
| | substrate layer (SL) and completely submerged | | |
| | (bare copper wire Ø 80 μm, for inductive | | |
| | coupling with the module antenna (MA) of the | | |
| | transponder chip module (TCM) | | |
| AL-CS | Top adhesive layer of the adhesive coated | | 25 μm |
| | substrate layer (ACSL) for bonding | | |
| SL-CS | Substrate layer in the form of a sheet of | Lengthwise | 100 μm |
| | nonwoven fabric for reinforcement | | |
| AL-CS | Bottom adhesive layer of the adhesive coated | | 25 μm |
| | substrate layer (ACSL) for bonding | | |
| WL-CS | Lower sheet of rotary peeled wood (veneer), | Crosswise | 150 μm |
| | optionally a sheet of sliced wood veneer of a | | |
| | certain thickness | | |

Note the array of booster antenna circuits (BAC) may be integrated into the adhesive coated substrate layer (ACSL) of the front subassembly (FS) instead of the core subassembly (CS).

| Layers | Description | Grain direction | Thickness |
|---|---|---|---|
| ACSL-RS | Sheet for bonding and reinforcement in the form | Lengthwise | 150 μm |
| | of an adhesive coated substrate layer | | |
| WL-RS | Rear face sheet of rotary peeled wood (veneer), | Lengthwise | 150 μm |
| | optionally a sheet of sliced wood veneer of a | | |
| | certain thickness | | |
| | Total thickness of the prelaminated 2-ply core | Post Lamination | 800 μm |
| | subassembly, an adhesive layer, 2 adhesive | of the Final | |
| | coated substrate layers for interlayer bonding | Assembly | |
| | and reinforcement, a magnetic shielding layer, a | | |
| | front face metal layer or foil and a rear face | | |
| | wood layer before final press lamination of the | | |
| | stack-up: 1.100 mm | | |

FIG. 13B shows a timber metal transaction card (TMTC) or smartcard (SC) having a front face continuous metal layer or metal foil (CML, ML, MF) with a laser cut module opening (MO), an adhesive layer (AL), a magnetic shielding layer (MSL) and an adhesive coated substrate layer (ACSL) forming a front subassembly (FS), and an adhesive coated substrate layer (ACSL) and a rear downward facing wood veneer layer (WL) forming a rear subassembly (RS), respectively laminated to a upper and lower surface of a laminated core subassembly (CS) comprising top and bottom wood (veneer) layers (WL) and an intermediate adhesive coated substrate layer (ACSL) for bonding and reinforcement (forming a 2-ply wood veneer laminate with 2 interlayers of adhesive and 1 substrate layer), wherein a booster antenna circuit (BAC) for inductive coupling with the module antenna (MA) of a transponder chip module (TCM) is incorporated into an adhesive layer (AL) of the adhesive coated substrate layer (ACSL) and wherein the booster antenna (BA) is a wire embedded antenna circuit with a perimeter coil, coupler coil and extension coil.

FIG. 13B: Architecture of a Timber Metal Transaction Card (TMTC) with a Wire Embedded Booster Antenna Circuit (BAC) for Inductive Coupling incorporated in a 2-ply Wood Veneer Construction forming a Core Subassembly (CS)

The layers and process steps in the stack-up construction of the timber metal transaction card (TMTC/SC):
TCM 8 pin dual interface chip module with 6 pin positioning to accommodate a larger module antenna (MA) for inductive coupling with an in-card booster antenna circuit, (aka a transponder chip module (TCM) or inductive coupling chip module (ICM)), residing in a module opening (MO);
MA Module antenna with a given number of turns, e.g. 15 windings, for inductive coupling with the coupler coil (CC) of the wire embedded booster antenna circuit (BAC);
MO Module opening (MO) in the form of a stepped cavity (P₁ and P₂) to accept the insertion or implanting of the transponder chip module (TCM);
Note the module tape has a thickness of 170 μm, and the dimensions of the P₁ module opening (8 pin package) is 13.2 mm×12.0 mm, R=2.3 mm, while the P₂ module opening is 9.8×8.8 mm, R=2.2 mm.

### AFL

LM Laser marking of personalization data to a varnish applied during digital inkjet printing of the graphic artwork to the upward facing continuous metal layer (CML, ML, MF) forming the front subassembly (FS), not shown;
AW Artwork-digitally deposited UV ink to the front face continuous metal layer (CML, ML, MF) and protected by a topcoat of varnish;
IL Impregnation layer in the form of a primer (an adhesion promoter) applied digitally before the deposition of ink or by way of silk screen printing;

### FS

Front Subassembly (FS) of a Continuous Metal Layer (CML) bonded to the Core Subassembly (CS) using an Adhesive Coated Substrate Layer (ACSL):
ML Front face continuous (aluminum) metal layer or metal foil (CML, MF) with a milled-out pocket (post lamination) or a P₁ laser cut module opening (before lamination of the assembly), and coated on its front surface with a lacquer including color pigments and pre-treatment, and a primer applied to its reverse side for enhanced adhesion, having a thickness of 100 μm;
AL Adhesive layer (AL) in the form of a thermoplastic or thermoset adhesive film having a thickness of 25 μm, having a P₁ module opening;
MSL Magnetic shielding layer (MSL: 50, 65 or 75 μm) to offset the attenuation effect of the front face continuous metal layer (CML, ML, MF) with a P₁ opening (void) to accommodate the transponder chip module, whereby the void may be filled with a resin or a composite before lamination of the assembly;
ACSL Adhesive coated substrate layer (ACSL) or Reinforcement Layer (RL) in the form of a nonwoven fabric (fleece layer) coated on both sides with thermoplastic adhesive (PVAc) having an initial thickness of 150 μm-Fleece direction: horizontal/lengthwise;
Note the combined thickness of the metal layer (ML), adhesive layer (AL) and the magnetic shielding layer (MSL) corresponds approximately to the thickness of the module tape (170 μm) plus mounting tape (30-40 μm), and may be laminated together to form a subassembly prior to the final step of laminating the complete assembly.

### CS

### Core Wood Veneer Subassembly (CS)

WL Upper wood layer (PWL or WL) of the core subassembly (CS) comprising a micro thin wood veneer (rotary peeled) orientated in a vertical grain direction (crosswise) having a thickness of 150 μm;
BAC Booster antenna (BA) or booster antenna circuit (BAC) formed in the top adhesive layer of the intermediate adhesive coated substrate layer (ACSL) or directly on the underside of the top wooden layer (WL) coated with an adhesive, by ultrasonically embedding or scribing an insulated copper wire conductor (Ø: 80 μm) therein;
AL Adhesive layer as a coating applied to the top side of the substrate layer (SL) having a thickness of 25 μm;
SL Substrate layer having a thickness of ~100 μm (post calendering from an initial thickness of ~220 μm), comprising a substrate layer of nonwoven fabric (aka a fleece layer (FL)) or nonwoven pulp and fiber further comprising cellulose and synthetic fibers bonded with a latex binder-fleece direction: horizontal/lengthwise;
AL Adhesive layer as a coating applied to the underside of the substrate layer (SL);
WL Lower wood layer (PWL or WL) comprising a micro thin wood layer (WL) orientated in a vertical grain (crosswise) direction having a thickness of 150 μm;
Note that AL+SL+AL forms the adhesive coated substrate layer (ACSL) and may also be referred to as a reinforcement layer (RL).
The thickness before press lamination of the 2-ply core subassembly (CS) is approximately 450 μm.
The 2-ply core subassembly (CS) with the wire embedded booster antenna circuit (BAC) integrated into the adhesive layer (AL) of the adhesive coated substrate layer (ACSL) may be laminated at a (medium) pressure in the range of 150-200 N/cm² and at a temperature of 140° C. for a dwell time of 6 minutes.
The post lamination of the core subassembly (CS) with two layers of wood veneer (2-ply construction) may have a thickness of 335 μm+15 μm (26% compression).

### RS

Rear Single-Ply Wood Veneer Subassembly (RS) bonded together using an Adhesive Coated Substrate Layer (ACSL):
ACSL Adhesive coated substrate layer (ACSL) in the form of a nonwoven substrate coated on both sides with thermoplastic adhesive having an initial thickness of 150 μm-fleece direction: horizontal/lengthwise;
WL Rear face wood (veneer) layer (PWL, WL) of the rear single-ply subassembly (RS) comprising a micro thin wood veneer (rotary peeled) orientated in a horizontal grain direction (lengthwise) having a thickness of 150 μm;

### ARL

IL Impregnation layer in the form of a primer (an adhesion promoter) applied digitally before the deposition of ink or by way of silk screen printing;
AW Artwork-digitally deposited ink onto the rotary peeled wood veneer layer (PWL or WL) of the rear subassembly (RS), a white channel (undercoat) may be applied to the wood veneer surface to enhance the color of the digitally deposited CYMK ink (over-print) followed by a topcoat of matt varnish, not shown;
TC Laser engravable topcoat (TC) of matt or gloss varnish, applied during digital printing to protect the graphic artwork, not shown;
MS Magnetic stripe (2 or 3 tracks (HiCo)) adhesively attached to the rear facing rotary peeled wood veneer layer (PWL) of the rear single-ply subassembly (RS);
LM Laser marking (LM) of personalization data to the topcoat (TC) in the rear rotary peeled wood veneer layer (PWL or WL) of the rear single-ply subassembly (RS);

Security elements (not shown)-signature panel and payment brand hologram.

The primer may be applied digitally or by screen printing using a defined mesh (th/cm) to apply a solvent-based screen printing ink (adhesive) in one pass with a thickness of approximately 5 μm (post drying and absorption of the solvent in the pores of the wood veneer). The primer functions as an adhesion promoter, a sealant and as an impregnation layer. Artwork may be digitally deposited on the primed surface, resulting in CMYK ink thickness of approximately 15 μm. Post digital printing, a topcoat of matt or gloss varnish may be applied by way of screen printing to protect the underlying graphics from scratches. The varnish may be a UV based thermo-adhesive, with a post curing thickness of approximately 7 μm (depending on the mesh size and number of passes). The total thickness of the impregnation layer, printed ink and varnish may be ~27 μm on each side of the card body. The varnish also facilitates the application of the magnetic stripe and the hot stamping of security elements, such as a holographic foil or signature panel. The varnish may be laser engravable.

The surface roughness of the exposed wood veneer layers (front and rear faces) in a laminated sheet assembly has an Ra value of approximately 5 μm. By screen printing a UV varnish to the exposed surface, the surface roughness drops to 2 μm.

FIG. 13B: Description and dimensions of the individual layers forming the smartcard (SC) construction

| Layers | Description | Grain direction | Thickness |
|---|---|---|---|
| ML-FS | Front face continuous metal layer, such as an | | 100 μm |
| | aluminum foil (metal foil) with a surface finish | | |
| | (e.g. a natural tone, gold, champagne, copper, | | |
| | bronze, stainless steel or anthracite), having a | | |
| | milled-out pocket or a laser cut module opening | | |
| | to accept the later placement of a dual interface | | |
| | chip module | | |
| AL-FS | Adhesive layer for bonding | | 25 μm |
| MSL-FS | Magnetic shielding layer with an opening (void) | | 75 μm |
| | to accommodate the dual interface chip module | | |
| ACSL-FS | Adhesive coated substrate layer for bonding and | Lengthwise | 150 μm |
| | reinforcement | | |
| WL-CS | Upper (rotary) peeled wood (veneer) layer | Crosswise | 150 μm |
| | (PWL)-wood species: Birch | | |
| BAC-CS | Wire embedded booster antenna circuit (BAC) | | |
| | formed in the top adhesive layer coated to the | | |
| | substrate layer (SL) and completely submerged | | |
| | (bare copper wire Ø 80 μm, for inductive | | |
| | coupling | | |
| AL-CS | Top adhesive layer of the adhesive coated | | 25 μm |
| | substrate layer (ACSL) for bonding | | |
| SL-CS | Substrate layer in the form of a nonwoven fabric | Lengthwise | 100 μm |
| | (aka a fleece layer (FL) or nonwoven pulp and | | |
| | fiber for reinforcement | | |
| AL-CS | Bottom adhesive layer of the adhesive coated | | 25 μm |
| | substrate layer (ACSL) for bonding | | |
| WL-CS | Lower (rotary) peeled wood (veneer) layer | Crosswise | 150 μm |
| | (PWL: Lower Core)-wood species: Birch | | |

Note that the booster antenna (BA) or booster antenna circuit (BAC) may be integrated into the adhesive coated substrate layer (ACSL) of the front subassembly (FS) instead of the core subassembly (CS).

| Layers | Description | Grain direction | Thickness |
|---|---|---|---|
| ACSL-RS | Adhesive coated substrate layer for bonding | Lengthwise | 150 μm |
| | and reinforcement | | |
| WL-RS | Rear face rotary peeled wood (veneer) layer | Lengthwise | 150 μm |
| | (PWL)-wood species: Birch | | |
| | Total thickness of the prelaminated 2-ply core | Post Lamination | 800 μm |
| | subassembly, an adhesive layer, 2 adhesive | of the Final | |
| | coated substrate layers for interlayer bonding | Assembly | |
| | and reinforcement, a magnetic shielding layer, | | |
| | a front face metal layer or foil and a rear face | | |
| | wood layer before final press lamination of the | | |
| | stack-up: 1.100 mm | | |

### Topcoat-Digital Inkjet Printed Artwork

| Layers | Description | | Thickness |
|---|---|---|---|
| TC | Laser engravable topcoat (TC)- | Varnish | 10 μm |
| | digitally deposited | | |
| AW | DoD Digital Printing | | |
| IL | Deposition of a primer absorbed | | |
| | by the wood veneer | | |

### Additional Rear Layers (ARL)

| Layers | Description | | Thickness |
|---|---|---|---|
| IL | Deposition of a primer absorbed | | |
| | by the wood veneer | | |
| | (white channel) and overprint | | |
| | (CYMK) | | |
| TC | Laser engravable topcoat (TC)- | Varnish | 10 μm |
| | digitally deposited | | |

Note the complete stack-up may be laminated in a single step using a (high) pressure between 200 N/cm² and 850 N/cm² at a temperature between 135° C. and 150° C. for a dwell time between 30 and 50 minutes followed by a cooling cycle to ambient pressure and temperature, depending on the thickness and type of wood species in the stack-up construction of the assembly.

FIG. 13C shows a timber metal transaction card (TMTC) or smartcard (SC) having a front face continuous metal layer or metal foil (CML, ML, MF) with a laser cut module opening (MO), an adhesive layer (AL) with a module opening (MO), a magnetic shielding layer (MSL) with a module opening (MO) forming a front subassembly (FS) and a rear subassembly (RS) comprising three wood veneer layers (WL), upper, middle and lower, bonded between reinforcement layers of an adhesive coated substrate (ACSL) forming a 3-ply wood veneer laminate with 4 interlayers of adhesive and 2 substrate layers, with said front subassembly (FS) and rear subassembly (RS) laminated to an upper and lower surface of a (prepressed) core subassembly (CS) comprising an adhesive coated substrate layer (ACSL), wherein a booster antenna circuit (BAC) for inductive coupling with the module antenna (MA) of a transponder chip module (TCM) is incorporated into the bottom adhesive layer (AL) of the core adhesive coated substrate layer (ACSL) and wherein the booster antenna (BA) is a wire embedded antenna circuit with a perimeter coil, coupler coil and extension coil.

FIG. 13C: Description and dimensions of the individual layers forming the smartcard (SC) construction

| Layers | Description | Grain direction | Thickness |
|---|---|---|---|
| ML-FS | Front face continuous metal layer, such as an | | 100 μm |
| | aluminum foil (metal foil) with a surface finish (e.g. a | | |
| | natural tone, gold, champagne, copper, bronze, | | |
| | stainless steel or anthracite), having a laser cut module | | |
| | opening (module opening (P1): 13.2 mm x 12.0 mm, | | |
| | R = 2.3 mm) to accept the later placement of an 8-pin | | |
| | dual interface chip module (CM, TCM) | | |
| AL-FS | Adhesive layer (free standing dry film thermosetting | | 25 μm |
| | adhesive) for bonding the metal layer (ML) to the | | |
| | underlying magnetic shielding layer (MSL) | | |
| MSL-FS | Magnetic shielding layer with a void (module opening | | 75 μm |
| | (P1): 13.2 mm x 12.0 mm, R = 2.3 mm) to | | |
| | accommodate the 8-pin dual interface chip module | | |
| | (CM, TCM) | | |
| | The front subassembly (FS) with a P1 module opening | | |
| | (MO) in all layers, comprising the continuous metal | | |
| | layer (CML, ML, MF: 100 μm), the adhesive layer | | |
| | (AL: 25 μm) and the magnetic shielding layer (MSL: | | |
| | 50, 65 or 75um) laminated together, having a post | | |
| | lamination thickness of ~200 μm matching the | | |
| | thickness of the module tape (MT) of the 8-pin dual | | |
| | interface chip module (CM, TCM) with contact pads | | |
| | (CP) on the face-up side, including the chip module | | |
| | mounting tape 30-40 μm (compressed during chip | | |
| | embedding) | | |
| AL/ | Top adhesive layer (AL) of the core adhesive coated | | 25 μm |
| ACLS-CS | substrate layer (ACSL) for bonding to the underside | | |
| | of the magnetic shielding layer (MSL) | | |
| SL/ | Substrate layer in the form of a nonwoven fabric for | Crosswise | 100 μm |
| ACLS-CS | reinforcement and for spacing the booster antenna | | |
| | circuit off the magnetic shielding layer MSL) for | | |
| | optimum RF performance | | |
| AL/ | Bottom adhesive layer of the adhesive coated | | 25 μm |
| ACLS-CS | substrate layer (ACSL) for bonding to the upper wood | | |
| | veneer layer (WL) of the rear subassembly (RS) | | |
| BAC-CS | Wire embedded booster antenna circuit (BAC) for | | |
| | inductive coupling formed in the bottom adhesive | | |
| | layer coated to the underside of the substrate layer | | |
| | (SL) and completely submerged therein (bare copper | | |
| | wire Ø: 80 μm) | | |
| | The adhesive coated substrate layer (ACSL) forming | | |
| | the core subassembly (CS) is provided with an | | |
| | opening in all layers (module opening (P2): 9.8 x 8.8 | | |
| | mm, R = 2.2 mm to accommodate the mold mass or | | |
| | encapsulation on the bond side of the 8-pin dual | | |
| | interface chip module (CM, TCM); The substrate | | |
| | layer (SL) of nonwoven fabric with a thickness of 100 | | |
| | um may be replaced by a hydroentanglement | | |
| | nonwoven, a glass fiber nonwoven or a hybrid | | |
| | nonwoven of glass fiber and fleece with a certain | | |
| | thickness to enhance the P2 mechanical support for | | |
| | the chip module (CM, TCM) | | |
| WL-RS | Upper wood (veneer) layer (WL) | Lengthwise | 150 μm |
| AL-RS | Adhesive layer (AL) of the upper adhesive | | 25 μm |
| | coated substrate layer (ACSL) for interlayer | | |
| | bonding | | |
| SL-RS | Substrate layer (SL) in the form of a nonwoven | Crosswise | 100 μm |
| | fabric for reinforcement | | |
| AL-RS | Adhesive layer (AL) of the upper adhesive | | 25 μm |
| | coated substrate layer (ACSL) for bonding | | |
| WL-RS | Middle intermediate wood (veneer) layer (ML) | Crosswise | 150 μm |
| AL-RS | Adhesive layer (AL) of the lower adhesive | | 25 μm |
| | coated substrate layer (ACSL) for interlayer | | |
| | bonding | | |
| SL-RS | Substrate layer (SL) in the form of a nonwoven | Lengthwise | 100 μm |
| | fabric for reinforcement | | |
| AL-RS | Adhesive layer (AL) of the lower adhesive | | 25 μm |
| | coated substrate layer (ACSL) for bonding | | |
| WL-RS | Lower wood (veneer) layer (ML) | Lengthwise | 150 μm |
| | The rear subassembly (RS) comprising three | | |
| | layers of wood veneer (WL) and two adhesive | | |
| | coated substrate layers (ACSL) with an overall | | |
| | thickness of 750 μm may be laminated together | | |
| | before final lamination of the complete | | |
| | assembly. | | |
| | The front subassembly (FS) comprising a front | Lamination of | 760-800 |
| | face continuous metal layer (CM, ML, MF: 100 | the Final | μm |
| | um), an adhesive layer (AL: 25 μm) and a | Assembly | |
| | magnetic shielding layer (MSL: 50, 65 or 75 | | |
| | um) having a post lamination thickness of ~200 | | |
| | um; a rear subassembly (RS) having a thickness | | |
| | before press lamination of 750 μm (3-ply wood | | |
| | veneer laminate with 2 adhesive coated | | |
| | substrate layers (ACSL-4 interlayers of | | |
| | adhesive and 2 substrate layers) with a post | | |
| | lamination thickness of 545 μm, sandwiching a | | |
| | core subassembly (CS) of an adhesive coated | | |
| | substrate layer (ACSL: 150 μm) incorporating a | | |
| | booster antenna circuit (BAC) and prepressed, | | |
| | with the stack-up assembly before final | | |
| | lamination having a thickness: 895 μm | | |
| | The substrate layer (SL) in the form of a | | |
| | nonwoven fabric with a P2 module opening in | | |
| | the core subassembly (CS) to support the chip | | |
| | module (CM, TCM) may be replaced by a | | |
| | alternative substrate with a greater thickness | | |

In some embodiments disclosed herein, a stepped recess for receiving implantation of a chip module (CM) may extend through some subassemblies (and several layers) of the stack-up of a card body (CB). The chip module (CM) may comprise a module tape (MT) having a thickness, a front (face-up, top) surface and a rear (face-down, bottom) surface. Contact pads (CP), or pins, may be disposed on the front surface of the module tape. A module antenna (MA), bond pads and circuitry or traces, and an integrated circuit (IC) chip) may be disposed on the rear surface of the module tape. The thickness of the module tape may be 170 μm, and its cross-dimension (footprint) may be 11.2 mm×8.5 mm (for a 6-pin module) or 13.2 mm×12.0 mm (for an 8-pin module).

The stepped recess may be formed by module openings (MO) in the several layers of the stack-up, as follows. Topmost ones of the layers, for example in a front subassembly (FS) of the stack-up may have module openings with a first (P₁) cross-dimension (footprint) sufficient to receive the module tape, and the layers of the front subassembly may have an aggregate thickness approximately equal to the thickness of the module tape and mounting tape.

Subsequent underlying layers, for example in a core subassembly (CS) of the stack-up may have module openings with a second (P₂) cross-dimension (footprint) sufficient to receive the chip module (which may be encapsulated with glob top epoxy, or the like). The P₂ cross-dimension may be 6.4 mm×8.5 mm (for a 6-pin module) or 9.8 mm×8.8 mm (for an 8-pin module). The (encapsulated) chip module may be supported by a topmost layer (which does not have a module opening) of an underlying subassembly, such as the rear subassembly (RS).

The card body (CB) may include a booster antenna circuit (BA), which may comprise a wire embedded antenna circuit having a perimeter coil, a coupler coil (CC) and an extension coil. The coupler coil (CC) may be disposed around and in close proximity with the stepped recess (module openings) when the chip module (CM) is implanted into the stepped recess, the module antenna (MA) and coupler coil (CC) may be in close proximity with one another to promote efficient coupling of signals (and energy) between the booster antenna circuit (BAC) and the integrated circuit (IC) chip (i.e., with the module antenna (MA) of the chip module (CM) coaxially aligned with the coupler coil (CC) of the booster antenna circuit (BAC) for inductive coupling).

### Coupling Frame

Generally, a “coupling frame” (CF) may comprise a metal layer, metal frame, metal plate or any electrically-conductive medium or surface with an electrical discontinuity such as in the form of a slit(S) extending from an outer edge of the layer to an inner position thereof, the coupling frame (CF) capable of being oriented so that the slit(S) overlaps (crosses-over) the module antenna (MA) of the transponder chip module (TCM), such as on at least one side thereof. The slit(S) may be straight and may have a width and a length. The slit(S) may extend to an opening (MO) for accepting the transponder chip module. There may only be a slit, and no opening for the transponder chip module (TCM). Coupling frames of this type, typically a layer of metal with an opening for receiving a transponder chip module, and a slit extending from a periphery of the layer to the opening, wherein the slit overlaps at least a portion of the module antenna, may be found in the following U.S. Pat. Nos. 9,812,782; 9,390,364; 9,634,391; 9,798,968 and 9,475,086.

A metal foil with a laser-cut slit(S) and module opening (MO) may act as a coupling frame (CF) in the form of a one turn booster antenna circuit (BAC) in a smartcard, such as a timber transaction card.

Discontinuity in a Metal Layer or Metal Card Body acting as a Coupling Frame: A discontinuity in a metal layer comprises a slit or gap in the metal layer extending from the front surface to the back surface, the discontinuity defining a path from an origin at the card periphery and terminating at a terminus in an opening to accept a transponder chip module. The metal layer may or may not be defined as reaching the periphery of the transaction card, and the slit geometries may be defined in terms of the card body, and not the coupling frame. A slit may be angled enough that it intersects the periphery of the card body above or below the Y-coordinates of the module opening to accept a transponder chip module.

EP 0 494 471 (1 Jan. 1992; Chubb Lips; Nieuwkoop), entitled “Locks” describes an electronic lock which is constructed to resemble the appearance and functionality of a conventional cylinder lock. Its key (22) has a bit (24) in which is mounted an integrated circuit chip (27) storing the key code and including a transmission coil for inductive coupling with reading means of the lock. The latter includes a coil (33) for generating a high frequency alternating magnetic field across a localized region of the keyway (12) concentrated via a toroidal ferrite core structure which defines a gap spanning the keyway through which the chip (27) passes when the key bit (24) is inserted. This core structure includes a U-shaped part (31) in the stationary lock housing (30) around which the coil (33) is wound, and two parts (35) mounted in the barrel, one to either side of the keyway (12), which register with the part (31) in the housing when the barrel is in the key-reading position. Further ferrite pads (28) may be mounted to either side of the coil in the key itself, to register with the ferrite parts (35) in the barrel. By this means, optimum flux coupling between the lock and key may be achieved, thereby minimizing power consumption.

U.S. Pat. No. 11,341,385 (24 May 2022; Federal Card Services; Finn), entitled RFID Enabled Metal Transaction Card With Shaped Opening And Shaped Slit, incorporated by reference herein, discloses a transaction card for dual interface communication of a transaction includes a card body, a chip opening, a discontinuity, and a transponder chip. The card body includes a first metal layer having an outer peripheral edge, a first metal face, and a second metal face. The chip opening includes a first chip hole transversely extending from the first metal face toward the second metal face thereby defining a first metal edge surrounding a predetermined hole shape. The discontinuity extends from the outer peripheral edge to the first metal edge. The transponder chip module has a module antenna and is configured to be received within the chip opening. The module antenna defines an outer antenna edge surrounding a predetermined antenna shape such that the predetermined antenna shape is the same as the predetermined hole shape for improved inductive coupling via the discontinuity during use. Reference is made to FIGS. 61A, 62, 63A, 64A and 65A.

Reference is also made to FIG. 3G or 2014/0361086, 2015/0021403, 2019/0197386, 2020/0257953 and 2021/0192311.

FIG. 14A shows a discontinuous metal layer (DML), functioning as a coupling frame (CF) and forming the core of a wood metal hybrid transaction card such as shown in FIG. 9A. The coupling frame may extend substantially over the entire area of the card body (CB).

The discontinuity in the coupling frame may be in the form of a straight (as shown) or shaped (other than straight) slit (Slit 1) starting a peripheral edge (left, as viewed) of the coupling frame and extending to a module opening (MO; P2: 8.80×9.80 mm) in the coupling frame. The slit, or another portion (Slit 2) thereof, extends from the module opening (MO) towards an opposite edge (right, as viewed) of the coupling frame, and terminates at a point in a central area (region) of the card body (“center of card body”). The slit may have a width of approximately 100 μm.

A transponder chip module (TCM, not shown) having a module antenna (MA) may be disposed in the card body so that its module antenna is disposed atop the module opening of the coupling frame. This arrangement of a slit (or slits) which extend from a peripheral edge of the coupling frame to a central area (region) of the coupling frame may significantly improve the RF (radio frequency) performance of the inductively coupled transponder chip module, as contrasted with slits in coupling frames that extend only from a peripheral edge of the coupling frame to the module opening.

A metal layer such as the discontinuous metal layer (coupling frame) may provide additional weight (such as 10 grams) to the resulting smart card (SC), or timber metal transaction card (TMTC). The metal layer may also tend to provide additional stiffness to the resulting card. Such additional weight and stiffness may be desirable. However, it will easily be understood that providing a slit in the coupling frame may compromise the stiffness, especially when the slit (or slits) extend from a peripheral edge of the metal layer, to the module opening, and beyond to a central area of the metal layer. The discontinuous metal layer is sandwiched between the upper and lower reinforcement layers (RL), as shown in FIGS. 9A and 14B. In this manner, the upper and lower reinforcement layers serve to compensate for (offset) the loss of stiffness in the discontinuous metal layer caused by the slit (Slit 1, Slit 2), thereby restoring stiffness to the card body which has been compromised by the slit (or slits).

The slit(S) shown in FIG. 14A has two portions, a first portion extending from the peripheral edge of the metal layer to the module opening (P₂), and a second portion extending from the module opening to a central region (or area) of the metal layer, hence a central region of the card body. The slit portions are illustrated as being straight, but the may be may be curved, or serpentine. The slit portions are shown as nearly colinear with one another, but may be other than nearly colinear. The first portion of the slit is shown extending from the left (as viewed) edge of the metal layer to the left (as viewed) side of the module opening. The first portion of the slit may extend to another portion of the module opening, such as a corner of the module opening or to the top or bottom, or right side of the module opening. The second portion of the slit is shown extending from the right (as viewed) side of the module opening towards the right (as viewed) edge of the metal layer. The second portion of the slit may extend from another portion of the module opening, such as a corner of the module opening or to the top or bottom, or right side of the module opening. The second portion of the slit is shown extending only to a central region (or area) of the metal layer. The second portion of the slit may extend further than the central region (or area) of the metal layer towards the right (as viewed) edge of the metal layer. It may even be curved, or form a spiral pattern. The only limitation on the shape and extent of the slit is that a portion should extend from a peripheral edge of the card to the module opening, and the slit should not completely separate (bifurcate) the metal layer into two disconnected metal layers. It is within the scope of the invention that additional slits (or slit portions) may extend from the module opening to other areas of the metal layer, and may also be curved, or form a spiral pattern.

FIG. 14B shows a construction of a timber metal transaction card (TMTC), similar to the construction shown in FIG. 9A. The transaction card comprising front and rear wood layers (stained or dyed) sandwiching a core subassembly (CS) incorporating a coupling frame (CF) with a straight or shaped slit(S) and module opening (MO), structurally stabilized by upper and lower reinforcement layers (RL) in forming a card body subassembly (CBS), wherein the reinforcement layers comprise a calendered nonwoven fabric coated on both sides with an adhesive. The front and rear wood layers may be prepressed dyed wood veneers.

In FIGS. 14A and 14B, the transponder chip module (TCM) and other components of a complete card such as additional front and rear layers (AFL and RFL, respectively) and a magnetic stripe (MS), are omitted, for illustrative clarity.

The front and rear face wood layer (single-ply) forming the front subassembly (FS) and rear subassembly (RS) may be a stained or dyed wood veneer having an initial thickness of 300 or 550 μm before compression or densification, and a post lamination thickness of 200 μm (pressure dependent). Alternatively, the wood layers may be technical or reconstituted wood veneers.

The upper and lower reinforcement layers (RL) comprise a substrate layer (SL) of fleece, i.e. a (wetlaid) nonwoven fabric comprising a blend of cellulosic and polyester fibers bonded with a latex binder. The basis weight of the nonwoven fabric may be 70 g/m² having an initial thickness of 220 μm before adhesive coating. Post calendering and application of the adhesive coating (~25 μm) to both sides of the substrate layer, the adhesive coated nonwoven fabric or adhesive coated fleece (ACF) may have a thickness of ~150 μm (100 g/m²).

The discontinuous metal layer (ML, DML) as a coupling frame (CF) in forming the core subassembly (CS) as described in FIG. 14A may be a layer of tempered 304 stainless steel, titanium, aluminum or any suitable metal alloy that provides durability and aesthetics having a thickness of 254 μm. Optionally, the laser-cut module opening (MO) may be stuffed with a wooden plug or slug to prevent indents (top and bottom) appearing after lamination of the complete card body subassembly (CBS).

The complete card body subassembly (CBS) of the front face wood layer (FS), upper reinforcement layer (RL), core discontinuous metal layer (CS), lower reinforcement layer (RL) and rear face wood layer (RS) may be laminated together in a single process step without prepressing of the wood layers.

### Front Single-Ply Subassembly (FS):

WL Top wood layer (WL: upward facing side-dyed wood veneer) of the front single-ply subassembly (FS) comprising a thin wood veneer orientated in a horizontal or vertical grain direction (lengthwise or crosswise) having a prepressed thickness of 200 μm (compressed from an initial thickness of 300 or 550 μm, depending on the pressure applied); post lamination of the complete assembly and singulation provided with a P₁ cavity (with a depth of 200 μm) for implanting of a transponder chip module (TCM) with mounting tape, with the top wood layer impregnated from the underside with the adhesive from the reinforcement layer (RL) during the final lamination step;
   Core Subassembly (CS) incorporating the Coupling Frame (CF):
RL Reinforcement Layer (RL) or Adhesive Coated Substrate Layer (ACSL) in the form of an adhesive coated fleece (ACF) having a thickness of 150 μm (AL~25 μm+SL~100 μm (post calendering from an initial thickness of ~220 μm)+AL~25 μm), or 100 grams per square meter (g/m²), with a processing temperature of 120-140° C., comprising a substrate layer of colored or non-colored nonwoven fabric (cellulose and synthetic fibers (polyester) bonded with a latex binder) coated on both sides with an adhesive layer (AL), wherein the adhesive on the top side of the substrate layer impregnates the underside of the top dyed wood veneer layer (WL) forming the front single-ply subassembly (FS), and wherein the adhesive on the bottom side of the substrate layer is a bonding agent to the metal coupling frame (CF) with the nonwoven fabric stretched or spanning across the slit and module opening negating the need to fill the voids with a thermosetting resin such as epoxy or polyurethane;
CF A single discontinuous metal layer having laser-cut slits (slit 1 and 2) and a laser-cut module opening with metal edges sized to the dimensions of the P₂ opening (8.80×9.80 mm) of the chip module having a thickness of 254 μm (10 mils);
RL Reinforcement Layer (RL) or Adhesive Coated Substrate Layer (ACSL) in the form of an adhesive coated fleece (ACF) having a thickness of 150 μm (AL~25 μm+SL~100 μm (post calendering from an initial thickness of ~220 μm)+AL~25 μm), or 100 grams per square meter (g/m²), with a processing temperature of 120-140° C., comprising a substrate layer of colored or non-colored nonwoven fabric (cellulose and synthetic fibers (polyester) bonded with a latex binder) coated on both sides with an adhesive layer (AL), wherein the adhesive on the bottom side of the substrate layer impregnates the underside of the bottom wood layer (WL) forming the rear single-ply subassembly (RS), and wherein the adhesive on the top side of the substrate layer is a bonding agent to the metal coupling frame (CF) with the nonwoven fabric stretched or spanning across the slit and module opening negating the need to fill the voids with a thermosetting resin such as an epoxy or polyurethane;

### Rear Single-Ply Subassembly (RS)

WL Bottom wood layer (WL: inward facing-dyed wood veneer) forming the rear single-ply subassembly (RS) comprising a thin wood veneer orientated in a horizontal or vertical grain direction (lengthwise or crosswise) having a prepressed thickness of 200 μm (compressed from an initial thickness of 300 or 550 μm, depending on the pressure applied), with the bottom wood layer impregnated from the underside with the adhesive from the reinforcement layer (RL) during the final lamination step;

Security elements (not shown)-signature panel and payment brand hologram.

FIG. 14C shows a timber metal hybrid transaction card, comprising front and rear outer wooden (veneer) layers (WL) having a grain direction in the vertical axis and intermediate (upper and lower) reinforcement layers (RL) having fibers arranged in a vertical orientation, and said wood layers (WL) and reinforcement layers (RL) sandwiching a discontinuous metal layer (DML) which is a coupling frame (CF) with a straight or shaped slit(S) and module opening (MO) with said slit(S) running parallel the long side of the card body (CB) in the horizontal axis, and wherein the wooden layers (WL) and reinforcement layers (RL) provide structurally stability to the card body (CB).

The front and rear wood layers (stained or unstained) with a vertical grain direction may have an initial thickness of 400 μm or 550 μm before compression or densification of the complete assembly in a lamination press, with a post lamination thickness of approximately 200 μm (pressure dependent).

The discontinuous metal layer (DML) acting as a coupling frame (CF) may be a layer of tempered 304 stainless steel having a thickness of 254 μm.

The upper and lower reinforcement layers (RL) may comprise a substrate layer of fleece with synthetic fibers having a vertical orientation and coated on both sides with a thermosetting resin. The thickness of the adhesive coated fleece (ACF) before press lamination may be 150 μm and undergoing significant shrinkage during the press lamination process.

The complete card body subassembly (CBS) of the front wood layer (WL), upper reinforcement layer (RL), core discontinuous metal layer (DML), lower reinforcement layer (RL) and rear wood layer (WL) may be laminated together in a single process step resulting in an ISO conforming thickness of 800 μm.

While the invention(s) may have been described with respect to a limited number of embodiments, these should not be construed as limitations on the scope of the invention(s), but rather as examples of some of the embodiments of the invention(s). Those skilled in the art may envision other possible variations, modifications, and implementations that are also within the scope of the invention(s), and claims, based on the disclosure(s) set forth herein.

What is claimed is:

1. A card body subassembly (CBS) for a wooden transaction card (WTC) comprising:
a laminated stack-up comprising five wooden (veneer) layers (WL);
wherein a front subassembly (FS) comprises a first two of the wooden layers with a first reinforcement layer (RL) disposed between the first two wooden layers;
wherein a rear subassembly (RS) comprises a second two of the wooden layers with a second reinforcement layer (RL) disposed between the second two wooden layers; and
wherein a core subassembly (CS) comprises a remaining one of the wooden layers with a third reinforcement layer disposed atop the remaining one of the wooden layers and a fourth reinforcement layer disposed beneath the remaining one of the wooden layers;
further comprising a booster antenna (BA; BAC) disposed atop the third reinforcement layer between the core subassembly and the front subassembly;
wherein each wooden layer comprises a micro-thin rotary peeled wood veneer having a thickness of approximately 125-170 μm (nominally 150 μm);
wherein each reinforcement layer comprises a substrate layer (SL), a first adhesive layer disposed atop the substrate layer and a second adhesive layer disposed beneath the substrate layer;
wherein the adhesive layers have a thickness of 25-30 μm;
wherein the substrate layer comprises a compressed and densified wetlaid nonwoven fabric processed by calendering; and
wherein the laminated stack-up has a pre-lamination thickness of approximately 1350 μm and a post-lamination thickness of 760-800 μm following press lamination under pressure and temperature for a defined dwell time.

2. The wooden transaction card of claim 1, wherein:
the wetlaid nonwoven fabric comprises cellulose and synthetic fibers bound with a latex binder.

3. The wooden transaction card of claim 1, wherein:
the wetlaid nonwoven fabric has an initial thickness of approximately 220 μm prior to calendering and a post-calendering thickness including application of an adhesive to both sides thereof of approximately 150 μm.

4. The wooden transaction card of claim 1, wherein:
the wetlaid nonwoven fabric has a basis weight of approximately 40 g/m² and an initial thickness of 270 μm before calendering and the application of an adhesive coating to both sides thereof, and post calendaring and coating having a thickness of approximately 150 μm.

5. The wooden transaction card of claim 1, wherein:
the press lamination results in a material shrinkage of approximately 42%.

6. The wooden transaction card of claim 1, wherein:
during press lamination the adhesive layers penetrate into fibers of adjacent wooden layers to enhance interlayer bonding.

7. The wooden transaction card of claim 1, wherein:
a topmost one of the wooden layers in the front subassembly and a bottommost one of the wooden layers in the rear subassembly are thinned (sanded) after lamination to achieve a uniform thickness compliant with ISO card standards.

8. The wooden transaction card of claim 1, wherein:
the reinforcement layers provide structural integrity, dimensional stability, and resistance to cracking of the laminated stack-up.

9. The wooden transaction card of claim 1, wherein:
the laminated stack-up comprises five wooden layers exactly four reinforcement layers.

10. Method of making a wooden transaction card (WTC) comprising:
providing a plurality of wooden (veneer) layers (WL); and
providing a plurality of reinforcement layers (RL) disposed between the wooden layers;
wherein the wooden layers comprise micro thin rotary peeled wood veneer having a grain direction (crosswise or lengthwise) having a thickness between 125 and 175 μm;
wherein some of the wooden layers are oriented with their grain direction different than other ones of the wooden layers;
wherein the reinforcement layers comprise a (wetlaid) nonwoven fabric (aka fleece), nonwoven pulp and fiber or nonwoven fluff pulp (of cellulose, synthetic and organic fibers bonded with a latex binder) laid in a specific direction and coated on both sides by way of adhesive transfer, spray coating or curtain coating with a thermoplastic adhesive (PVAc) having a total thickness of 150 μm;
the stack-up of wooden layers and reinforcement layers 1350 μm further comprising:
laminating the wooden layers and reinforcement layers in a single step to produce a multi-layered laminate;
sanding back outer (front and rear) ones of the wooden layers so that the laminate is ISO thickness compliant;
coating (impregnating) the sanded-back laminate with a water-based self-sealer for the purpose of waterproofing and as an adhesion promoter for subsequent deposition of digital ink;
digital inkjet printing or laser etching graphic features on the water-protected sanded-back laminate; and
protecting the graphic features with topcoat (TC; film or resin) which is laser engravable.

11. The method of claim 10 wherein the laminate comprises a laminated sheet assembly (LSA) having a plurality of card body sites (SCB) for production of a plurality of smart cards (SC), further comprising:
singulating individual card body sites from the laminated sheet assembly by CO₂ laser cutting while at the same time laser sealing the perimeter edges of the individual card bodies to protect against the environment.

12. The method of claim 10, wherein:
the reinforcement layers between the wooden layers comprise substrate layers (SL) having adhesive layers (AL) on both sides thereof; and
further comprising:
during lamination, causing some of the adhesive from the reinforcement layers to penetrate pores of the wooden layers for the purpose of adhesion, reinforcement and impregnation.

13. The method of claim 10, wherein:
grain directions of individual wooden layers and individual reinforcement layers are oriented 90 degrees with respect to each other.

14. The method of claim 10, wherein:
prior to lamination, the stack-up of wooden layers and reinforcement layers has a first thickness; and
after lamination, the stack-up of wooden layers and reinforcement layers has a second thickness which is 40-44% less than the first thickness.

15. The method of claim 14, further comprising:
sanding back outer wooden layers to reduce the second thickness.

16. The method of claim 10, further comprising:
incorporating (integrating) a booster antenna (BA) or a coupling frame (CF) into the stack-up of wooden layers and reinforcement layers.

17. The method of claim 10, further comprising:
embossing a wood grain into the outer ones of the wooden layers in a subsequent lamination process.
